(19) United States
(12) Patent Application Publication
(10) Pub. No.: US 2010/0216654 A1
(43) Pub. Date: Aug. 26, 2010

(54) BIOMARKERS OF PROSTATE CANCER AND USES THEREOF

(75) Inventors: Katrin Stedronsky, Winnipeg (CA); Douglas Barker, Winnipeg (CA); Yilan Zhang, Winnipeg (CA)

Correspondence Address: MERCHANT & GOULD PC, P.O. BOX 2903, MINNEAPOLIS, MN, 55402-0903, US

(73) Assignee: MIRACULINS, INC., Winnipeg, MB (CA)

(21) Appl. No.: 12/531,018

(22) PCT Filed: Mar. 12, 2008
(86) PCT No.: PCT/CA2008/000488

§ 371 Date: Mar. 8, 2010

Related U.S. Application Data
(60) Provisional application No. 60/894,250, filed on Mar. 12, 2007.
(60) Provisional application No. 60/895,601, filed on Mar. 19, 2007.
(60) Provisional application No. 60/940,371, filed on May 25, 2007.
(60) Provisional application No. 60/976,606, filed on Oct. 1, 2007.

(51) Int. Cl. C40B 30/02

(52) U.S. Cl. 506/8

(57) ABSTRACT

The present invention includes biomolecules and use of these biomolecules for differential diagnosis of prostate cancer and/or non-malignant disease of the prostate. In an embodiment, the present invention provides methods for detecting biomolecules within a biological sample as well as a database comprising of mass profiles of biomolecules specific for healthy subjects, subjects having a non-malignant disease of the prostate and subjects having prostate cancer. The invention further includes kits for differential diagnosis of prostate cancer and/or non-malignant disease of the prostate in a biological sample.

### CROSS-REFERENCE TO RELATED APPLICATIONS

This application claims priority to U.S. provisional application No. 60/894,250, filed Mar. 12, 2007, U.S. provisional application No. 60/895,601, filed Mar. 19, 2007, U.S. provisional application No. 60/940,371, filed May 25, 2007, and U.S. provisional application No. 60/976,606, filed Oct. 1, 2007, the disclosures of which are incorporated herein by reference.

### FIELD OF THE INVENTION

The present invention relates to the field of diagnosis of prostate diseases. More particularly, the present invention provides a method for the differential diagnosis of prostate cancer from a non-malignant disease of the prostate, and/or from a healthy prostate.

### BACKGROUND

Prostate cancer is one of the most common cancers to afflict men in western countries. In North America the incidence rate for prostate cancer in males is an estimated 166.7 per year per 100,000 population, accounting for an estimated 33% of all newly reported cancers in men in 2005 (American Cancer Society 2005). The Canadian Cancer Society indicates that one in 7 men will develop prostate cancer, mostly after age 70 (Canadian Cancer Society 2005). In 2005, American Cancer Society and Canadian Cancer Society estimated the mortality rate for this disease to be 20% (American Cancer Society 2005; Canadian Cancer Society 2005).

The current standard screening method for prostate cancer is the PSA (Prostate Specific Antigen) test, which can take the form of total PSA measurements, free:total PSA ratios, and PSA velocities (change in PSA levels over time) (Egawa et al. 1997; Djavan et al. 1999). The PSA level above which an individual has typically been characterized as having an elevated risk for prostate cancer is 4.0 ng/mL (Gann et al. 1995). This can be refined to account for a number of factors, such as PSA levels increasing naturally with age (Oesterling et al. 1994). Unfortunately, PSA screening is an imperfect means of diagnosis, is not indicative of pathological stage (Beduschi and Oesterling 1997; Erdem et al. 2002-2003), and has sufficiently poor specificity that clinicians must rely on complementary diagnostic tools. The result is healthy patients being subjected to unnecessary testing, and increasing the financial and emotional toll of prostate cancer diagnosis. The primary diagnostic tools used in addition to PSA testing are the digital-rectal exam (DRE) and prostate biopsy. DREs are performed routinely in conjunction with PSA tests and biopsies to improve the accuracy of diagnosis (Scattoni et al. 2003). Prostate biopsies are the means of ultimate confirmation of diagnosis, but have significant complication rates (Rodriguez and Terris 1998). The U.S. Preventative Services Task Force does not recommend the PSA test for routine screening. Despite the known shortcomings of PSA testing and significant amounts of research, there has been little improvement in the state of the art.

With recent developments in proteomic and genomic technologies, the discovery and identification of substitutes or supplements for PSA testing in prostate cancer diagnosis may be within reach. A commonly applied proteomic technique is matrix assisted laser desorption/ionisation mass spectrometry (MALDI-MS), which permits the simultaneous detection and analysis of multiple proteins or peptides in a single sample and, in conjunction with tandem mass spectrometry micro-sequencing, possible protein identification. Surface-enhanced laser desorption/ionisation mass spectrometry (SELDI-MS) is a derivative of and improvement over MALDI-MS. Recently, Ciphergen Biosystems Inc. and a number of independent academic groups have developed diagnostic tools based on the SELDI-MS approach. New markers for a variety of urological complaints have been discovered, including bladder cancer (Vlahou et al. 2001; Liu et al. 2005; Vlahou et al. 2004), renal cancer (Won et al. 2003), prostate cancer (Yasui et al. 2003; Qu et al. 2002; Li et al. 2005; Cazares et al. 2002; Wagner et al. 2004; Adam et al. 2002), benign prostatic hyperplasia (Adam et al. 2002), renal allograft rejection (Clarke et al. 2003; Schaub et al. 2004) and urolithiasis (J Clin Lab Anal, 2004).

Similarly, the generation of a mass spectrum permits the application of panels of possibly unrelated markers to disease diagnosis in one test, rather than evaluation of a single marker. The use of panels of markers represents an improvement over the state of the art by providing capabilities not present in single-marker assays, including the ability to verify that the assay was conducted correctly through monitoring of internal control or reference peaks, the ability to fine-tune parameters by several small adjustments rather than a single large one to ensure that all patients in one group (typically a diagnosis of having a deleterious condition) are correctly identified, the capacity for sub-classification of diagnosis by concurrently looking for markers characteristic of different diseases or grades of disease, and providing the clinician with multiple decision points for diagnosis.

The application of marker panels as described above also provides SELDI-MS with the advantage that marker identification (for example, by the characteristic amino acid sequence of a protein or peptide) is not necessary for the development of an accurate and reliable test. It is well known to those knowledgeable in the art that ELISA-type tests, such as those typically used for PSA testing, require antibodies raised against a particular, known antigen. In contrast, the identity of a marker is not relevant to diagnosis by SELDI-MS, only the ability to reliably and reproducibly detect that marker under the conditions established for the test. In this context, it is noted that markers detected as peaks of the same m/z ratio on two (or more) different surface chemistries cannot be assumed to be the same marker until a final identification is made. This is because mass identities may be coincidental but within the error of the low-resolution mass spectrometry equipment used. Both proteins may be equally good diagnostic tools, and both may have similar peak intensity ranges for cancer and non-cancer samples, but while identical for the purposes of the diagnostic test, they need not be the same protein. Once peaks are identified using SELDI-MS or MALDI-MS, the proteins can be resolved, purified and identified using standard protein chemistry techniques.

### SUMMARY OF THE INVENTION

An aspect of the present invention relates to methods for differential diagnosis of prostate cancer or a non-malignant disease of the prostate by detecting one or more differentially expressed biomolecules within a test sample of a given subject, comparing results with samples from healthy subjects, subjects having precancerous prostatic lesion, subjects with non-malignant disease of the prostate, subjects with localized cancer of the prostate, subjects with metastasised cancer of the prostate, and/or subjects with an acute or a chronic inflammation of prostatic tissue, wherein comparison allows for differential diagnosis of a subject as healthy, having a precancerous prostatic lesion, having non-malignant disease of the prostate, having localized prostate cancer, having a metastasised prostate cancer or having an acute or chronic inflammation of prostatic tissue.

An aspect of the present invention relates to methods for differential diagnosis of prostate cancer or a non-malignant disease of the prostate by detecting one or more differentially expressed biomolecules within a test sample of a given subject, comparing results with samples from healthy subjects, subjects having precancerous prostatic lesion, subjects with non-malignant disease of the prostate, subjects with localized cancer of the prostate, subjects with metastasised cancer of the prostate, and/or subjects with an acute or a chronic inflammation of prostatic tissue, wherein comparison allows for differential diagnosis of a subject as healthy, having a precancerous prostatic lesion, having non-malignant disease of the prostate, having localized prostate cancer, having a metastasised prostate cancer or having an acute or chronic inflammation of prostatic tissue.

One aspect of the invention includes a method for diagnosing prostate cancer in a subject comprising detecting a quantity, presence or absence of biomarker A, B, C, D, E, F, G, H, I, J, K, L, M, and/or N, or a combination thereof in a biological sample; and classifying said subject as having or not having prostate cancer, based on said quantity, presence or absence of said biomarker A, B, C, D, E, F, G, H, I, J, K, L, M, and/or N, or a combination thereof. In one embodiment, the step of classifying said subject comprises comparing the quantity, presence or absence of the biomarker(s) with a reference biomarker panel indicative of a prostate cancer.

A further aspect of the invention includes a method for differential diagnosis of prostate cancer and non-malignant disease of the prostate in a subject, comprising detecting a quantity, presence or absence of the following biomarkers in a biological sample: biomarker A, B, C, D, E, F, G, H, I, J, K, L, M, and/or N, or a combination thereof in a biological sample; and classifying said subject as having prostate cancer, non-malignant disease of the prostate, or as healthy, based on the quantity, presence or absence of said one or more biomarkers in said biological sample. In one embodiment, the step of classifying said subject comprises comparing the quantity, presence or absence of the biomarker(s) with a reference biomarker panel indicative of prostate cancer and a reference biomarker panel indicative of a non-malignant disease of the prostate.

A further aspect of the invention includes a method for differential diagnosis of healthy, non-malignant disease of the prostate, precancerous prostatic lesion, localized cancer of the prostate, metastasised cancer of the prostate, and acute or chronic inflammation of prostatic tissue in a subject, comprising detecting a quantity, presence or absence of the following biomarkers in a biological sample: biomarker A, B, C, D, E, F, G, H, I, J, K, L, M, and/or N, or a combination thereof; and classifying said subject as having non-malignant disease of the prostate, precancerous prostate lesion, localized cancer of the prostate, metastasised cancer of the prostate, and/or acute or chronic inflammation of prostatic tissue, or as healthy, based on the quantity, presence or absence of said one or more biomarkers in said biological sample. In one embodiment, the step of classifying said subject comprises comparing the quantity, presence or absence of the biomarker(s) with a reference biomarker panel indicative of healthy, non-malignant disease of the prostate, precancerous prostate lesion, localized cancer of the prostate, metastasised cancer of the prostate, acute inflammation of prostatic tissue or chronic inflammation of prostatic tissue.

In a further embodiment, a method for diagnosis of a prostate cancer in a subject or the method for differential diagnosis of healthy, non-malignant disease of the prostate, precancerous prostatic lesion, localized cancer of the prostate, metastasised cancer of the prostate, and acute or chronic inflammation of prostatic tissue in a subject, one or more biomarkers are used to classify a subject by: (a) contacting a biological sample with a biologically active surface, (b) allowing the biomarkers within the biological sample to bind to the biologically active surface; (c) detecting the bound biomarkers using a detection method, wherein the detection method generates mass profiles of the biological sample; (d) transforming the information obtained in c) into a computer readable form; and (e) comparing the information in d) with a database containing mass profiles from subjects whose classification is known; wherein the comparison allows for the differential diagnosis and classification of a subject.

An aspect of the invention includes a method for determining aggressiveness or non-aggressiveness of prostate cancer, the method comprising comparing 1) quantity of biomarker A, B, C, D, E, F, G, H, I, J, K, L, M, N, or a combination thereof, in a subject's test sample; and 2) quantity of biomarker A, B, C, D, E, F, G, H, I, J, K, L, M, N, or a combination thereof, in a control/benign sample. A difference in the quantity in the subject's sample and the quantity in the control/benign sample is an indication that prostate cancer is aggressive or non-aggressive.

An aspect of the invention includes a method of determining a stage of prostate cancer by obtaining a sample from a subject; and measuring a quantity of biomarker A, B, C, D, E, F, G, H, I, J, K, L, M, N, or a combination thereof. The quantity of biomarker A, B, C, D, E, F, G, H, I, J, K, L, M, N, or a combination thereof, above or below a pre-determined cut-off or reference level is indicative of the stage of prostate cancer.

An aspect of the invention includes methods of classifying a stage of prostate cancer. For example, a method comprises: a) determining a quantity of biomarker A, B, C, D, E, F, G, H, I, J, K, L, M, N, or a combination thereof, in a sample; b) comparing a level of biomarker A, B, C, D, E, F, G, H, I, J, K, L, M, N, or a combination thereof to a biomarker reference panel (for example, a reference panel which can be mean values of the quantities for the biomarker constituents of the panel for a specific stage); and c) classifying a tumor by said comparison.

An aspect of the invention includes a method of determining a grade of a prostate tumor by measuring a quantity of biomarker A, B, C, D, E, F, G, H, I, J, K, L, M, N, or a combination thereof in a biological sample. The quantity of biomarker A, B, C, D, E, F, G, H, I, J, K, L, M, N, or a combination thereof, above or below a pre-determined cut-off or reference level is indicative of the grade of a prostate tumor.

An aspect of the invention includes methods of classifying a grade of a prostate tumor. For example, a method comprises: a) determining a quantity of biomarker A, B, C, D, E, F, G, H, I, J, K, L, M, N, or a combination thereof, in a test sample; b) comparing the level of the biomarker or biomarkers (biomarker A, B, C, D, E, F, G, H, I, J, K, L, M, N, or a combination thereof) to a biomarker reference panel (for example, a reference panel including mean values of the quantities for the biomarker constituents of the panel for a specific grade) and c) classifying a tumor by said comparison.

An aspect of the present invention relates to methods for evaluating a prognosis of prostate cancer in a subject. The methods comprise detecting a quantity of biomarker A, B, C, D, E, F, G, H, I, J, K, L, M, N, or a combination thereof in a test sample; and classifying the progression of cancer. The present method permits differentiation of prostate cancer subjects with a good prognosis (high probability of recovery, becoming disease free) from subjects with a bad prognosis (low probability of recovery, cancer reoccurrence, metastasis).

In a further embodiment of the methods of the invention, a database is generated by (a) obtaining reference biological samples from subjects having known classification; (b) contacting the reference biological samples in (a) with a biologically active surface, (c) allowing biomarkers within the reference biological samples to bind to the biologically active surface, (d) detecting bound biomarkers using a detection method, wherein the detection method generates mass profiles of the reference biological samples, (e) transforming the mass profiles into a computer-readable form, and (f) applying a mathematical algorithm to classify the mass profiles in d) into desired classification groups.

In a further embodiment of the methods of the invention, the quantity, presence, or absence of the one or more biomarkers is detected in a biological sample obtained from a subject by mass spectrometry. A method of mass spectrometry may be selected from the group consisting of matrix-assisted laser desorption ionization/time of flight (MALDI-TOF), surface enhanced laser desorption ionisation/time of flight (SELDI-TOF), liquid chromatography, MS-MS, or ESI-MS.

In a further embodiment of the methods of the invention, the quantity, presence, or absence of the biomarker is detected or quantified in the biological sample obtained from the subject utilizing an antibody to said biomarker.

In a further embodiment of the methods of the invention, the quantity, presence, or absence of the biomarkers is detected or quantified in the biological sample obtained from the subject through the use of an ELISA assay.

In a further embodiment of the methods of the invention, the quantity, presence, or absence of the biomarkers is detected or quantified through the use of a biochip.

In a further embodiment of the methods of the invention, the quantity, presence, or absence of the biomarkers is detected or quantified in an automated system.

In a further embodiment of the methods of the invention, the subject is a mammal. The subject may be a human.

In a further embodiment of the methods of the invention, a test or biological samples used according to the invention may be of blood, blood serum, blood plasma, urine, semen, seminal fluid, seminal plasma, prostatic fluid, pre-ejaculatory fluid (Cowper's fluid), excreta, tears, saliva, sweat, bile, biopsy, ascites, cerebrospinal fluid, lymph, or tissue extract origin. In a further embodiment of the methods of the invention, the test and/or biological samples are urine, semen, seminal fluid, seminal plasma, prostatic fluid, pre-ejaculatory fluid (Cowper's fluid) samples, and are isolated from subjects of mammalian origin, preferably of human origin. In a still further embodiment of the invention, the test and/or biological samples are blood, blood serum, plasma and/or urine.

In a further embodiment of the methods of the invention, a biologically active surface comprises an adsorbent comprising silicon dioxide molecules.

In a further aspect of the invention, provided is a kit for diagnosis of prostate disease within a subject comprising: a biologically active surface comprising an adsorbent, binding solutions, and instructions to use the kit, wherein the instructions outline the a method for diagnosis of a prostate cancer in a subject according to the invention or a method for the differential diagnosis of healthy, non-malignant disease of the prostate, precancerous prostatic lesion, localized cancer of the prostate, metastasised cancer of the prostate, and acute or chronic inflammation of prostatic tissue in a subject according to the invention.

In an embodiment of the invention, a kit comprises a biologically active surface comprising an adsorbent comprised of silicon dioxide molecules.

In an embodiment of the invention, a kit comprises a biologically active surface comprising an adsorbent comprising antibodies specific to a biomarker or biomarkers, which can be biomarker A, B, C, D, E, F, G, H, I, J, K, L, M, N, or a combination thereof.

A further aspect of the invention includes a method for in vitro diagnosis of a prostate cancer in a subject comprising detecting one or more differentially expressed biomarkers in a biological sample by: (a) contacting a biological sample from a subject with one or more binding molecule specific for a biomarker, which can be biomarker A, B, C, D, E, F, G, H, I, J, K, L, M, N, or a combination thereof; and (b) detecting a quantity, presence or absence of the one or more biomarker in the sample, wherein the quantity, presence or absence of the biomarker(s) allows for diagnosis of the subject as healthy or having prostate cancer.

A further aspect of the invention includes a method for in vitro differential diagnosis of prostate cancer and non-malignant disease of the prostate in a subject, comprising detecting one or more differentially expressed biomarkers in a biological sample: (a) contacting a biological sample with a binding molecule specific for a biomarker, which can be biomarker A, B, C, D, E, F, G, H, I, J, K, L, M, N, or a combination thereof; and (b) detecting a quantity, presence or absence of the one or more biomarker in the sample, wherein the quantity, presence or absence of the biomarker(s) allows for the differential diagnosis of the subject as having prostate cancer, and/or having a non-malignant disease of the prostate, or as being healthy.

A further aspect of the invention includes a method for in vitro differential diagnosis of healthy, prostate cancer, non-malignant disease of the prostate, precancerous prostatic lesion, localized cancer of the prostate, metastasised cancer of the prostate, and acute or chronic inflammation of prostatic tissue in a subject, comprising detecting two or more differentially expressed biomarkers in a biological sample by: (a) contacting the biological sample with one or more binding molecules specific for a biomarker, which can include biomarker A, B, C, D, E, F, G, H, I, J, K, L, M, N, or a combination thereof; and (b) detecting a quantity, presence or absence of the two or more biomarkers; wherein the presence or absence of the biomarkers allows for the differential diagnosis of the subject as healthy, having non-malignant disease of the prostate, precancerous prostate lesions, localized cancer of the prostate, metastasised cancer of the prostate, and/or having acute or chronic inflammation of the prostate, or as being healthy.

In an embodiment the method according to the invention for in vitro diagnosis of a prostate cancer in a subject, the method according to the invention for the in vitro differential diagnosis of prostate cancer and non-malignant disease of the prostate in a subject, or the method according to the invention for the in vitro differential diagnosis of healthy, prostate cancer, non-malignant disease of the prostate, precancerous prostatic lesion, localized cancer of the prostate, metastasised cancer of the prostate, and acute or chronic inflammation of prostatic tissue in a subject, the detecting is performed by an immunosorbent assay.

A further aspect of the invention comprises a kit for diagnosis of a prostate disease within a subject comprising a binding solution, one or more binding molecule(s), a detection substrate, and instructions, wherein the instructions outline a method according to the invention for in vitro diagnosis of prostate cancer in a subject, a method according to the invention for in vitro differential diagnosis of prostate cancer and non-malignant disease of the prostate in a subject, or a method according to the invention for in vitro differential diagnosis of healthy, prostate cancer, non-malignant disease of the prostate, precancerous prostatic lesion, localized cancer of the prostate, metastasised cancer of the prostate, and acute or chronic inflammation of prostatic tissue in a subject.

Further aspects of the invention include biomolecules of biomarker A, B, C, D, E, F, G, H, I, J, K, L, M, N, or a combination thereof. In an embodiment of the invention, biomolecules comprise a nucleic acids, nucleotides, polynucleotides (DNA or RNA), amino acids, polypeptides, proteins, sugars, carbohydrates, fatty acids, lipids, steroids, antibodies, and combinations thereof. The combination may be glycoproteins, ribonucleotides, or lipoproteins.

In a further embodiment, biomolecules are proteins, polypeptides, and/or fragments thereof.

A further aspect of the invention comprises a use of any one or more biomarkers, which can be biomarker A, B, C, D, E, F, G, H, I, J, K, L, M, N, or a combination thereof, for differential diagnosis of non-malignant disease of the prostate, precancerous prostatic lesion, localized cancer of the prostate, metastasised cancer of the prostate or acute or chronic inflammation of prostatic tissue.

A further aspect of the invention comprises a use of a biomarker, which can be biomarker A, B, C, D, E, F, G, H, I, J, K, L, M, N, or a combination thereof, for the treatment of non-malignant disease of the prostate, precancerous prostatic lesion, localized cancer of the prostate, metastasised cancer of the prostate or acute or chronic inflammation of prostatic tissue.

A further aspect of the invention comprises a use of the detection or quantification of a biomarker, which can be biomarker A, B, C, D, E, F, G, H, I, J, K, L, M, N, or a combination thereof, in a biological sample from a subject for determination of whether the subject has prostate cancer.

A further aspect of the invention comprises a use of the detection or quantification of a biomarker, which can be biomarker A, B, C, D, E, F, G, H, I, J, K, L, M, N, or a combination thereof, in a biological sample from a subject for determination of whether the subject has non-malignant disease of the prostate.

A further aspect of the invention comprises a use of the detection or quantification of a biomarker, which can be biomarker A, B, C, D, E, F, G, H, I, J, K, L, M, N, or a combination thereof in a biological sample from a subject for determination of whether the subject has benign prostate disease, precancerous prostatic lesions, localized cancer of the prostate, metastasised cancer of the prostate, or acute or chronic inflammation of the prostate.

A further aspect of the invention comprises a database containing a plurality of database entries useful in diagnosing subjects as having, or not having, prostate cancer, comprising: (a) a categorization of each database entry as either characteristic of having, or not having prostate cancer; (b) characterization of each database entry as either having, or not having, or having in a certain quantity, a biomarker, which can be biomarker A, B, C, D, E, F, G, H, I, J, K, L, M, N, or a combination thereof.

In an embodiment of the invention, a database can further include a characterization of each database entry as either having, or not having, or having in a certain quantity, an additional one or more biomarker, which can be biomarker A, B, C, D, E, F, G, H, I, J, K, L, M, N, or a combination thereof.

A further aspect of the invention comprises a database generated by: (a) obtaining reference biological samples from subjects known to have, and patients known not to have, prostate cancer; (b) contacting the reference biological samples in (a) with a biologically active surface; (c) allowing biomarkers within the reference biological samples to bind to the biologically active surface; (d) detecting bound biomarkers using a detection method wherein the detection method generates mass profiles of the reference biological samples; (e) transforming the mass profiles into a computer readable form; and (f) applying a mathematical algorithm to classify the mass profiles in (d) as specific for healthy subjects or subjects having prostate cancer.

A further aspect of the invention includes memory for storing data for access by an application program being executed on a data processing system for diagnosing a prostate cancer or a non-malignant prostate disease, comprising a data structure stored in the memory, the data structure including information resident in a database used by the application program and including one or more reference biomarker panels stored in the memory having a plurality of mass profiles associated with one or more biomarkers previously defined as being characteristic of a prostate cancer or a non-malignant disease of the prostate; wherein each of the mass profiles has been transformed into a computer readable form.

A further aspect of the invention comprises a use of biomarker A, B, C, D, E, F, G, H, I, J, K, L, M, N, or a combination thereof, and combinations thereof to detect prostate cancer.

A further aspect of the invention includes a method of identifying a molecular entity that inhibits or promotes an activity of any biomarker according to the invention, comprising the steps of: (a) selecting a control animal having the biomarker and a test animal having the biomarker; (b) treating the test animal using the molecular entity or a library of molecular entities, under conditions to allow specific binding and/or interaction and, (c) determining the relative quantity of the biomarker, as between the control animal and the test animal.

In an embodiment of the invention, the animals are mammals. The mammals may be rats or mice.

A further aspect of the invention includes a method of identifying a molecular entity that inhibits or promotes an activity of any biomarker according to the invention, comprising the steps of: (a) selecting a host cell expressing the biomarker; (b) cloning the host cell and separating the clones into a test group and a control group; (c) treating the test group using the molecular entity or a library of molecular entities under conditions to allow specific binding and/or interaction and (d) determining the relative quantity of the biomarker, as between the test group and the control group.

A further aspect of the invention includes a method for identifying a molecular entity that inhibits or promotes an activity of any biomarker according to the invention, comprising the steps of: (a) selecting a test group having a host cell expressing the biomarker and a control group; (b) treating the test group using the molecular entity or a library of molecular entities; (c) determining the relative quantity of the biomarker, as between the test group and the control group.

In an embodiment of the invention, a host cell is a neoplastic or cancer cell.

In an embodiment of any of the methods according to the invention for identifying a molecular entity that inhibits or promotes an activity of any biomarker according to the invention, the library of molecular entities is selected from the group consisting of: nucleotides, oligonucleotides, polynucleotides, amino acids, peptides, polypeptides, proteins, antibodies, immunoglobulins, small organic molecules, pharmaceutical agents, agonists, antagonists, derivatives and/or combinations thereof.

A further aspect of the invention includes a composition for treating a prostate disease comprising a molecular entity, which modulates a biomarker according to the invention and a pharmaceutically acceptable carrier.

An embodiment of the invention includes a composition for treating a prostate disease selected from the group consisting of prostate cancer and non-malignant disease of the prostate.

A further embodiment includes a composition for treating a prostate disease selected from the group consisting of non-malignant disease of the prostate, precancerous prostatic lesion, localized cancer of the prostate, metastasised cancer of the prostate, and acute or chronic inflammation of prostatic tissue.

A further embodiment of the invention includes a composition comprising a molecular entity selected from the group consisting of nucleotides, oligonucleotides, polynucleotides, amino acids, peptides, polypeptides, proteins, antibodies, immunoglobulins, small organic molecules, pharmaceutical agents, agonists, antagonists, derivatives and combinations thereof.

A further aspect of the invention includes a composition for treating a prostate disease comprising a molecular entity identified by any one of the methods of invention for identifying a molecular entity, which inhibits or promotes the activity of any biomarker according to the invention and a pharmaceutically acceptable carrier.

In an embodiment of the invention, a composition comprises a molecular entity is selected from the group consisting of nucleotides, oligonucleotides, polynucleotides, amino acids, peptides, polypeptides, proteins, antibodies, immunoglobulins, small organic molecules, pharmaceutical agents, agonists, antagonists, derivatives or combinations thereof.

A further aspect of the invention includes a use of any composition according to the invention for treating a prostate disease. Prostate disease may be prostate cancer and non-malignant disease of the prostate. The prostate disease may be is selected from the group consisting of non-malignant disease of the prostate, precancerous prostatic lesion, localized cancer of the prostate, metastasised cancer of the prostate, and acute or chronic inflammation of prostatic tissue.

### BRIEF DESCRIPTION OF THE DRAWINGS

FIG. 1 is a visual depiction of correlation of urine SELDI-MS peaks discriminatory for prostate cancer. All urine peak data was examined visually using WEKA to identify any peaks that may be easily correlated. Perfect correlation (such as is shown when a peak is correlated with itself) is depicted as a straight line of data points going from the bottom left to the top right of a given panel. The X and Y axes represent peak intensity for each peak, peaks for the X and Y axes specified at the top or left of the figure, respectively. Peaks Ur5385, Ur10517, Ur10560, Ur10632 and Ur 10759 appear to be correlated. Peak Ur9898 is included to demonstrate the depiction of an uncorrelated peak.

FIG. 2 illustrates the presence of doubly charged peaks in urine mass spectra generated using NP20 ProteinChips. The presence of doubly charged peptides discriminatory for prostate cancer was first intuited by visual examination of mass spectra. Comparison of peak masses further supported the notion that at least some of the peaks discovered may be multiply charged versions of larger peaks that were also discriminatory for prostate cancer. The “detect multiple charge peaks” function in the CiphergenExpress software was used to confirm the presence of such peaks. The spectrum above gives the output of the CiphergenExpress software, showing two pairs of peaks, one that is singly charged (m/z ˜10760 and 10648) and one that is doubly charged (m/z ˜5380 and 5325).

FIG. 3 is urine mass spectra showing the effect of one additional freeze/thaw cycle on MI0750 detection. Urine sample from patient WC036 that had previously been frozen twice were thawed and either not centrifuged (top) or centrifuged (middle) to remove salts prior to dispensing into clean tubes and being refrozen a third time. These samples were assayed on NP20 ProteinChips® by SELDITOF MS and compared to positive control samples consisting of urine sample from patient WC036 frozen only twice. The spectra depicted are representative of duplicate spectra generated for each treatment type.

FIG. 4 is urine mass spectra showing the effect of storage conditions protein stability within AEX fraction. Urine sample from patient WC036 was fractionated on Q Ceramic HyperD Filtration plate (Ciphergen Inc.). AEX fraction eluted with buffer at pH 6.0 was subjected to different storage conditions prior to assay on NP20 ProteinChips® by SELDITOF MS. Storage condition is given to the right of each spectrum.

FIG. 5 is urine mass spectra showing the effect of dialysis at 4° C. for 24 hours on urinary protein stability. Urine sample from patient WC036 was assayed on NP20 ProteinChips® by SELDITOF MS either without treatment (top), after 24 hour dialysis at 4° C. against HPLC-grade water (middle) Spectra are representative of duplicate spectra generated for each treatment type. Co-crystallisation was performed with CHCA.

FIG. 6 is mass spectra for anion exchange fractionation of MI0750 from crude urine. Urine sample from patient WC036 was fractionated on Q Ceramic HyperD® F-Filtration Plate (Ciphergen Inc.) using a step gradient of buffers of decreasing pH. Elution pH is given to the right of each spectrum. Spectra were normalized for total ion current before presentation in this figure. The H+ and 2H+ species of MI0750 are clearly dominant in these spectra. Spectra given are representative of duplicate spectra generated.

FIG. 7 is mass spectra for reverse phase fractionation of MI0750 from pooled AEX fractions (pH7.0, pH 6.0). Pooled AEX fraction was fractionated on Alltech C18 SPE column using a step gradient of buffers of increasing methanol concentration. Elution methanol concentration is given to the right of each spectrum. Spectra were normalized for total ion current before presentation in this figure. Spectra given are representative of duplicate spectra generated.

FIG. 8 is mass spectra for anion exchange (AEX in short) fractionation of MI0750 from pooled crude urine containing either increased (positive control) or decreased (negative) expression of MI0750. Pooled urine sample was fractionated on Q Ceramic HyperD® F-Filtration Plate (Ciphergen Inc.) using a step gradient of buffers of decreasing pH. Elution pH and fractions from positive (+) or negative (−) control are given to the right of each spectrum. Spectra were normalized for total ion current before presentation in this figure. Spectra given are representative of duplicate spectra generated.

FIG. 9 is a photograph of an electrophoresis gel. Bands used to estimate the Mw of the putative MI0750 bands. The 1st lane from left is derived from the protein standard, the 2^{nd}, 4th, 7^{th} and 9^{th} lane were derived from sample pH8.0 (+), pH7.0 (+), pH6.5 (+) and pH6.0 (+) respectively, which showed the putative MI0750 bands. While the 3^{rd}, 5^{th}, 8^{th} and 10^{th} lane were derived from pH8.0 (−), pH7.0 (−), pH6.5 (−) and pH6.0 (−) which showed no putative bands of MI0750.

FIG. 10 is mass spectra foranionic exchange fractionation of MI0005 from crude urine. Urine sample from patient WC093 was fractionated on Q Ceramic HyperD® F-Filtration Plate (Ciphergen Inc.) using a step gradient of buffers of decreasing pH. Elution pH is given to the right of each spectrum. Spectra were normalized for total ion current before presentation in this figure.

FIG. 11 is mass spectra for reverse phase chromatographic fractionation of MI0005 from pooled AEX fraction pH 5 and pH 6 from FIG. 1. Pooled AEX fraction pH 6 and pH 5 was obtained by fractionating urine sample from patient WC093 on Q Ceramic HyperD® F-Filtration Plate (Ciphergen Biosystems) using elution buffers at pH 6 and 5, respectively.

FIG. 12 is mass spectra for anionic exchange fractionation of MI0005 from crude urine. Pooled urine sample from 35 patient was fractionated on HiTrap Q FF Cartridge (GE Healthcare.) using a step gradient of buffers of increasing salt—NaCl concentration. Elution salt concentration in elution buffer is given to the right of each spectrum.

FIG. 13 is mass spectra for purification of MI0005 on C8 Reverse phase HPLC. Pooled AEX fraction enriched with MI0005 was applied onto C8-RPHLC, utilizing linear gradient method 1. The spectra depicted are representative of mass spectra generated from pooled AEX fraction by applying the first linear gradient elution method.

FIG. 14. is mass spectra for purification of MI0005 on C8 Reverse phase HPLC. Pooled AEX fraction enriched with MI0005 was applied onto C8-RPHLC, utilizing linear gradient method 1. The spectra depicted are representative of mass spectra generated from pooled AEX fraction by applying the second linear gradient elution method. The second linear gradient elution could remove most, if not all impurities, leading to a RP-HPLC fraction containing MI0005>90% purity.

FIG. 15 is mass spectra for antibody capture of MI005 using PS20 ProteinChip arrays and polyclonal antibodies specific for vitronectin. Spectra shown were generated following SELSI-TOF MS analysis of samples PBS, partially purified MI005 and urine sample known to contain elevated levels of MI005 applied to array surfaces i) without polyclonal antibodies (spectra A, C and E; respectively), and ii) couples with polyclonal antibodies specific for vitronectin (B, D and F, respectively). Spectra were normalized for total ion current.

FIG. 16 is mass spectra forantibody capture of MI005 using tosyl-activated magnetic Dynabeads and polyclonal antibodies specific for vitronectin. Spectra shown were generated following application of samples collected during antibody capture and analysed using SELSI-TOF MS: A) PBS control, B) supernatant, C) PBS wash I, D) PBS wash II, E) PBS wash III, F) eluate and G) partially purified MI005 positive control. Spectra were normalized for total ion current.

FIG. 17 is a bar graph illustrating the effect of dialysis of urine samples with HPLC-grade water or PBS on optical density detected during an indirect ELISA assay for PSP94. Three samples with high MI0750 intensity (482C67C3 (orange), A4F33E34 (green) and 31C26B10 (pink)) and one with low MI0750 intensity (A1F8E231 (red)) were dialyzed against either sterile HPLC-grade water or PBS and then assayed using an indirect ELISA assay with and without the addition of exogenous PSP94 to a final concentration of 200 ng/mL. In addition, commercially available PSP94 (200 ng/mL) and partially purified MI0750 were also assayed for comparison. In samples with high MI0750 intensity there was a consistent increase in optical density with sample dialysis, but no change in optical density with the addition of exogenous PSP94. In contrast, little change was observed across sample treatments for the sample with low MI0750 intensity. Neat: undialyzed sample. Water: Dialyzed with water. PBS: Dialyzed with PBS. +PSP94: exogenous PSP94 added.

FIG. 18 is a bar graph illustrating the effect of dilution of urine samples with HPLC-grade water on optical density detected during an indirect ELISA assay for PSP94. Three samples with high MI0750 intensity (482C67C3, A4F33E34 and 31C26B10) and one with low MI0750 intensity (A1F8E231) were serially diluted in sterile HPLC-grade water and assayed using an indirect ELISA assay. Optical density for sample A1F8E231 was not strongly affected by dilution, being consistently low throughout. Samples A4F33E34 and 31C26B10 both showed an increase in optical density with a dilution of up to 1 in 10 for both. Sample 482C67C3 showed a deterioration in optical density with increasing dilution.

FIG. 19 are line graphs illustrating the correlation of PSP94 concentration and MI0750 peak intensity of samples falling within the linear range of PSP94 concentration of Plate Group 1 (A) and Plate Group 2 (B). A total of 83 and 57 samples were plotted for Plate Groups 1 and 2, respectively. Linear regressions and R² values were calculated automatically using the Microsoft Excel program. X- and Y-axis scales were matched for the data from the two Plate Groups in order to better illustrate the differences in slope, y-intercept and linear range of PSP94 concentration between these groups.

FIG. 20 are line graphs illustrating the relationship between MI0750 peak intensity and PSP94 concentration as measured in urine samples. Individual patients were plotted according to observed MI0750 peak intensity and measured PSP94 concentration. PSP94 was measured using an ELISA developed by Covance applied to diluted urine samples (left, diluted 1:10 in water) and to undiluted urine samples (right). A logarithmic regression was observed for both sets of samples, deteriorating at [PSP94]<˜2.25 ng/mL for diluted urine (line, left panel) or [PSP94]<˜5.60 ng/mL was observed for undiluted urine (line, right panel). Hollow squares: samples obtained from prostate cancer patients. Solid triangles: samples obtained from non-cancer patients. Data are shown using logarithmic scales for clarity.

FIG. 21 bar graphs illustrating the effect of sample dilution on observed PSP94 concentration. Urine samples were assayed in undiluted form (white), or diluted either in PBS (1 part in 2 (grey) or 1 part in 10 (dotted)) or in water (1 part in 2 (cross hatch going up and right) or 1 part in 10 (cross hatch going down and right)). Samples were assayed on two plates, one giving much lower intensity (Plate 1, (A) and (B)) compared to the other plate (Plate 2, C). Values given are the average of two or three replicates, one standard deviation. (A) and (B) show the same data for samples ECC80577 and EEB980EC, with the vertical axis in (B) expanded to ease interpretation.

FIG. 22 are line graphs illustrating the comparison of MI0750 peak intensity with measured [PSP94] in samples 0149A588, ECC80577 and EEB980EC under various conditions. Conditions tested were various dilutions of urine samples with either PBS or water, and are noted on each graph. The plate on which these samples were assayed (Plate 1) had low optical density compared to the other plate assayed. Values depicted are the average of 2 or 3 replicate wells±one standard deviation ([PSP94]) or the average of duplicate spectra where available (MI0750 Intensity).

FIG. 23 are bar graphs illustrating the effect of PSP94 spiking on the observed PSP94 concentration of diluted urine samples. Urine samples were assayed after dilution in either PBS (1 part in 2 (grey and dotted bars)) or in water (1 part in 2 (cross hatched bars)). Diluted samples were spiked with exogenous PSP94 at a final concentration of 50 ng/mL. Samples were assayed on two plates, one giving much lower intensity (Plate 1, (A) and (B)) compared to the other plate (Plate 2, C). Values given are the average of two or three replicates, one standard deviation. (A) and (B) show the same data for samples ECC80577 and EEB980EC, with the vertical axis in (B) expanded to ease interpretation.

### DETAILED DESCRIPTION OF THE INVENTION

The term “biomolecule” refers to a molecule that is produced by a cell or tissue in an organism. Such molecules include, but are not limited to, molecules comprising nucleic acids, nucleotides, oligonucleotides, polynucleotides, amino acids, peptides, polypeptides, proteins, monoclonal and/or polyclonal antibodies, antigens, sugars, carbohydrates, fatty acids, lipids, steroids, and combinations thereof (e.g., glycoproteins, ribonucleoproteins, lipoproteins). Furthermore, the terms “nucleotide”, “oligonucleotide” or polynucleotide” refer to DNA or RNA of genomic or synthetic origin which may be single-stranded or double-stranded and may represent the sense or the antisense strand. Included as part of the definition of “oligonucleotide” or “polynucleotide” are peptide polynucleotide sequences (i.e. peptide nucleic acids; PNAs), or any DNA-like or RNA-like material (i.e. Morpholinos, Ribozymes).

The term “molecular entity” refers to any defined inorganic or organic molecule that is either naturally occurring or is produced synthetically. Such molecules include, but are not limited to, biomolecules as described above, simple and complex molecules, acids and alkalis, alcohols, aldehydes, arenas, amides, amines, esters, ethers, ketones, metals, salts, and derivatives of any of the aforementioned molecules.

The term “biomarker A”, “peak A”, “biomolecule A” and “molecular entity A” are used interchangeably herein and refer to a biomolecule characterized by having a peak with an apparent time of flight of 18.96 μS, wherein the error cited represents one standard deviation of the population of observed peaks with this approximate time of flight (see Table 1). Moreover, biomarker A is also referred to as Ur3049 (examples) since it is further characterized as having an average M/Z ratio of 3049.44.

The term “biomarker B”, “peak B”, “biomolecule B” and “molecular entity B” are used interchangeably herein and refer to a biomolecule characterized by having a peak with an apparent time of flight of 19.865S, wherein the error cited represents one standard deviation of the population of observed peaks with this approximate time of flight (see Table 1). Moreover, biomarker B is also referred to as Ur3338 (examples) since it is further characterized as having an average M/Z ratio of 3338.08.

The term “biomarker C”, “peak C”, “biomolecule C” and “molecular entity C” are used interchangeably herein and refer to a biomolecule characterized by having a peak with an apparent time of flight of 20.439 μS, wherein the error cited represents one standard deviation of the population of observed peaks with this approximate time of flight (see Table 1). Moreover, biomarker C is also referred to as Ur3529 (examples) since it is further characterized as having an average M/Z ratio of 3529.32.

The term “biomarker D”, “peak D”, “biomolecule D” and “molecular entity D” are used interchangeably herein and refer to a biomolecule characterized by having a peak with an apparent time of flight of 21.837 μS, wherein the error cited represents one standard deviation of the population of observed peaks with this approximate time of flight (see Table 1). Moreover, biomarker D is also referred to as Ur4013 (examples) since it is further characterized as having an average M/Z ratio of 4013.21.

The term “biomarker E”, “peak E”, “biomolecule E” and “molecular entity E” are used interchangeably herein and refer to a biomolecule characterized by having a peak with an apparent time of flight of 21.941 μS, wherein the error cited represents one standard deviation of the population of observed peaks with this approximate time of flight (see Table 1). Moreover, biomarker E is also referred to as Ur4051 (examples) since it is further characterized as having an average M/Z ratio of 4051.82.

The term “biomarker F”, “peak F”, “biomolecule F” and “molecular entity F” are used interchangeably herein and refer to a biomolecule characterized by having a peak with an apparent time of flight of 22.778 μS, wherein the error cited represents one standard deviation of the population of observed peaks with this approximate time of flight (see Table 1). Moreover, biomarker F is also referred to as Ur4360 (examples) since it is further characterized as having an average M/Z ratio of 4359.90.

The term “biomarker G”, “peak G”, “biomolecule G” and “molecular entity G” are used interchangeably herein and refer to a biomolecule characterized by having a peak with an apparent time of flight of 25.381 μS, wherein the error cited represents one standard deviation of the population of observed peaks with this approximate time of flight (see Table 1). Moreover, biomarker G is also referred to as Ur5385 (examples) since it is further characterized as having an average M/Z ratio of 5386.13.

The term “biomarker H”, “peak H”, “biomolecule H” and “molecular entity H” are used interchangeably herein and refer to a biomolecule characterized by having a peak with an apparent time of flight of 31.401 μS, wherein the error cited represents one standard deviation of the population of observed peaks with this approximate time of flight (see Table 1). Moreover, biomarker H is also referred to as Ur8177 (examples), since it is further characterized as having an average M/Z ratio of 8177.25.

The term “biomarker I”, “peak I”, “biomolecule I” and “molecular entity I” are used interchangeably herein and refer to a biomolecule characterized by having a peak with an apparent time of flight of 34.601 μS, wherein the error cited represents one standard deviation of the population of observed peaks with this approximate time of flight (see Table 1). Moreover, biomarker I is also referred to as Ur9898 (examples) since it is further characterized as having an average M/Z ratio of 9898.83.

The term “biomarker J”, “peak J”, “biomolecule J” and “molecular entity J” are used interchangeably herein and refer to a biomolecule characterized by having a peak with an apparent time of flight of 35.685 μS, wherein the error cited represents one standard deviation of the population of observed peaks with this approximate time of flight (see Table 1). Moreover, biomarker J is also referred to as Ur10517 (examples) since it is further characterized as having an average M/Z ratio of 10518.65.

The term “biomarker K”, “peak K”, “biomolecule K” and “molecular entity K” are used interchangeably herein and refer to a biomolecule characterized by having a peak with an apparent time of flight of 35.754 μS, wherein the error cited represents one standard deviation of the population of observed peaks with this approximate time of flight (see Table 1). Moreover, biomarker K is also referred to as Ur10560 (examples) since it is further characterized as having an average M/Z ratio of 10561.23.

The terms “biomarker L”, “peak L”, “biomolecule L” and “molecular entity L” are used interchangeably herein and refer to a biomolecule characterized by having a peak with an apparent time of flight of 24.5978 μS, wherein the error cited represents one standard deviation of the population of observed peaks with this approximate time of flight (see Table 1). Moreover, biomarker L is also referred to as Ur5004 (examples) since it is further characterized as having an average M/Z ratio of 5004.11. Biomarker L has been identified as a fragment of vitronectin (SEQ ID No: 2). Vitronectin is also known as “Serum-spreading factor”, “S-protein”, and “V75”. The fragment is vitronectin's binding domain, known as somatomedin B (SEQ ID NO: 3)

The term “biomarker M”, “peak M”, “biomolecule M” and “molecular entity M” are used interchangeably herein and refer to a biomolecule characterized by having a peak with an apparent time of μS, wherein the error cited represents one standard deviation flight of 35.8887 of the population of observed peaks with this approximate time of flight (see Table 1). Moreover, biomarker M is also referred to as Ur10632 (examples) since it is further characterized as having an average M/Z ratio of 10633.33.

The term “biomarker N”, “peak N”, “biomolecule N” and “molecular entity N” are used interchangeably herein and refer to a biomolecule characterized by having a peak with an apparent time of flight of 36.0876 μS, wherein the error cited represents one standard deviation of the population of observed peaks with this approximate time of flight (see Table 1). Moreover, biomarker N is also referred to as Ur10751 (examples) since it is further characterized as having an average M/Z ratio of 10751.31. Biomarker M has been determined to be PSP94 and/or fragments thereof. PSP93 is a naturally occurring fragment of PSP94, where the two polypeptides are the same for the first 93 amino acids and PSP94 has the one additional amino acid at the C-terminus. In spectroscopy studies, PSP94 and PSP93 would have the same time-of-flight data.

TABLE 1
Definition of peaks in terms of time-of-flight parameters.

99% Confidence Interval

| | Mean | | Minimum | Maximum |
|---|---|---|---|---|
| Peak ID | TOF | StDev | TOF | TOF |
| A | 18.96 | 1.23 | 15.7918 | 22.1282 |
| B | 19.865 | 1.161 | 16.8745 | 22.8555 |
| C | 20.439 | 1.120 | 17.5541 | 23.3239 |
| D | 21.837 | 1.019 | 19.2123 | 24.4617 |
| E | 21.941 | 1.012 | 19.3343 | 24.5477 |
| F | 22.778 | 0.952 | 20.3258 | 25.2302 |
| G | 25.381 | 0.764 | 23.4131 | 27.3489 |
| H | 31.401 | 0.332 | 30.5458 | 32.2562 |
| I | 34.601 | 0.102 | 34.3383 | 34.8637 |
| J | 35.685 | 0.0249 | 35.6209 | 35.7491 |
| K | 35.758 | 0.0197 | 35.7073 | 35.8087 |
| L | 24.5978 | 0.0098 | 24.5965 | 24.5991 |
| M | 35.8887 | 0.0049 | 35.888 | 35.8893 |
| N | 36.0876 | 0.0056 | 36.0868 | 36.0883 |

All times are given in microseconds (μS)

The term “fragment” refers to a portion of a polynucleotide or polypeptide sequence that comprises at least 15 consecutive nucleotides or 5 consecutive amino acid residues, respectively. Furthermore, these “fragments” typically retain the biological activity and/or some functional characteristics of the parent polypeptide e.g. antigenicity or structural domain characteristics.

The term “prostatic secretory protein” or “PSP94” refers to a 94 amino acid protein secreted by the prostate that functions as a tumor suppressor. PSP94 is the mature protein that is amino acid residues 1 to 94 of the full-length 114 amino acid protein of SEQ ID NO:1. The terms “Prostate Secretory protein PSP94”, “PSP94”, “Prostate Secreted Seminal Plasma Protein”, “Seminal Plasma Beta-Inhibin”, “Immunoglobulin-binding factor”, “IGBF”, and “PN44” are used interchangeably herein.

The term “derivative of PSP94” refers to a polypeptide that differs from PSP94 in at least one amino acid. An amino acid difference can be produced by substitution, deletion, or insertion of one or more amino acids in amino acid residues 1 to 94 of SEQ ID NO: 1. A derivative of PSP94 comprises an amino acid sequence with at least 80% sequence identity to residues 1 to 94 of SEQ ID NO: 1. Preferably, the derivative comprises an amino acid sequence with at least about 85% amino acid identity to residues 1 to 94 of SEQ ID NO: 1, an amino acid sequence with at least about 86% amino acid identity to residues 1 to 94 of SEQ ID NO: 1, an amino acid sequence with at least about 87% amino acid identity to residues 1 to 94 of SEQ ID NO: 1, an amino acid sequence with at least about 88% amino acid identity to residues 1 to 94 of SEQ ID NO: 1, an amino acid sequence with at least about 89% amino acid identity to residues 1 to 94 of SEQ ID NO: 1, an amino acid sequence with at least about 90% amino acid identity to residues 1 to 94 of SEQ ID NO: 1, an amino acid sequence with at least about 91% amino acid identity to residues 1 to 94 of SEQ ID NO: 1, an amino acid sequence with at least about 92% amino acid identity to residues 1 to 94 of SEQ ID NO: 1, an amino acid sequence with at least about 93% amino acid identity to residues 1 to 94 of SEQ ID NO: 1, an amino acid sequence with at least about 94% amino acid identity to residues 1 to 94 of SEQ ID NO: 1, an amino acid sequence with at least about 95% amino acid identity to residues 1 to 94 of SEQ ID NO: 1, an amino acid sequence with at least about 96% amino acid identity to residues 1 to 94 of SEQ ID NO: 1, an amino acid sequence with at least about 97% amino acid identity to residues 1 to 94 of SEQ ID NO:1, an amino acid sequence with at least about 98% amino acid identity to residues 1 to 94 of SEQ ID NO: 1, an amino acid sequence with at least about 99% amino acid identity to residues 1 to 94 of SEQ ID NO:1, or an amino acid sequence with at least about 99.5% amino acid identity to residues 1 to 94 of SEQ ID NO:1.

The terms “biological sample” and “test sample” are used interchangeably and refer to all biological fluids and excretions isolated from any given subject. In the context of the invention such samples include, but are not limited to, blood, blood serum, blood plasma, urine, semen, seminal fluid, seminal plasma, prostatic fluid, pre-ejaculatory fluid (Cowper's fluid), excreta, tears, saliva, sweat, biopsy, ascites, cerebrospinal fluid, lymph, marrow, hair or tissue extract samples such as homogenized tissue, and cellular extracts. Tissue samples include samples of tumors.

The term “host cell” refers to a cell which has been transformed or transfected, or is capable of transformation or transfection by an exogenous polynucleotide sequence. It is understood that such terms refer not only to the particular subject cell but also to the progeny or potential progeny of such a cell. Because certain modifications may occur in succeeding generations due to either mutation or environmental influences, such progeny may not, in fact, be identical to the parent cell, but are still included within the scope of the term as used herein.

The term “specific binding” refers to the interaction between two biomolecules that occurs under specific conditions. The binding of two biomolecules is considered to be specific when the interaction between said molecules is substantial. In the context of the invention, a binding reaction is considered substantial when the signal of the peak representing the biomolecule is at least twice that of the signal arising from the coincidental detection of non-biomolecule associated ions in approximately the same mass range, that is the peak as a signal to noise ratio of at least two. Moreover, the phrase “specific conditions” refers to reaction conditions that permit, enable, or facilitate the binding of said molecules such as pH, salt, detergent and other conditions known to those skilled in the art.

The term “interaction” relates to the direct or indirect binding or alteration of biological activity of a biomolecule.

The term “differential diagnosis” refers to a diagnostic decision between healthy and different disease states, including various stages of a specific disease. A subject is diagnosed as healthy or to be suffering from a specific disease, or a specific stage of a disease based on a set of hypotheses that allow for the distinction between healthy and one or more stages of the disease. The choice between healthy and one or more stages of disease depends on a significant difference between each hypothesis. Under the same principle, a “differential diagnosis” may also refer to a diagnostic decision between one disease type as compared to another (e.g. prostate cancer vs. a non-malignant disease of the prostate).

The term “prostate cancer” refers to a malignant neoplasm of the prostate within a given subject, wherein the neoplasm is of epithelial origin and is also referred to as a carcinoma of the prostate. According to the invention, prostate cancer is defined according to its type, stage and/or grade. Typical staging systems known to those skilled in the art include but are not limited to the Jewett-Whitmore system and the TNM system (the system adopted by the American Joint Committee on Cancer and the International Union Against Cancer). A typical grading system is the Gleason Score which is a measure of tumour aggressiveness based on pathological examination of tissue biopsy). The term “prostate cancer”, when used without qualification, includes both localized and metastasised prostate cancer. The term “prostate cancer” can be qualified by the terms “localized” or “metastasised” to differentiate between different types of tumour as those words are defined herein. The terms “prostate cancer” and “malignant disease of the prostate” are used interchangeably herein.

The terms “neoplasm” or “tumour” may be used interchangeably and refer to an abnormal mass of tissue wherein the growth of the mass surpasses and is not coordinated with the growth of normal tissue. A neoplasm or tumour may be defined as “benign” or “malignant” depending on the following characteristics: degree of cellular differentiation including morphology and functionality, rate of growth, local invasion and metastasis. A “benign” neoplasm is generally well differentiated, has characteristically slower growth than a malignant neoplasm and remains localised to the site of origin. In addition a benign neoplasm does not have the capacity to infiltrate, invade or metastasise to distant sites. A “malignant” neoplasm is generally poorly differentiated (anaplasia), has characteristically rapid growth accompanied by progressive infiltration, invasion and destruction of the surrounding tissue. Furthermore, a malignant neoplasm has to capacity to metastasise to distant sites.

The term “differentiation” refers to the extent to which parenchymal cells resemble comparable normal cells both morphologically and functionally.

The term “metastasis” refers to the spread or migration of cancerous cells from a primary (original) tumour to another organ or tissue, and is typically identifiable by the presence of a “secondary tumour” or “secondary cell mass” of the tissue type of the primary (original) tumour and not of that of the organ or tissue in which the secondary (metastatic) tumour is located. For example, a prostate cancer that has migrated to bone is said to be metastasised prostate cancer, and consists of cancerous prostate cancer cells in the prostate as well as cancerous prostate cancer cells growing in bone tissue.

The terms “a non-malignant disease of the prostate”, “non-prostate cancer state” and “benign prostatic disease” may be used interchangeably and refer to a disease state of the prostate that has not been classified as prostate cancer according to specific diagnostic methods including but not limited to rectal palpitation, PSA scoring, transrectal ultrasonography and tissue biopsy. Such diseases include, but are not limited to an inflammation of prostatic tissue (i.e. chronic bacterial prostatitis, acute bacterial prostatitis, chronic abacterial prostatitis) and benign prostate hyperplasia.

In the context of this application, the term “healthy” refers to an absence of any malignant or non-malignant disease of the prostate; thus, a “healthy individual” may have other diseases or conditions that would normally not be considered “healthy”. A “healthy” individual demonstrates an absence of any malignant or non-malignant disease of the prostate.

The term “pre-cancerous lesion of the prostate” or “precancerous prostate lesion” refers to a biological change within the prostate such that it becomes susceptible to the development of a malignant neoplasm. More specifically, a pre-cancerous lesion of the prostate is a preliminary stage of a prostate cancer. Causes of a pre-cancerous lesion may include, but are not limited to, genetic predisposition and exposure to cancer-causing agents (carcinogens); such cancer causing agents include agents that cause genetic damage and induce neoplastic transformation of a cell.

The term “neoplastic transformation of a cell” refers to an alteration in normal cell physiology and includes, but is not limited to, self-sufficiency in growth signals, insensitivity to growth-inhibitory (anti-growth) signals, evasion of programmed cell death, limitless replicative potential, sustained angiogenesis, and tissue invasion and metastasis.

The term “differentially present” refers to differences in the quantity of a biomolecule present in samples taken from prostate cancer patients as compared to samples taken from subjects having a non-malignant disease of the prostate or healthy subjects. Furthermore, a biomolecule is differentially present between two samples if the quantity of said biomolecule in one sample population is significantly different (defined statistically) from the quantity of said biomolecule in another sample population. For example, a given biomolecule may be present at elevated, decreased, or absent levels in samples of taken from subjects having prostate cancer compared to those taken from subjects who do not have a prostate cancer.

The term “biological activity” may be used interchangeably with the terms “biologically active”, “bioactivity” or “activity” and, for the purposes herein, means an effector or antigenic function that is directly or indirectly performed by a biomarker of the invention (whether in its native or denatured conformation), derivative or fragment thereof. Effector functions include phosphorylation (kinase activity) or activation of other molecules, induction of differentiation, mitogenic or growth promoting activity, signal transduction, immune modulation, DNA regulatory functions and the like, whether presently known or inherent. Antigenic functions include possession of an epitope or antigenic site that is capable of cross-reacting with antibodies raised against a naturally occurring or denatured biomarker of the invention, derivative or fragment thereof. Accordingly, a biological activity of such a protein can be that it functions as regulator of a signalling pathway of a target cell. Such a signalling pathway can, for example, modulate cell differentiation, proliferation and/or migration of such a cell, as well as tissue invasion, tumour development and/or metastasis. A target cell according to the invention can be a neoplastic or cancer cell.

The terms “neoplastic cell” and “neoplastic tissue” refer to a cell or tissue, respectively, that has undergone significant cellular changes (transformation). Such cellular changes are manifested by an escape from specific control mechanisms, increased growth potential, alteration in the cell surface, karyotypic abnormalities, morphological and biochemical deviations from the norm, and other attributes conferring the ability to invade, metastasise and kill.

The term “diagnostic assay” can be used interchangeably with “diagnostic method” and refers to the detection of the presence or nature of a pathologic condition. Diagnostic assays differ in their sensitivity and specificity, and their relative usefulness as a diagnostic tool can be measured using ROC-AUC statistics.

Within the context of the invention, the term “true positives” refers to those subjects having a localized or a metastasised cancer of the prostate or a benign prostate disease, a precancerous prostatic lesion, or an acute or a chronic inflammation of prostatic tissue and who are categorized as such by the diagnostic assay. Depending on context, the term “true positives” may also refer to those subjects having either prostate cancer or a non-malignant disease of the prostate, who are categorized as such by the diagnostic assay.

Within the context of the invention, the term “false negatives” refers to those subjects having either a localized or a metastasised cancer of the prostate, a benign prostate disease, a precancerous prostatic lesion, or an acute or a chronic inflammation of prostatic tissue and who are not categorized as such by the diagnostic assay. Depending on context, the term “false negatives” may also refer to those subjects having either prostate cancer or a non-malignant disease of the prostate and who are not categorized as such by the diagnostic assay.

Within the context of the invention, the term “true negatives” refers to those subjects who do not have a localized or a metastasised cancer of the prostate, a benign prostate disease, a precancerous prostatic lesion, or an acute or a chronic inflammation of prostatic tissue and who are categorized as such by the diagnostic assay. Depending on context, the term “true negatives” may also refer to those subjects who do not have prostate cancer or a non-malignant disease of the prostate and who are categorized as such by the diagnostic assay.

Within the context of the invention, the term “false positives” refers to those subjects who do not have a localized or a metastasised cancer of the prostate, a benign prostate disease, a precancerous prostatic lesion, or an acute or a chronic inflammation of prostatic tissue but are categorized by the diagnostic assay as having a localized or metastasised cancer of the prostate, a benign prostate disease, a precancerous prostatic lesion or an acute or chronic inflammation of prostatic tissue. Depending on context, the term “false positives” may also refer to those subjects who do not have prostate cancer or a non-malignant disease of the prostate but are categorized by the diagnostic assay as having prostate cancer or a non-malignant disease of the prostate.

The term “sensitivity”, as used herein in the context of its application to diagnostic assays, refers to the proportion of all subjects with localized or metastasised cancer of the prostate, a benign prostate disease, a precancerous prostatic lesion, or an acute or a chronic inflammation of prostatic tissue that are correctly identified as such (that is, the number of true positives divided by the sum of the number of true positives and false negatives).

The term “specificity” of a diagnostic assay, as used herein in the context of its application to diagnostic assays, refers to the proportion of all subjects with neither localized or metastasised cancer of the prostate nor a benign prostate disease, a precancerous prostatic lesion, or an acute or a chronic inflammation of prostatic tissue that are correctly identified as such (that is, the number of true negatives divided by the sum of the number of true negatives and false positives).

The term “adsorbent” refers to any material that is capable of accumulating (binding) a given biomolecule. The adsorbent typically coats a biologically active surface and is composed of a single material or a plurality of different materials that are capable of binding a biomolecule. Such materials include, but are not limited to, anion exchange materials, cation exchange materials, metal chelators, polynucleotides, oligonucleotides, peptides, antibodies, naturally occurring compounds, synthetic compounds, etc.

The phrase “biologically active surface” refers to any two- or three-dimensional extensions of a material that biomolecules can bind to, or interact with, due to the specific biochemical properties of this material and those of the biomolecules. Such biochemical properties include, but are not limited to, ionic character (charge), hydrophobicity, or hydrophilicity.

The phrase “binding biomolecule” refers to a molecule that displays an affinity for another biomolecule.

The term “immunogen” may be used interchangeably with the phrase “immunising agent” and refers to any substance or organism that provokes an immune response when introduced into the body of a given subject. All immunogens are considered as antigens and, in the context of the invention, can be defined on the basis of their immunogenicity, wherein “immunogenicity” refers to the ability of the immunogen to induce either a humoral or a cell-mediated immune response. In the context of the invention an immunogen that induces a “humoral immune response” activates antibody production and secretion by cells of the B-lymphocyte lineage (B-cells) and thus can be used to for antibody production as described herein. Such immunogens may be polysaccharides, proteins, lipids or nucleic acids, or they may be lipids or nucleic acids that are complexed to either a polysaccharide or a protein.

The term “solution” refers to a homogeneous mixture of two or more substances. Solutions may include, but are not limited to buffers, substrate solutions, elution solutions, wash solutions, detection solutions, standardisation solutions, chemical solutions, solvents, etc.

The phrase “coupling buffer” refers to a solution that is used to promote covalent binding of biomolecules to a biological surface.

The phrase “blocking buffer” refers to a solution that is used to (prevent) block unbound binding sites of a given biological surface from interacting with biomolecules in an unspecific manner.

The term “chromatography” refers to any method of separating biomolecules within a given sample such that the original native state of a given biomolecule is retained. Separation of a biomolecule from other biomolecules within a given sample for the purpose of enrichment, purification and/or analysis, may be achieved by methods including, but not limited to, size exclusion chromatography, ion exchange chromatography, hydrophobic and hydrophilic interaction chromatography, metal affinity chromatography, wherein “metal” refers to metal ions (e.g. nickel, copper, gallium, zinc, iron or cobalt) of all chemically possible valences, or ligand affinity chromatography wherein “ligand” refers to binding molecules, preferably proteins, antibodies, or DNA. Generally, chromatography uses biologically active surfaces as adsorbents to selectively accumulate certain biomolecules.

The phrase “mass spectrometry” refers to a method comprising employing an ionisation source to generate gas phase ions from a biological entity of a sample presented on a biologically active surface, and detecting the gas phase ions with an ion detector. Comparison of the time the gas phase ions take to reach the ion detector from the moment of ionisation with a calibration equation derived from at least one molecule of known mass allows the calculation of the estimated mass to charge ratio of the ion being detected.

The phrases “mass to charge ratio”, “m/z ratio” or “m/z” can be used interchangeably and refer to the ratio of the molecular weight (grams per mole) of an ion detected by mass spectrometry to the number of charges the ion carries. Thus a single biomolecule can be assigned more than one mass to charge ratio by a mass spectrometer if that biomolecule can be ionised into more than one species each of which carries a different number of charges.

The acronym “TOF” refers to the “time-of-flight” of a biomolecule or other molecular entity, such as an ion in a time-of-flight type mass spectrometer. “TOF” values are derived by measuring the duration of flight of an ion, typically between its entry into and exit from a time-of-flight analyser tube. Alternatively, the accuracy of TOF values can be improved by known methods, for example through the use of reflectrons and/or pulsed-laser ionization. TOF values for a given ion can be applied to previously established calibration equations derived from the TOF values for ions of known mass in order to calculate the mass to charge ratio of these ions.

The phrase “calibration equation” refers to a standard curve based on the TOF of biomolecules with known molecular mass. Application of a calibration equation to peaks in a mass spectrum allows the calculation of the m/z ratio of these peaks based on their observed TOF.

The phrase “laser desorption mass spectrometry” refers to a method comprising the use of a laser as an ionisation source to generate gas phase ions from a biomolecule presented on a biologically active surface, and detecting the gas phase ions with a mass spectrometer.

The term “mass spectrometer” refers to a gas phase ion spectrometer that includes an inlet system, an ionisation source, an ion optic assembly, a mass analyser, and a detector.

Within the context of the invention, the terms “detect”, “detection” or “detecting” refer to the identification of the presence, absence, or quantity of a given biomolecule.

The phrase “Mann-Whitney Rank Sum Test” refers to a non-parametric statistical method used to test the null hypothesis that two sets of values that do not have normal distributions are derived from the same population.

The phrase “energy absorbing molecule” and its acronym “EAM” refers to a molecule that absorbs energy from an energy source in a mass spectrometer thereby enabling desorption of a biomolecule from a biologically active surface. Cinnamic acid derivatives, sinapinic acid and dihydroxybenzoic acid, ferulic acid and caffeic acid are frequently used as energy-absorbing molecules in laser desorption of biomolecules. See U.S. Pat. No. 5,719,060 (Hutchens & Yip) for a further description of energy absorbing molecules.

The terms “peak” and “signal” may be used interchangeably, and refer to a defined, non-background value which is generated by a population of a given biomolecule of a certain molecular mass that has been ionised contacting the detector of a mass spectrometer, wherein the size of the population can be roughly related to the degree of the intensity of the signal Typically, this “signal” can be defined by two values: an apparent mass-over-charge ratio (m/z) and an intensity value generated as described.

The phrases “peak intensity”, “intensity of a peak” and “intensity” may be used interchangeably, and refer to the relative amount of a biomolecule contacting the detector of a mass spectrometer in relation to other peaks in the same mass profile. Typically, the intensity of a peak is expressed as the maximum observed signal within a defined mass range that adequately defines the peak.

The phrases “signal to noise ratio”, “SN ratio” and “SN” may be used interchangeably, and refer to the ratio of a peak”s intensity and a dynamically calculated value representing the average background signal detected in the approximate mass range of the peak. The SN ratio of a peak is typically used as an objective criterion for (a) computer-assisted peak detection and/or (b) manual evaluation of a peak as being an artefact.

The term “cluster” refers to a peak that is present in a certain set of mass spectra or mass profiles obtained from different samples belonging to two or more different groups (e.g. subjects with prostate cancer and healthy subjects). Within the set of spectra, the peaks or signals belonging to a given cluster can differ in their intensities, but not in the apparent molecular masses.

The term “classifier” refers to an algorithm or methodology which is using one or more defined traits or attributes to subdivide a population individual patients or samples or elements of data into a finite number of groups with as great a degree of accuracy as possible.

The term “tree” refers to a type of classifier consisting of a branching series of decision points (typically referred to as “leaves” or “nodes”) that eventually lead to the classification of individual patients or samples or elements of data from a population into one of a finite number of groups.

The phrase “mass profile” refers to a series of discrete, non-background noise peaks that are defined by their mass to charge ratio and are characteristic of an individual mass spectrum.

The acronym “ROC-AUC” refers to the area under a receiver operator characteristic curve. This is a widely accepted measure of diagnostic utility of some tool, taking into account both the sensitivity and specificity of the tool. Typically, ROC-AUC ranges from 0.5 to 1.0, where a value of 0.5 indicates the tool has no diagnostic value and a value of 1.0 indicates the tool has 100% sensitivity and 100% specificity.

The term “sensitivity” refers to the proportion of patients with the outcome in whom the results of the decision rule are abnormal. Typically, the outcome is disadvantageous to the patient. The term “specificity” refers to the proportion of patients without the outcome in whom the results of the decision rule are normal.

It is to be understood that the present invention is not limited to the particular materials and methods described or equipment, as these may vary. It is also to be understood that the terminology used herein is for the purpose of describing particular embodiments only, and is not intended to limit the scope of the present invention, which will be limited only by the appended claims.

It should be noted that as used herein and in the appended claims, the singular forms “a,” “an,” and “the” include plural reference unless the context clearly dictates otherwise. Thus, for example, a reference to “an antibody” is a reference to one or more antibodies and derivatives thereof known to those skilled in the art, and so forth.

### PSP94

PSP94 is a versatile protein that plays are role in several biological processes within the reproductive tract ranging from modulating the circulation of follicle-stimulating hormone (FSH) to inducing apoptosis in prostate cancer cells (Sheth et al. 1984; Chao et al. 1996; Hirano et al. 1996; Garde et al. 1999; Shukeir et al. 2003). It is one of the three major protein secreted by the normal human prostate gland. As a secreted protein, this molecule is found in a variety of bodily fluids including serum (Teni et al. 1988; Reeves et al. 2005; van Huizen et al. 2005), urine (Teni et al. 1988; Liu et al. 1993), seminal plasma fluid (Sheth et al 1984; Dubé et al. 1987a; von der Kammer et al. 1991) and mucous gland secretions (Weiber et al. 1990). PSP94 occurs in both the free and bound forms in serum (Wu et al 1999).

Several groups have demonstrated that PSP94 has the clinical potential to becoming a relevant biomarker for prostate cancer (Dubé et al. 1987b, Tremblay et al. 1987; Abrahamsson et al. 1988; Teni et al. 1988; Abrahamsson et al. 1989; Teni et al. 1989; von der Kammer et al. 1990; Huang et al. 1993; Hyakutake et al. 1993; von der Kammer et al. 1993, Maeda et al. 1994; Tsurusaki et al. 1998, Sakai et al. 1999). Abnormal protein levels in serum are indicative of prostate cancer, wherein the irregular or erratic control of PSP94 secretion from the prostate is correlated with neoplasia (Wu et al. 1999). While most diagnostic methods utilising PSP94 as a discriminator for prostate cancer focus on detecting abnormal levels of the protein in serum samples (von der Kammer et al 1990; von der Kammer et al. 1993; Wu et al. 1999; U.S. Pat. No. 6,107,103; US 2006/0029984; WO 02/46448; WO 03/093474), others base their capabilities on detecting abnormal levels of PSP94 in urine samples (Teni et al. 1988; Teni et al. 1989) or in seminal plasma fluid (von der Kammer et al. 1990).

PSP94 has the following sequence:

MNVLLGSVVIFATFVTLCNASCYFIPNEGVPGDSTRKCMDLKGNKHPNSE
WQTDNCETCTCYETEISCCTLVSTPVGYDKDNCQRLFKKEDCKYIVVEKK
DPKKTCSVSEWII
(SEQ ID NO: 1; Accession No. AAB29732.1/GI:46O569)

### Vitronectin

Vitronectin (known alternatively as Serum-spreading factor, S-protein and V75) is an adhesive glycoprotein which is said to be multifunctional in terms of abilities. It provides connection between cellular functions. These functions include humoral immunity defense mechanisms as well as cell adhesion and invasion. Vitronectin may be found in circulation, amniotic fluid and in urine as well (Preissner 1991). The role of Vitronectin in cellular adhesion makes it an intriguing candidate in the study, diagnosis and treatment of prostate cancer and its metastatic state. Vitronectin has the following sequence:

MAPLRPLLILALLAWVALADQESCKGRCTEGFNVDKKCQCDELCSYYQSC
CTDYTAECKPQVTRGDVFTMPEDEYTVYDDGEEKNNATVHEQVGGPSLTS
DLQAQSKGNPEQTPVLKPEEEAPAPEVGASKPEGIDSRPETLHPGRPQPP
AEEELCSGKPFDAFTDLKNGSLFAFRGQYCYELDEKAVRPGYPKLRIDVW
GIEGPIDAFTRINCQGKTYLFKGSQYVRFEDGVLDPDYPRNISDGFDGIP
DNVDAALALPAHSYSGRERVYFFKGKQYWEYQFQHQPSQEECEGSSLSAV
FEHFAMMQRDSWEDIFELLFWGRTSAGTRQPQFISRDWHGVPGQVDAAMA
GRIYISGMAPRPSLAKKQRFRHRNRKGYRSQRGHSRGRNQNSRRPSRAMW
LSLFSSEESNLGANNYDDYRMDWLVPATCEPIQSVFFFSGDKYYRVNLRT
RRVDTVDPPYPRSIAQYWLGCPApGHL
(SEQ ID NO: 2; Accession No. AAH05046.1
GI:13477169).

### Diagnostic Tools

The invention described herein takes advantage of the capabilities of SELDI-MS to detect and identify biomarkers capable of correctly classifying samples as those originating from patients having prostate cancer versus having a non-prostate cancer disease. The biomarkers described can include biomarker A, B, C, D, E, F, G, H, I, J, K, L, M, N, or a combination thereof.

Although PSP94 has been shown to be a useful discriminatory factor for diagnosis and/or prognosis of prostate cancer, diagnostic tools utilizing this protein are both invasive and lacking sensitivity. A diagnostic tool utilising a combination panel of A, B, C, D, E, F, G, H, I, J, K, L, M, N, or a combination thereof has not yet been described. This panel improves the discriminatory value for prostate cancer over each of the markers when used alone. In addition to this, urine samples are the preferred samples for diagnostic tools described herein, making the test ideal for clinical application. Embodiments of the invention are non-invasive and cost-effective.

The present invention relates to methods for differential diagnosis of prostate cancer or a non-malignant disease of the prostate by detecting one or more differentially expressed biomolecule within a biological sample of a given subject, comparing results with samples from healthy subjects, subjects having a non-malignant disease of the prostate and subjects having prostate cancer, wherein the comparison allows for the differential diagnosis of a subject as healthy, having non-malignant disease of the prostate or having prostate cancer.

One aspect of the invention includes a method for diagnosing prostate cancer in a subject comprising: (a) detecting a quantity, presence or absence of a biomarker, which can be A, B, C, D, E, F, G, H, I, J, K, L, M, N, or a combination thereof, in a biological sample; and (b) classifying the subject as having or not having prostate cancer.

In an embodiment of the invention, the step of classifying the subject comprises comparing the quantity, presence or absence of the biomarker(s) with a reference biomarker panel indicative of a prostate cancer. The reference biomarker panel comprises one or more biomarkers previously characterised as being diagnostic for prostate cancer.

A further aspect of the invention includes a method for differential diagnosis of prostate cancer and non-malignant disease of the prostate in a subject, comprising: (a) detecting a quantity, presence or absence of a biomarker, which can be biomarker A, B, C, D, E, F, G, H, I, J, K, L, M, N, or a combination thereof, in a biological sample; and (b) classifying the subject as having prostate cancer, non-malignant disease of the prostate, or as healthy, based on the quantity, presence or absence of the one or more biomarkers in the biological sample.

In an embodiment of the invention, the step of classifying the subject comprises comparing the quantity, presence or absence of the biomarker(s) with a reference biomarker panel indicative of prostate cancer and a reference biomarker panel indicative of a non-malignant disease of the prostate. The reference biomarker panels comprise one or more biomarkers previously characterised as being diagnostic for prostate cancer or for a non-malignant disease of the prostate.

A further aspect of the invention includes a method for differential diagnosis of healthy, non-malignant disease of the prostate, precancerous prostatic lesion, localized cancer of the prostate, metastasised cancer of the prostate, and acute or chronic inflammation of prostatic tissue in a subject, comprising: (a) detecting the quantity, presence or absence of a biomarker, which can be biomarker A, B, C, D, E, F, G, H, I, J, K, L, M, N, or a combination thereof, in a biological sample; and (b) classifying the subject as having non-malignant disease of the prostate, precancerous prostate lesion, localized cancer of the prostate, metastasised cancer of the prostate, and/or acute or chronic inflammation of prostatic tissue, or as healthy, based on the quantity, presence or absence of the one or more biomarkers in the biological sample. Each of the reference biomarker panels comprise one or more biomarkers for good health, non-malignant disease of the prostate, precancerous prostate lesion, localized cancer of the prostate, metastasised cancer of the prostate, and/or acute or chronic inflammation of prostatic tissue.

A further aspect of the invention includes a method for differential diagnosis of healthy, non-malignant disease of the prostate, precancerous prostatic lesion, localized cancer of the prostate, metastasised cancer of the prostate, and acute or chronic inflammation of prostatic tissue in a subject, comprising: (a) detecting the quantity, presence or absence of biomarker A, B, C, D, E, F, G, H, I, J, K, L, M, N, or a combination thereof, in a biological sample; and (b) classifying the subject as having non-malignant disease of the prostate, precancerous prostate lesion, localized cancer of the prostate, metastasised cancer of the prostate, and/or acute or chronic inflammation of prostatic tissue, or as healthy, based on the quantity, presence or absence of the one or more biomarkers in the biological sample. Each of the reference biomarker panels comprise one or more biomarkers for good health, non-malignant disease of the prostate, precancerous prostate lesion, localized cancer of the prostate, metastasised cancer of the prostate, and/or acute or chronic inflammation of prostatic tissue. In addition, each of the reference biomarker panels comprise two or more biomarkers for good health, non-malignant disease of the prostate, precancerous prostate lesion, localized cancer of the prostate, metastasised cancer of the prostate, and/or acute or chronic inflammation of prostatic tissue.

In one embodiment of the invention, a method for differential diagnosis of prostate cancer or a non-malignant disease of the prostate comprises: contacting a biological sample with an adsorbent present on a biologically active surface under specific binding conditions, allowing the biomolecules within the biological sample to bind to said adsorbent, detecting one or more bound biomolecules using a detection method, wherein the detection method generates a mass profile of said sample, transforming the mass profile generated into a computer-readable form, and comparing the mass profile of said sample with a database containing mass profiles from comparable samples specific for healthy subjects, subjects having prostate cancer, and/or subjects having a non-malignant disease of the prostate. The outcome of said comparison will allow for the determination of whether the subject from which the biological sample was obtained, is healthy, has a non-malignant disease of the prostate and/or prostate cancer based on the presence, absence or comparative quantity of specific biomolecules.

In one embodiment, a biologically active surface comprises an adsorbent comprising silicon dioxide molecules. In another embodiment, a biologically active surface comprises an adsorbent comprised of antibodies. Antibodies may be antibodies specific to a biomarker, which can include biomarker A, B, C, D, E, F, G, H, I, J, K, L, M, N, or a combination thereof. Biologically active surfaces useful for practicing the methods of the invention are further described in greater detail below.

The quantity, presence, or absence of the one or more biomarkers in a biological sample obtained from a subject may be determined by mass spectrometry. A method of mass spectrometry may be selected from the group consisting of matrix-assisted laser desorption time/time of flight (MALDI-TOF), surface enhanced laser desorption ionisation/time of flight (SELDI-TOF), liquid chromatography, MS-MS, or ESI-MS. Detection methods useful for practicing the methods of the invention are further described in greater detail below.

In addition, other methods of determining the quantity, presence or absence of the one or more biomolecules in a biological sample can be utilized, such as ELISA utilizing antibodies targeted to a biomarker of the invention. In any of the embodiments of the methods described above, a single biomolecule or a combination of more than one biomolecule selected from the group of biomarker A, B, C, D, E, F, G, H, I, J, K, L, M, N, and a combination thereof, may be detected within a given biological sample. Detection of a single or a combination of more than one biomolecule of the invention is based on specific sample pre-treatment conditions, the pH of binding conditions, the adsorbent used on the biologically active surface, and the calibration equation used to determine the TOF of the given biomolecules.

In one embodiment of the invention, a biomolecule of the invention can include biomarker A, B, C, D, E, F, G, H, I, J, K, L, M, N, or a combination thereof, and may be used individually to diagnose a subject as being healthy, or having a non-malignant disease of the prostate, or having a precancerous prostatic lesion, or having a localized cancer of the prostate, or having a metastasised cancer of the prostate, or having an acute or a chronic inflammation of prostatic tissue. In another embodiment of the invention, biomolecules that can include biomarker A, B, C, D, E, F, G, H, I, J, K, L, M, N, or a combination thereof may be used in combination with one another to diagnose a subject as being healthy, or having of a non-malignant disease of the prostate, or having a precancerous prostatic lesion, or having a localized cancer of the prostate, or having a metastasised cancer of the prostate, or having an acute or a chronic inflammation of prostatic tissue. Preferred are biomarkers selected from the group consisting of biomarker A, B, C, D, E, F, G, H, I, J, K, L, M, N, or a combination thereof. For example, biomarker N may be used in combination with one or more biomarkers, including biomarker M and L, to diagnose a subject as being healthy, or having of a non-malignant disease of the prostate or having a precancerous prostatic lesion or having a localized cancer of the prostate or having a metastasised cancer of the prostate or having an acute or a chronic inflammation of prostatic tissue. To further clarify the preceding example, biomarker N may be used together with biomarker M to differentially diagnose a subject as being healthy, or having of a non-malignant disease of the prostate, or having a precancerous prostatic lesion, or having a localized cancer of the prostate, or having a metastasised cancer of the prostate, or having an acute or a chronic inflammation of prostatic tissue. Furthermore, biomarker N may also be used together with biomarker M and L to differentially diagnose a subject as being healthy, having a non-malignant disease of the prostate, or having prostate cancer. In addition, biomarker N may also be used together with biomarker M, to differentially diagnose a subject as being healthy, or having of a non-malignant disease of the prostate, or having a precancerous prostatic lesion, or having a localized cancer of the prostate, or having a metastasised cancer of the prostate, or having an acute or a chronic inflammation of prostatic tissue. In addition, biomarker N may also be used together with biomarker M and L to differentially diagnose a subject as being healthy, or having of a non-malignant disease of the prostate, or having a precancerous prostatic lesion, or having a localized cancer of the prostate, or having a metastasised cancer of the prostate, or having an acute or a chronic inflammation of prostatic tissue. Similarly, these combinations can be used to merely identify and diagnose prostate cancer, or to differentiate between prostate cancer and BPH, for example. This preceding example is intended for clarity only and is not intended to limit the scope of the invention.

In yet another embodiment of the invention, detection and/or quantification of biomolecules, including biomarker A, B, C, D, E, F, G, H, I, J, K, L, M, N, or a combination thereof, may be used in combination with another diagnostic tool to diagnose a subject as being healthy, or having a non-malignant disease of the prostate, or having a precancerous prostatic lesion, or having a localized cancer of the prostate, or having a metastasised cancer of the prostate, or having an acute or a chronic inflammation of prostatic tissue. For example, biomarker N may be used in combination with other diagnostic tools specific for prostate cancer detection such as, but not limited to, prostate specific antigen (PSA) testing, DRE, rectal palpitation, biopsy evaluation using Gleason scoring, radiography and symptomological evaluation by a qualified clinician.

Methods for detecting biomolecules according to the invention have many applications. For example, a single biomolecule or a combination of more than one biomolecule, which can include biomarker A, B, C, D, E, F, G, H, I, J, K, L, M, N, or a combination thereof, can be measured to differentiate between healthy subjects, subjects having a non-malignant disease of the prostate, subjects having a precancerous prostatic lesion, or subjects having a localized cancer of the prostate, or subjects having a metastasised cancer of the prostate, or subjects with an acute or a chronic inflammation of prostatic tissue, and thus are useful as an aid in diagnosis of a non-malignant disease of the prostate, or a precancerous prostatic lesion, or a localized cancer of the prostate, or a metastasised cancer of the prostate, or an acute or a chronic inflammation of prostatic tissue. Alternatively, said biomolecules may be used to diagnose a subject as being healthy.

For example, biomarker N may be present only in biological samples from patients having prostate cancer. Mass profiling of two biological samples from different subjects, X and Y, reveals the presence of biomarker N in a sample from test subject X, and the absence of the same biomarker in a test sample from subject Y. The medical practitioner is able to diagnose subject X as having prostate cancer and subject Y as not having prostate cancer. In yet another example, three biomarkers: biomarker L and N, or M, are present in varying quantities in samples specific for benign prostate hyperplasia (BPH) and prostate cancer. Biomarker L is more present in samples specific for prostate cancer than BPH. Biomarker M is not detected in samples from subjects having prostate cancer but in those having BPH, whereas biomarker N is only present in samples from healthy subjects. Analysis of a biological sample reveals the presence of biomarker L and absence of biomarker N. The medical practitioner is able to diagnose the test subject as having prostate cancer. These examples are solely used for the purpose of clarification and are not intended to limit the scope of this invention.

Another aspect of the invention includes a method for in vitro diagnosis of a prostate cancer in a subject comprising detecting differentially expressed biomarkers in a biological sample by: (a) contacting the sample with a binding molecule specific for a biomarker, which can be biomarker A, B, C, D, E, F, G, H, I, J, K, L, M, N, or a combination thereof, and (b) detecting the quantity, presence or absence of the one or more biomarker in the sample, wherein the quantity, presence or absence of the biomarker(s) allows for diagnosis of the subject as healthy or having prostate cancer.

A further aspect of the invention includes a method for in vitro differential diagnosis of prostate cancer and non-malignant disease of the prostate in a subject, comprising detecting one or more differentially expressed biomarkers in a biological sample: (a) contacting the sample with a binding molecule specific for a biomarker, which can be biomarker A, B, C, D, E, F, G, H, I, J, K, L, M, N, or a combination thereof, and (b) detecting the quantity, presence or absence of the one or more biomarker in the sample, wherein the quantity, presence or absence of the biomarker(s) allows for the differential diagnosis of the subject as having prostate cancer, and/or having a non-malignant disease of the prostate, or as being healthy.

Still a further aspect of the invention includes a method for in vitro differential diagnosis of healthy, prostate cancer, non-malignant disease of the prostate, precancerous prostatic lesion, localized cancer of the prostate, metastasised cancer of the prostate, and acute or chronic inflammation of prostatic tissue in a subject, comprising detection of one or more differentially expressed biomarkers in a biological sample by: (a) contacting the sample with a binding molecule specific for a biomarker, which can be biomarker A, B, C, D, E, F, G, H, I, J, K, L, M, N, or a combination thereof, and (b) detecting the quantity, presence or absence of the one or more biomarker; wherein the presence or absence of the biomarker(s) allows for the differential diagnosis of the subject as healthy, having non-malignant disease of the prostate, precancerous prostate lesions, localized cancer of the prostate, metastasised cancer of the prostate, and/or having acute or chronic inflammation of the prostate, or as being healthy.

In an embodiment of any of the methods for in vitro diagnosis described above, an in vitro binding assay can be used to detect a biomolecule selected from the group of biomarker A, B, C, D, E, F, G, H, I, J, K, L, M, N, or a combination thereof, within a biological sample of a given subject. A given biomolecule of the invention can be detected within a biological sample by contacting the biological sample from a given subject with specific binding molecule(s) under conditions conducive for an interaction between the given binding molecule(s) and a biomolecule that can be biomarker A, B, C, D, E, F, G, H, I, J, K, L, M, N, or a combination thereof.

If a given biomolecule is present in a biological sample, it will form a complex with its binding molecule. To determine if a quantity of the detected biomolecule in a biological sample is comparable to a given quantity for healthy subjects, subjects having a non-malignant disease of the prostate, subjects having a precancerous prostatic lesion, subjects having a localized cancer of the prostate, subjects having a metastasised cancer of the prostate or subjects with an acute or a chronic inflammation of prostatic tissue, the amount of the complex formed between a binding molecule and a biomolecule, which can be biomarker A, B, C, D, E, F, G, H, I, J, K, L, M, N, or a combination thereof, can be determined by comparing to a standard. For example, if the amount of the complex falls within a quantitative value for healthy subjects, then the sample can be considered to be obtained from a healthy subject. If the amount of the complex falls within a quantitative value for subjects known to have a non-malignant disease of the prostate, then the sample can be considered to be obtained from a subject having a non-malignant disease of the prostate. If the amount of the complex falls within a quantitative range for subjects known to have prostate cancer, then the sample can be considered to have been obtained from a subject having prostate cancer. In vitro binding assays that are included within the scope of the invention are those known to the skilled in the art (i.e. ELISA, western blotting).

In further aspects, an embodiment of the invention further provides in vivo and in vitro methods for differential diagnosis of prostate cancer or a non-malignant disease of the prostate comprising: detecting of one or more differentially expressed biomolecules that can include biomaker A, B, C, D, E, F, G, H, I, J, K, L, M, N, or a combination thereof, within a given biological sample. This method comprises obtaining a biological sample from a subject, contacting said sample with a binding molecule specific for a differentially expressed biomolecule, detecting an interaction between the binding molecule and its specific biomolecule, wherein the detection of an interaction indicates the presence or absence of said biomolecule, thereby allowing for the differential diagnosis of a subject as healthy, or having a non-malignant disease of the prostate, or having a precancerous prostatic lesion, or having a localized cancer of the prostate, or having a metastasised cancer of the prostate, or having an acute or a chronic inflammation of prostatic tissue.

Binding molecules include, but are not limited to, nucleic acids, nucleotides, oligonucleotides, polynucleotides, amino acids, peptides, polypeptides, proteins, monoclonal and/or polyclonal antibodies, antigens, sugars, carbohydrates, fatty acids, lipids, steroids, or combinations thereof (e.g. glycoproteins, ribonucleoproteins, lipoproteins), compounds or synthetic molecules. In one preferred embodiment, binding molecules are antibodies specific for any one of the biomolecules selected from the group of biomarker A, B, C, D, E, F, G, H, I, J, K, L, M, N, or a combination thereof. Biomolecules detected using the above-mentioned binding molecules include, but are not limited to, molecules comprising nucleic acids, nucleotides, oligonucleotides, polynucleotides, amino acids, peptides, polypeptides, proteins, monoclonal and/or polyclonal antibodies, antigens, sugars, carbohydrates, fatty acids, lipids, steroids, and combinations thereof (e.g., glycoproteins, ribonucleoproteins, lipoproteins). Preferably, biomolecules that are detected using the above-mentioned binding molecules include nucleic acids, nucleotides, oligonucleotides, polynucleotides, amino acids, peptides, polypeptides, proteins, monoclonal and/or polyclonal antibodies. In a more preferred embodiment, binding molecules are amino acids, peptides, polypeptides, proteins, monoclonal and/or polyclonal antibodies.

For example, in vivo, antibodies or fragments thereof may be utilised for the detection of one or more biomolecule(s) selected from the group of biomarker A, B, C, D, E, F, G, H, I, J, K, L, M, N, and a combination thereof, in a biological sample comprising: applying a labelled antibody directed against a given biomolecule of the invention to said biological sample under conditions that favour an interaction between the labelled antibody and its corresponding biomolecule. Depending on the nature of the biological sample, it is possible to determine not only the presence of a biomolecule, but also its cellular distribution. For example, in a blood serum sample, only the serum levels of a given biomolecule can be detected, whereas its level of expression and cellular localisation can be detected in histological samples. It will be obvious to those skilled in the art, that a wide variety of methods can be modified in order to achieve such detection.

In another example, an antibody directed against a biomolecule of the invention that is coupled to an enzyme is detected using a chromogenic substrate that is recognised and cleaved by the enzyme to produce a chemical moiety, which is readily detected using spectrometric, fluorimetric or visual means. Enzymes used to for labelling include, but are not limited to, malate dehydrogenase, staphylococcal nuclease, delta-5-steroid isomerase, yeast alcohol dehydrogenase, alpha-glycerophosphate, dehydrogenase, triose phosphate isomerase, horseradish peroxidase, alkaline phosphatase, asparaginase, glucose oxidase, beta-galactosidase, ribonuclease, urease, catalase, glucose-6-phosphate dehydrogenase, glucoamylase and acetylcholinesterase. Detection may also be accomplished by visual comparison of the extent of the enzymatic reaction of a substrate with that of similarly prepared standards. Alternatively, radio-labelled antibodies can be detected using a gamma or a scintillation counter, or they can be detected using autoradiography. In another example, fluorescently labelled antibodies are detected based on the level at which the attached compound fluoresces following exposure to a given wavelength. Fluorescent compounds typically used in antibody labelling include, but are not limited to, fluorescein isothiocynate, rhodamine, phycoerthyrin, phycocyanin, allophycocyani, o-phthaldehyde and fluorescamine. In yet another example, antibodies coupled to a chemi- or bioluminescent compound can be detected by determining the presence of luminescence. Such compounds include, but are not limited to, luminal, isoluminal, theromatic acridinium ester, imidazole, acridinium salt, oxalate ester, luciferin, luciferase and aequorin.

Furthermore, in vivo techniques for detecting a biomolecule include introducing into a subject a labelled antibody directed against a biomolecule, which can be biomarker A, B, C, D, E, F, G, H, I, J, K, L, M, N, or a combination thereof.

In addition, the methods of the invention for the differential diagnosis of healthy subjects, subjects having a non-malignant disease of the prostate, subjects having a precancerous prostatic lesion, subjects having a localized cancer of the prostate, subjects having a metastasised cancer of the prostate and/or subjects having an acute or chronic inflammation of prostatic tissue, described herein may be combined with other diagnostic methods to improve the outcome of the differential diagnosis. Other diagnostic methods are known to those skilled in the art.

As shown in the example above (for the differentiation of prostate cancer from benign prostate hyperplasia), methods of the invention can also be used for the differential diagnosis of healthy subjects, subjects having a precancerous prostatic lesions, subjects having a non-malignant disease of the prostate, subjects having a localized cancer of the prostate, subjects having metastasised cancer of the prostate, and/or subjects having acute or chronic inflammation of the prostate, or any two or more of the above states.

In general, for an equivalent number of patients categorized (i.e., for a data set of the same size), one would expect a database divided into three classes (healthy, having non-malignant disease of the prostate, having prostate cancer) to have a greater diagnostic accuracy when used for diagnosing patients, as compared to a database divided into six classes (healthy, having non-malignant disease of the prostate, having localized cancer of the prostate, having metastasised cancer of the prostate, having precancerous prostatic lesions, and having acute or chronic inflammation of prostatic tissue). One would also reasonably expect that an increase in the data characterized (i.e., number of patients entered into the database) would result in an improvement in the diagnostic accuracy of the database. The invention can also be used for the differential diagnosis of any two or more of the six classes described herein.

One would also expect, in general, that a database utilizing at least two biomolecules, which can be biomarker A, B, C, D, E, F, G, H, I, J, K, L, M, N, or a combination thereof, would have greater sensitivity and specificity than a database utilizing only one of these biomolecules. For example, to differentiate between non-malignant disease of the prostate and prostate cancer, a database utilizing just one biomolecule (biomarker N) may be enough to have acceptable sensitivity and specificity, whereas a larger number of biomolecules may be necessary to differentiate between, for example, prostate cancer and a non-malignant disease of the prostate.

The biomolecules detected in a given biological sample using the diagnostic methods of the invention are further described herein.

The binding molecules used to detect the biomolecules of the invention are further described herein.

The biological samples used in the diagnostic methods of the invention are described herein.

### Database

In another aspect of the invention, a database comprises mass profiles specific for healthy subjects, subjects having a non-malignant disease of the prostate or prostate cancer is generated by contacting biological samples isolated from above-mentioned subjects with an adsorbent on a biologically active surface under specific binding conditions, allowing the biomolecules within said sample to bind said adsorbent, detecting one or more bound biomolecules using a detection method wherein the detection method generates a mass profile of said sample, transforming the mass profile) data into a computer-readable form and applying a mathematical algorithm to classify the mass profile as specific for healthy subjects, subjects having a non-malignant disease of the prostate and prostate cancer.

Alternatively, mass profile specificity can be further differentiated into patients known to be healthy subjects, subjects with non-malignant disease of the prostate, subjects with localized cancer of the prostate, subjects with metastasized cancer of the prostate, subjects having precancerous prostatic lesions, and subjects with acute or chronic inflammation of prostatic tissue.

According to the invention, classifying mass profiles is performed using a mathematical algorithm that assesses a detectable level of some combination of one or two or three or four or five or six or seven or eight or nine or ten or eleven or twelve or thirteen or fourteen of the biomolecules, or its derivative, either in conjunction with or independent of other clinical parameters, to correctly categorize an individual sample as originating from a healthy patient, a patient with a non-malignant disease of the prostate or a patient with prostate cancer, or, as described above, to further categorize an individual sample as originating from a healthy subject, having a non-malignant disease of the prostate, a subject having a localized cancer of the prostate, a subject having a metastasised cancer of the prostate, a subject having precancerous prostatic lesions, or a subject with acute or chronic inflammation of prostatic tissue.

In general, for an equivalent number of patients categorized (i.e., for a data set of the same size), one would expect a database divided into three classes (healthy, having non-malignant disease of the prostate, having prostate cancer) to have a greater diagnostic accuracy as compared to a database divided into six classes (healthy, having non-malignant disease of the prostate, having localized cancer of the prostate, having metastasised cancer of the prostate, having precancerous prostatic lesions, and having acute or chronic inflammation of prostatic tissue). One would also reasonably expect that an increase in the data characterized (i.e., number of patients entered into the database) would result in an improvement in the diagnostic accuracy of the database. In another aspect of the invention, a database of mass spectrometric profiles obtained from patients of known diagnoses can be used to provide a comparative training set of spectra for use in diagnosis of an unknown sample from which a test mass spectrometric profile has been obtained. For example, such a diagnostic method would compare some combination of one or two or three or four or five or six or seven or eight or nine or ten or eleven or twelve or thirteen or fourteen biomolecules, which can include biomarker A, B, C, D, E, F, G, H, I, J, K, L, M, N, or a combination thereof, detected in the test mass spectrometric profile with those retained in the database in order to identify the training mass spectrometric profile(s) to which the test mass spectrometric profile is the most similar. By taking a weighted majority vote of the training profile(s) thus identified a diagnosis of the sample from which the test mass spectrometric profile was derived can be made.

In more than one embodiment, one or more biomolecules, which can be biomarker A, B, C, D, E, F, G, H, I, J, K, L, M, N, or a combination thereof, may be detected within a given biological sample. Detection of said biomolecules of the invention is based on the type of biologically active surface used for the detection of biomolecules within a given biological sample. Biomolecules of the invention can be bound to an adsorbent on a biologically active surface under specific binding conditions following direct application of a given sample to a given biologically active surface. For example, a given sample is applied to a biologically active surface comprising an adsorbent consisting of silicon dioxide molecules and biomolecules within the given sample that are detected using mass spectrometry.

A further aspect of the invention comprises memory for storing data for access by an application program being executed on a data processing system for diagnosing a prostate cancer or a non-malignant prostate disease, comprising a data structure stored in the memory, the data structure including information resident in a database used by the application program and including one or more reference biomolecule(s)/biomarker panel(s) stored in the memory having a plurality of mass profiles associated with one or more biomolecule(s) or biomarker(s) previously defined as being characteristic of a prostate cancer or a non-malignant disease of the prostate; wherein each of the mass profiles has been transformed into a computer readable form. The database may be any of the database embodiments described above.

Biomolecules detected in a given biological sample for the purpose of generating a database are further described herein.

Biological samples used in the diagnostic methods of the invention are described herein.

Biological samples used to generate a database of mass profiles for healthy subjects, subjects having a non-malignant disease of the prostate, and those having prostate cancer are described herein.

Biological samples used to generate a database of mass profiles for healthy subjects, subjects having non-malignant disease of the prostate, subjects having localized cancer of the prostate, subjects having metastasised cancer of the prostate, subjects having precancerous prostatic lesions, and those subjects having acute or chronic inflammation of prostatic tissue, are described herein.

### Molecules of the Invention

Differential expression of biomolecules in samples from healthy subjects, subjects having a non-malignant disease of the prostate, and subjects having prostate cancer allows for differential diagnosis of a prostate cancer or a non-malignant disease of the prostate within a given subject. Accordingly, biomolecules discovered and characterized herein can be isolated and further characterized using standard laboratory techniques, and used to determine novel treatments for prostate cancer and non-malignant disease of the prostate. Knowledge of the association of these biomolecules with prostatic cancer and benign prostate disease can be used, for example, to treat patients with the biomolecule, an antibody specific to the biomolecule, or an antagonist of the biomolecule.

Biomolecules are said to be specific for a particular clinical state (e.g. healthy, healthy, a precancerous prostatic lesion, a non-malignant disease of the prostate, localized cancer of the prostate, metastasised cancer of the prostate, acute or chronic inflammation of the prostate) when they are present at different levels within samples taken from subjects in one clinical state as compared to samples taken from subjects from other clinical states (e.g. in subjects with a non-malignant disease of the prostate vs. in subjects with prostate cancer). Biomolecules may be present at elevated levels, at decreased levels, or altogether absent within a sample taken from a subject in a particular clinical state (e.g. healthy, non-malignant disease of the prostate, prostate cancer). The following hypothetical example is used for further clarity only, and is not be construed as an admission of the invention: biomarker N and/or M are found at elevated levels in samples isolated from healthy subjects as compared to samples isolated from subjects having a malignant disease of the prostate, or a prostate cancer. Whereas, biomarker L is found at elevated levels and/or more frequently in samples isolated from subjects having prostate cancer as opposed to subjects in good health, or having a non-malignant disease of the prostate. Biomarker N and/or M are said to be specific for healthy subjects, whereas biomarker L is specific for subjects having prostate cancer.

Accordingly, a differential presence of one or more biomolecules, which can include biomarker A, B, C, D, E, F, G, H, I, J, K, L, M, N, or a combination thereof, found in a given biological sample provide useful information regarding probability of whether a subject being tested has a non-malignant disease of the prostate, prostate cancer or is healthy. The probability that a subject being tested has a non-malignant disease of the prostate, prostate cancer or is healthy depends on whether the quantity of one or more biomolecules selected from the group of biomarker A, B, C, D, E, F, G, H, I, J, K, L, M, N, or a combination thereof, in a test sample taken from said subject is statistically significantly different from the quantity of one or more biomolecules selected from the group of biomarker A, B, C, D, E, F, G, H, I, J, K, L, M, N, or a combination thereof, in a biological sample taken from healthy subjects, subjects having a non-malignant disease of the prostate or subjects having prostate cancer.

Biomolecules of the invention may include any biomolecule that is produced by a cell or living organism, and may have any biochemical property (e.g. phosphorylated proteins, glycosylated proteins, positively charged molecules, negatively charged molecules, hydrophobicity, hydrophilicity), but preferably biochemical properties that allow binding of the biomolecules to a biologically active surface of the invention as described herein. Such biomolecules include, but are not limited to nucleic acids, nucleotides, oligonucleotides, polynucleotides (DNA or RNA), amino acids, peptides, polypeptides, proteins, monoclonal and/or polyclonal antibodies, antigens, sugars, carbohydrates, fatty acids, lipids, steroids, hormones and combinations thereof (e.g., glycoproteins, ribonucleoproteins, lipoproteins). Preferably a biomolecule may be a nucleic acid, nucleotide, oligonucleotide, polynucleotide (DNA or RNA), amino acid, peptide, polypeptide, protein or fragments thereof. Even more preferred are amino acids, peptides, polypeptides or protein biomolecules or fragments thereof.

Binding molecules of the invention include, but are not limited to nucleic acids, nucleotides, oligonucleotides, polynucleotides (DNA or RNA), amino acids, peptides, polypeptides, proteins, monoclonal and/or polyclonal antibodies, antigens, sugars, carbohydrates, fatty acids, lipids, steroids, hormones, and combinations thereof (e.g., glycoproteins, ribonucleoproteins, lipoproteins), compounds or synthetic molecules. Preferably, binding molecules are specific for any one of the biomolecules selected from the group of biomarker A, B, C, D, E, F, G, H, I, J, K, L, M, N, or a combination thereof.

### Screening for Therapeutics

Differential expression of the biomolecules of the invention may be the result of an aberrant expression of the biomolecules at either the genomic (i.e. transcription: mRNA) or proteomic levels (i.e. translation, post-translational modifications etc.) within a given subject. Whereas aberrant over-expression of a biomolecule may be regulated using agents that inhibit its biological activity and/or biological expression, aberrant under-expression of a given biomolecule may be regulated using agents that can promote its biological activity or biological expression. Such agents can be used to treat a subject known to have prostate cancer and are, therefore, referred to as therapeutic agents.

An embodiment of the present invention provides methods for screening for therapeutic agents for treating prostate cancer resulting from the aberrant expression of a biomolecule, which can be biomarker A, B, C, D, E, F, G, H, I, J, K, L, M, N, or a combination thereof. The methods identify candidates, test molecules or compounds, or agents (e.g. peptides, peptidomimetics, small molecules or other drugs) which may decrease or increase expression of a biomolecule, which can be biomarker A, B, C, D, E, F, G, H, I, J, K, L, M, N, or a combination thereof.

In an aspect of the invention, a method of identifying a molecular entity that inhibits or promotes activity of any biomarker according to the invention, comprises the steps of: (a) selecting a control animal having the biomarker and a test animal having the biomarker; (b) treating the test animal using the molecular entity or a library of molecular entities, under conditions to allow specific binding and/or interaction and, (c) determining the relative quantity of the biomarker, as between the control animal and the test animal.

In an embodiment of the invention, the animals are mammals. The mammals may be rats or mice.

In a further aspect of the invention, a method of identifying a molecular entity that inhibits or promotes activity of any biomarker according to the invention, comprises the steps of: (a) selecting a host cell expressing the biomarker; (b) cloning the host cell and separating the clones into a test group and a control group; (c) treating the test group using the molecular entity or a library of molecular entities under conditions to allow specific binding and/or interaction and (d) determining the relative quantity of the biomarker, as between the test group and the control group.

In a further aspect of the invention, a method for identifying a molecular entity that inhibits or promotes the activity of any biomarker according to the invention, comprises the steps of: (a) selecting a test group having a host cell expressing the biomarker and a control group; (b) treating the test group using the molecular entity or a library of molecular entities; (c) determining the relative quantity of the biomarker, as between the test group and the control group.

In an embodiment of the invention, a host cell is a neoplastic or cancer cell.

Agents capable of interacting directly or indirectly with a biomolecule, which can be biomarker A, B, C, D, E, F, G, H, I, J, K, L, M, N, or a combination thereof, can be identified by various methods. For example, such agents can be identified using methods based on various binding assays (see references on: yeast-2-hybrid Bemis et al. (1995) Methods Cell Biol. 46, 139-151, Fields and Sternglanz (1994) Trends Genet. 10, 286-292, Topcu and Borden (2000) Pharm. Res. 17, 1049-1055; yeast 3 hybrid: Zhang et al. (1999) Methods Enzymol. 306, 93-113; GST pull-downs as in Palmer et al. (1998) EMBO J. 17, 5037-5047; and phage display as in Scott and Smith (1990) Science 249, 386-390).

An embodiment of the invention provides assays for screening for agents that bind to, interact with, or modulate a biologically active form of a biomolecule, which can be biomarker A, B, C, D, E, F, G, H, I, J, K, L, M, N, or a combination thereof. Agents according to the present invention can be obtained using any of the numerous approaches in combinatorial library methods known in the art, including: biological libraries, aptially addressable parallel solid phase or solution phase libraries, synthetic library methods requiring deconvolution, the “one-bead-one-compound” library method, and synthetic library methods using affinity chromatography selection. The biological library approach is limited to peptide libraries, while the other four approaches are applicable to peptide, non-peptide oligomer or small molecule libraries of compounds (Bindseil et al. (2001) Drug Discov. Today 6, 840-847; Grabley et al. (2000) Ernst Schering Res. Found. Workshop. pp. 217-252; Houghten et al. (2000) Drug Discov. Today 5, 276-285; Rader, C. (2001) Drug Discov. Today 6, 36-43).

Examples of methods for the synthesis of molecular libraries can be found in the art, for example in: DeWitt et al. (1993) Proc. Natl. Acad. Sci. USA 90, 6909-6913; Erb et al. (1994) Proc. Natl. Acad. Sci. USA 91, 11422-11426; Gallop et al. (1994) J. Med. Chem. 37, 1233-1251; Gordon et al. (1994) J. Med. Chem. 37, 1385-1401.

Libraries of agents may be presented in solution (e.g., Houghten (1992) Biotechniques 13, 412-421), or on beads (Lam et al. (1991) Nature 354, 82-84), chips (Fodor et al. (1993) Nature 364, 555-556), bacteria (U.S. Pat. No. 5,223,409, published June 1993), spores [U.S. Pat. Nos. 5,571,698 (published in November 1996); 5,403,484 (published in April 1995); and 5,223,409 (published in June 1993)], plasmids (Cull et al. (1992) Proc. Natl. Acad. Sci. USA 89, 1865-1869) or phages (Scott and Smith (1990) Science. 249, 386-390; Devlin et al. (1990) Science. 249, 404-406; Cwirla et al. (1990) Proc. Natl. Acad. Sci. USA 87, 6378-6382; Felici et al. (1991) J. Mol. Biol. 222, 301-310).

In one embodiment, an assay is a cell-based assay in which a cell expresses a biomolecule, which can be biomarker A, B, C, D, E, F, G, H, I, J, K, L, M, N, or a combination thereof. The expressed biomarker is contacted with an agent or a library of agents and the ability of the agent to bind to, or interact with, the polypeptide is determined. The cell can, for example, be a eucaryotic cell such as, but not limited to a yeast cell, an invertebrate cell (e.g. C. elegans), an insect cell, a teleost cell, an amphibian cell, or a cell of mammalian origin. Determining the ability of an agent to bind to, or interact with a biomolecule of the invention can be accomplished, for example, by coupling an agent with a radioisotope (e.g. ¹²⁵I, ³⁵S, ¹⁴C, or ³H) or enzymatic (e.g. horseradish peroxidase, alkaline phosphatase, or luciferase) label such that binding or interaction of the agent to a biomolecule of the invention can be determined by detecting the labelled agent in the complex. Methods of labelling and detecting interactions of agents with a biomolecule of the invention are known to those skilled in the art.

In a preferred embodiment, an assay comprises contacting a cell, which expresses a biomolecule, which can be biomarker A, B, C, D, E, F, G, H, I, J, K, L, M, N, or a combination thereof, with a known agent which binds, or interacts with a biomolecule, which can be biomarker A, B, C, D, E, F, G, H, I, J, K, L, M, N, or a combination thereof, to form an assay mixture, contacting the assay mixture with a test agent, and determining the ability of the test agent to bind to, or interact with a biomolecule of the invention, wherein determining the ability of the test agent to bind, or interact with, a biomolecule of the invention is compared to a control. The determination of the ability of the test agent to bind to, or interact with a biomolecule, which can be biomarker A, B, C, D, E, F, G, H, I, J, K, L, M, N, or a combination thereof, is based on competitive binding/inhibition kinetics of the test agent and known target agent for a given biomolecule of the invention. Methods of detecting competitive binding, or the interaction of two molecules for the same target, wherein the target is a biomolecule, which can be biomarker A, B, C, D, E, F, G, H, I, J, K, L, M, N, or a combination thereof, are known to those skilled in the art.

In another embodiment, an assay is a cell-based assay comprising contacting a cell expressing a biologically active biomolecule, which can be biomarker A, B, C, D, E, F, G, H, I, J, K, L, M, N, or a combination thereof, with a test agent and determining the ability of a test agent to inhibit a biological activity of a biomolecule, which can be biomarker A, B, C, D, E, F, G, H, I, J, K, L, M, N, or a combination thereof. This can be accomplished, for example, by determining whether a biomolecule continues to bind to or interact with a known target molecule, or whether a specific cellular function (e.g. ion-channeling) has been abrogated. For example, a target molecule can be a component of a signal transduction pathway that facilitates transduction of an extracellular signal, a second intercellular protein that has a catalytic activity, a protein that regulates transcription of specific genes, or a protein that initiates protein translation. Determining the ability of a biologically active biomolecule to bind to, or interact with, a target molecule can be accomplished by determining the activity of the target molecule. For example, the activity of the target molecule can be determined by detecting induction of a cellular second messenger of the target [e.g., intracellular Ca²⁺, diacylglycerol and inositol triphosphate IP3)], detecting catalytic/enzymatic activity of the target on an appropriate substrate, detecting the induction (via a regulatory element that may be responsive to a given polypeptide) of a reporter gene operably linked to a polynucleotide encoding a detectable marker, e.g., β-galactosidase, luciferase, green fluorescent protein (GFP), enhanced green fluorescent protein (EGFP), Ds-Red fluorescent protein, far-red fluorescent protein (Hc-red), secreted alkaline phosphatase (SEAP), chloramphenicol acetyltransferase (CAT), neomycin etc, or detecting a cellular response, for example, cellular differentiation, proliferation or migration.

In yet another embodiment, an assay of the present invention is a cell-free assay comprising contacting a biologically active biomolecule, which can be biomarker A, B, C, D, E, F, G, H, I, J, K, L, M, N, or a combination thereof, with a test agent, and determining the ability of the test agent to bind to, or interact with any a biomolecule. Binding or interaction of a test agent to a biomolecule can be determined either directly or indirectly as described above. In a preferred embodiment, the assay includes contacting any one of biomarker A, B, C, D, E, F, G, H, I, J, K, L, M, N, or a combination thereof, with a known agent, which binds, or interacts with said biomolecule to form an assay mixture. The assay mixture is contacted with a test agent, and the determination of the ability of the test agent to interact with the polypeptide is based on competitive binding/inhibition kinetics of the test agent and known agents for a given biomolecule. Methods of detecting competitive binding, or interaction, of two agents for the same biomolecule, wherein the biomolecule is selected from the group of biomarker A, B, C, D, E, F, G, H, I, J, K, L, M, N, or a combination thereof, are known to those skilled in the art.

In another embodiment, an assay is a cell-free assay comprising contacting a biologically active biomolecule, which can be biomarker A, B, C, D, E, F, G, H, I, J, K, L, M, N, or a combination thereof, with a test agent, and determining the ability of the test agent to inhibit the activity of a given biomolecule of the invention. Determining the ability of a test agent to inhibit the activity of a biomolecule can be accomplished, for example, by determining the ability of a biomolecule of the invention to bind to a target molecule by one of the methods described above for determining direct binding. In an alternative embodiment, determining the ability of the test agent to modulate the activity of a given biomolecule of the invention can be accomplished by determining the ability of a given Biomolecule of the invention to further modulate a target molecule.

In embodiments of the above assay methods of the present invention, it may be desirable to immobilize either biomarker A, B, C, D, E, F, G, H, I, J, K, L, M, N, or a combination thereof, or its respective target molecule to facilitate separation of complexed from uncomplexed forms of one or both of the proteins, as well as to accommodate automation of the assay. Binding of a test agent to a biomolecule, which can be biomarker A, B, C, D, E, F, G, H, I, J, K, L, M, N, or a combination thereof, or interaction of a biomolecule, which can be biomarker A, B, C, D, E, F, G, H, I, J, K, L, M, N, or a combination thereof, with a target molecule in the presence and absence of a candidate compound, can be accomplished in any vessel suitable for containing the reactants. Examples of such vessels include microtitre plates, test tubes, and micro-centrifuge tubes. In one embodiment, a fusion protein can be provided which adds a domain that allows one or both of the proteins to be bound to a matrix. For example, glutathione-S-transferase fusion proteins can be adsorbed onto glutathione sepharose beads (Sigma Chemical; St. Louis, Mo.) or glutathione derivatised microtitre plates, which are then combined with the test agent and either the non-adsorbed target protein or a biologically active biomolecule selected from the group of biomarker A, B, C, D, E, F, G, H, I, J, K, L, M, N, or a combination thereof. The mixture is then incubated under conditions conducive to complex formation (e.g., at physiological conditions for salt and pH). Following incubation, the beads or microtitre plate wells are washed to remove any unbound components and complex formation is measured either directly or indirectly, for example, as described above. Alternatively, the complexes can be dissociated from the matrix, and the level of binding or activity of said polypeptide can be determined using standard techniques.

Other techniques for immobilizing biomolecules on matrices can also be used in the screening assays of the invention. For example, a biologically active biomolecule, which can be biomarker A, B, C, D, E, F, G, H, I, J, K, L, M, N, or a combination thereof, or its target molecule can be immobilized utilizing conjugation of biotin and streptavidin.

In another embodiment, inhibitors or promoters of expression of a biomolecule, which can be biomarker A, B, C, D, E, F, G, H, I, J, K, L, M, N, or a combination thereof, are identified in a method in which cells are contacted with a candidate agent and/library of candidate agents and expression of the selected mRNA or protein [i.e., the mRNA or protein corresponding to a biomolecule or a biologically active biomolecule of the invention] in a cell is determined. In a preferred embodiment, the cell is an animal cell. Even more preferred, the cell can be derived from an insect, fish, amphibian, mouse, rat, or human. Expression levels of a selected mRNA or protein in the presence of a candidate agent is compared to the expression level of the selected mRNA or protein in the absence of a candidate agent. The candidate agent can then be identified as an inhibitor of expression of a given biomolecule, which can be biomarker A, B, C, D, E, F, G, H, I, J, K, L, M, N, or a combination thereof, based on this comparison. For example, when expression of the selected mRNA or protein is less (statistically significant) in the presence of a candidate agent than in its absence, the candidate agent is identified as an inhibitor of the selected mRNA or protein expression. The level of the selected mRNA or protein expression in the cells can be determined by methods described herein.

Test agents identified in the above-described assays are considered specific biomarkers.

In another embodiment, a therapeutic agent specific for a biomolecule, which can be biomarker A, B, C, D, E, F, G, H, I, J, K, L, M, N, or a combination thereof, can also be identified by using a reporter assay, in which the level of expression of a reporter construct, under the control of a gene promoter specific for a gene encoding a biomolecule, which can be biomarker A, B, C, D, E, F, G, H, I, J, K, L, M, N, or a combination thereof, is measured in the presence or absence of a test agent. A promoter specific for a gene encoding a biomolecule, which can be biomarker A, B, C, D, E, F, G, H, I, J, K, L, M, N, or a combination thereof, can be isolated by screening a genomic library with a cDNA encoding the complete coding sequence for a biomolecule, which can be biomarker A, B, C, D, E, F, G, H, I, J, K, L, M, N, or a combination thereof, preferably containing the 5′ end of the cDNA. A portion of said promoter, typically from 20 to about 500 base pairs long is then cloned upstream of a reporter gene, e.g., a β-galactosidase, luciferase, green fluorescent protein (GFP), enhanced green fluorescent protein (EGFP), Ds-Red fluorescent protein, far-red fluorescent protein (Hc-red), secreted alkaline phosphatase (SEAP), chloramphenicol acetyltransferase (CAT), neomycin gene, in a plasmid. This reporter construct is then transfected into cells, e.g., mammalian cells. The transfected cells are distributed into wells of a multi-well plate and various concentrations of test molecules or compounds are added to the wells. After several hours of incubation, the level of expression of the reporter construct is determined according to methods known in the art. A difference in the level of expression of the reporter construct in transfected cells incubated with the test molecule or compound relative to transfected cells incubated without the test molecule or compound will indicate that the test molecule or compound is capable of modulating the expression of a gene encoding a biomolecule selected from the group of biomarker A, B, C, D, E, F, G, H, I, J, K, L, M, N, or a combination thereof, and is thus a therapeutic agent for a biomolecule selected from the group of biomarker A, B, C, D, E, F, G, H, I, J, K, L, M, N, or a combination thereof.

In one embodiment of the invention, therapeutic agents for a biomolecule selected from the group of biomarker A, B, C, D, E, F, G, H, I, J, K, L, M, N, or a combination thereof, can be used for treating prostate cancer, and may be applied to any patient in need of such therapy. Preferably, the patient in need of such therapy is of human origin.

This invention further pertains to novel agents identified by the above-described screening assays and uses thereof for the treatment of a non-steroid dependent cancer as described herein.

### Biological Samples of the Invention

Although the biomolecules of the invention were first identified in urine samples, their detection is not limited to urine samples. In more than one embodiment of the invention, the biomolecules of the invention can be detected in blood, blood serum, blood plasma, urine, semen, seminal fluid, seminal plasma, prostatic fluid, pre-ejaculatory fluid (Cowper's fluid), excreta, tears, saliva, sweat, biopsy, ascites, cerebrospinal fluid, lymph, or tissue extract (biopsy) samples. Preferably, the biological samples used to detect the biomolecules of the invention are urine, semen, seminal fluid, seminal plasma, prostatic fluid, pre-ejaculatory fluid (Cowper's fluid).

Furthermore, biological samples used for methods of the invention are isolated from subjects of mammalian origin, preferably of primate origin. Even more preferred are subjects of human origin.

A subject of the invention that is said to have a prostate cancer possesses morphological, biochemical and functional alterations of their prostatic tissue such that the tissue can be characterised as a malignant neoplasm. The stage to which a prostate cancer has progressed can be determined using known methods currently available to those skilled in the art [e.g. Union Internationale Contre Cancer (UICC) system or American Joint Committee on Cancer (AJC)]. Currently, the most widely used method for determining the extent of malignancy of a prostatic neoplasm is the Gleason Grading system. Gleason grading is based exclusively on the architectural pattern of the glands of a prostatic neoplasm, wherein the ability of neoplastic cells to structure themselves into glands resembling those of the normal prostate is evaluated using a scale of 1 to 5. For example, neoplastic cells that are able to architecturally structure themselves such that they resemble normal prostate gland structure are graded 1-2, whereas neoplastic cells that are unable to do so are graded 4-5. As known to those skilled in the art, a prostatic neoplasm whose tumour structure is nearly normal will tend to behave, biologically, as normal tissue and therefore it is unlikely that it will be aggressively malignant. Gleason score may be integrated with other grading methods and/or staging systems to determine cancer stage.

A subject of the invention that is said to have a non-malignant disease of the prostate possesses morphological and/or biochemical alterations of their prostatic tissue but does not exhibit malignant neoplastic properties known to those skilled in the art. Such diseases include, but are not limited to, inflammatory and proliferative lesions, as well as benign disorders of the prostate. Within the context of the invention, whereas inflammatory lesions encompass acute and chronic bacterial prostatitis, as well as chronic abacterial prostatitis, proliferative lesions include benign prostate hyperplasia (BPH).

### Biologically Active Surfaces

Biologically active surfaces of the invention include, but are not limited to, surfaces that contain adsorbents with anion exchange properties (adsorbents that are positively charged), cation exchange properties (adsorbents that are negatively charged), hydrophobic properties, reverse phase chemistry, groups such as nitriloacetic acid that immobilize metal ions such as nickel, gallium, copper, or zinc (metal affinity interaction), or biomolecules such as proteins, antibodies, nucleic acids, or protein binding sequences, covalently bound to the surface via carbonyl diimidazole moieties or epoxy groups (specific affinity interaction).

These surfaces may be located on matrices like polysaccharides such as sepharose, e.g. anion exchange surfaces or hydrophobic interaction surfaces, or solid metals, e.g. antibodies coupled to magnetic beads or a metal surface. Surfaces may also include gold-plated surfaces such as those used for Biacore Sensor Chip technology. Other surfaces known to those skilled in the art are also included within the scope of the invention.

Biologically active surfaces are able to adsorb biomolecules like nucleotides, nucleic acids, oligonucleotides, polynucleotides, amino acids, polypeptides, proteins, monoclonal and/or polyclonal antibodies, steroids, sugars, carbohydrates fatty acids, lipids, hormones, and combinations thereof (e.g., glycoproteins, ribonucleoproteins, lipoproteins).

In another embodiment, devices that use biologically active surfaces to selectively adsorb biomolecules may be chromatography columns for Fast Protein Liquid Chromatography (FPLC) and High Pressure Liquid Chromatography (HPLC), where the matrix, e.g. a polysaccharide, carrying the biologically active surface, is filled into vessels (usually referred to as “columns”) made of glass, steel, or synthetic materials like polyetheretherketone (PEEK).

In yet another embodiment, devices that use biologically active surfaces to selectively adsorb biomolecules may be metal strips carrying thin layers of a biologically active surface on one or more spots of the strip surface to be used as probes for gas phase ion spectrometry analysis, for example the PS20 ProteinChip array for (Ciphergen Biosystems, Inc.) for SELDI analysis.

### Generation of Mass Profiles

In one embodiment, the mass profile of a biological sample may be generated using an array-based assay in which the biomolecules of a given sample are bound by biochemical or affinity interactions to an adsorbent present on a biologically active surface located on a solid platform (“chip”). After the biomolecules have bound to the adsorbent, they are co-crystallized with an energy absorbing molecule and subsequently detected using gas phase ion spectrometry. This includes, e.g., mass spectrometers, ion mobility spectrometers, or total ion current measuring devices. The quantity and characteristics of the biomolecule can be determined using gas phase ion spectrometry. Other substances in addition to the biomolecule of interest can also be detected by gas phase ion spectrometry.

In one embodiment, a mass spectrometer can be used to detect a biomolecule on a chip. In a typical mass spectrometer, a chip with a bound biomolecule co-crystallized with an energy absorbing molecule is introduced into an inlet system of the mass spectrometer. The energy absorbing molecule:biomolecule crystals are then ionized by an ionisation source, such as a laser. The ions generated are then collected by an ion optic assembly, and then a mass analyser disperses and analyses the passing ions. The ions exiting the mass analyser are then detected by an ion detector. The ion detector then translates the information into mass-to-charge ratios. Detection of the presence of a biomolecule or other substances will typically involve detection of signal intensity. This, in turn, can reflect the quantity and character of a biomolecule bound to the probe.

In another embodiment, the mass profile of a sample may be generated using a liquid-chromatography (LC)-based assay in which a biomolecule of a given sample are bound by biochemical or affinity interactions to an adsorbent located in a vessel made of glass, steel, or synthetic material; known to those skilled in the art as a chromatographic column. Biomolecules are eluted from the biologically active adsorbent surface by washing the vessel with appropriate solutions known to those skilled in the art. Such solutions include but are not limited to, buffers, e.g. Tris (hydroxymethyl) aminomethane hydrochloride (TRIS-HCl), buffers containing salt, e.g. sodium chloride (NaCl), or organic solvents, e.g. acetonitrile. Mass profiles of these biomolecules are generated by application of the eluting biomolecules of the sample by direct connection via an electrospray device to a mass spectrometer (LC/ESI-MS).

Conditions that promote binding of a biomolecule to an adsorbent are known to those skilled in the art and ordinarily include parameters such as pH, the concentration of salt, organic solvent, or other competitors for binding of the biomolecule to the adsorbent.

### Detection of Biomolecules of the Invention

In one embodiment, mass spectrometry can be used to detect biomolecules, which can be biomarker A, B, C, D, E, F, G, H, I, J, K, L, M, N, or a combination thereof, of a given sample. Such methods include, but are not limited to, matrix-assisted laser desorption flight/time-of-flight (MALDI-TOF), surface-enhanced laser desorption flight/time-of-flight (SELDI-TOF), liquid chromatography coupled with MS, MS-MS, or ESI-MS. Typically, the biomolecules are analysed by introducing a biologically active surface containing said biomolecules, ionising said biomolecules to generate ions that are collected and analysed.

In a preferred embodiment, biomolecules selected from the group consisting of biomarker A, B, C, D, E, F, G, H, I, J, K, L, M, N, and a combination thereof, are detected in samples using gas phase ion spectrometry, and more preferably, using mass spectrometry. In one embodiment, matrix-assisted laser desorption/ionisation (“MALDI”) mass spectrometry can be used. In MALDI, the sample is partially purified to obtain a fraction that essentially consists of a biomolecule by employing such separation methods as: two-dimensional gel electrophoresis (2D-gel) or high performance liquid chromatography (HPLC).

In another embodiment, surface-enhanced laser desorption/ionisation mass spectrometry (SELDI) can be used to detect a biomolecule, which can be biomarker A, B, C, D, E, F, G, H, I, J, K, L, M, N, or a combination thereof, uses a substrate comprising adsorbents to capture biomolecules, which can then be directly desorbed and ionised from the substrate surface during mass spectrometry. Since the substrate surface in SELDI captures biomolecules, a sample need not be partially purified as in MALDI. However, depending on the complexity of a sample and the type of adsorbents used, it may be desirable to prepare a sample to reduce its complexity prior to SELDI analysis.

In a preferred embodiment, a laser desorption time-of-flight mass spectrometer is used with the probe of the present invention. In laser desorption mass spectrometry, biomolecules bound to a biologically active surface are introduced into an inlet system. Biomolecules are desorbed and ionised into the gas phase by a laser. The ions generated are then collected by an ion optic assembly. These ions are accelerated through a short high-voltage field and allowed to drift into a high vacuum chamber of a time-of-flight mass analyser. At the far end of the high vacuum chamber, the accelerated ions collide with a detector surface at varying times. Since the time-of-flight is a function of the mass of the ions, the elapsed time between ionisation and impact can be used to identify the presence or absence of molecules of a specific mass.

Data analysis can include the steps of determining signal strength (e.g., intensity of peaks) of a biomolecule(s) detected and removing “outliers” (data deviating from a predetermined statistical distribution). An example of this is the normalization of peaks, a process whereby the intensity of each peak relative to some reference is calculated. For example, a reference can be background noise generated by the instrument and/or chemicals (e.g., energy absorbing molecule), which is set as zero in the scale. Then the signal strength detected for each biomolecule can be displayed in the form of relative intensities in the scale desired (e.g., 100). Alternatively, the observed signal for a given peak can be expressed as the ratio of the intensity of that peak over the sum of the entire observed signal for both peaks and background noise in a specified mass to charge ratio range. Alternatively, a standard may be admitted with the sample so that a peak from the standard can be used as a reference to calculate relative intensities of the signals observed for each biomolecule(s) detected.

The resulting data can be transformed into various formats for displaying, typically through the use of computer algorithms. In one format, referred to as a “spectrum view”, a standard spectral view can be displayed, wherein the view depicts the quantity of a biomolecule reaching the detector at each possible mass to charge ratio. In another format, referred to as “scatter plot”, only the intensity and mass to charge information for defined peaks are retained from the spectrum view, yielding a cleaner image and enabling biomolecules with nearly identical molecular mass to be more easily distinguished from one another.

Using any of the above display formats, it can be readily determined from the signal display whether a biomolecule having a particular TOF is detected from a sample. Preferred biomolecules of the invention are biomolecules selected from the group of biomarker A, B, C, D, E, F, G, H, I, J, K, L, M, N, and a combination thereof.

In another aspect of the invention, biomolecules, which can be biomarker A, B, C, D, E, F, G, H, I, J, K, L, M, N, or a combination thereof, can be detected using other methods known to those skilled in the art. For examples an in vitro binding assay can be used to detect a biomolecule of the invention within a biological sample of a given subject. A given biomolecule of the invention can be detected within a biological sample by contacting the biological sample from a given subject with specific binding molecule(s) under conditions conducive for an interaction between the given binding molecule(s) and a biomolecule. Binding molecules include, but are not limited to, nucleic acids, nucleotides, oligonucleotides, polynucleotides, amino acids, peptides, polypeptides, proteins, monoclonal and/or polyclonal antibodies, antigens, sugars, carbohydrates, fatty acids, lipids, steroids, or combinations thereof. (e.g. glycoproteins, ribonucleoproteins, lipoproteins), compounds or synthetic molecules. Preferably, binding molecules are antibodies specific for any one of the biomolecules selected from the group of biomarker A, B, C, D, E, F, G, H, I, J, K, L, M, N, and a combination thereof. The biomolecules detected using the above-mentioned binding molecules include, but are not limited to, molecules comprising nucleic acids, nucleotides, oligonucleotides, polynucleotides, amino acids, peptides, polypeptides, proteins, monoclonal and/or polyclonal antibodies, antigens, sugars, carbohydrates, fatty acids, lipids, steroids, and combinations thereof (e.g., glycoproteins, ribonucleoproteins, lipoproteins). Preferably, biomolecules that are detected using the above-mentioned binding molecules include nucleic acids, nucleotides, oligonucleotides, polynucleotides, amino acids, peptides, polypeptides, proteins, monoclonal and/or polyclonal antibodies. Even more preferred are binding molecules that are amino acids, peptides, polypeptides, proteins, monoclonal and/or polyclonal antibodies.

### Antibodies of the Invention

With respect to protein-based testing, antibodies can be generated to biomarkers using standard immunological techniques, fusion proteins or synthetic peptides as described herein. Monoclonal antibodies can also be produced using now conventional techniques such as those described in Waldmann T. A., 1991, Science, 252: 1657-1662 and Harlow E. and Lane D. (eds.), 1988, Antibodies: A Laboratory Manual, Cold Harbour Press, Cold Harbour, NY. It will also be appreciated that antibody fragments, i.e. Fab′ fragments, can be similarly employed. Immunoassays, for example ELISAs, in which the test sample is contacted with antibody and binding to the biomarker detected, can provide a quick and efficient method of determining the presence and quantity of the biomarker. For example, the antibodies can be used to test the effect of pharmaceuticals in subjects enrolled in clinical trials.

Thus, the present invention also provides polyclonal and/or monoclonal antibodies and fragments thereof, and immunologic binding equivalents thereof, which are capable of specifically binding to the biomarkers and fragments thereof. The term “antibody” is used both to refer to a homogeneous molecular entity, or a mixture such as a serum product made up of a plurality of different molecular entities. Polypeptides may be prepared synthetically in a peptide synthesizer and coupled to a carrier molecule (e.g., keyhole limpet hemocyanin) and injected over several months into a host mammal. The host's sera can be tested for immunoreactivity to the subject polypeptide or fragment. Monoclonal antibodies may be made by injecting mice with the protein polypeptides, fusion proteins or fragments thereof. Monoclonal antibodies are screened by ELISA and tested for specific immunoreactivity with subject biomarkers or fragments thereof (Harlow E. and Lane D. (eds.), 1988, Antibodies: A Laboratory Manual, Cold Harbour Press, Cold Harbour, NY). These antibodies are useful in assays as well as pharmaceuticals.

Once a sufficient quantity of desired polypeptide has been obtained, it may be used for various purposes. A typical use is the production of antibodies specific for binding. These antibodies may be either polyclonal or monoclonal, and may be produced by in vitro or in vivo techniques well known in the art. For production of polyclonal antibodies, an appropriate target immune system, typically mouse or rabbit, is selected. Substantially purified antigen is presented to the immune system in a fashion determined by methods appropriate for the animal and by other parameters well known to immunologists. Typical routes for injection are in footpads, intramuscularly, intraperitoneally, or intradermally. Of course, other species may be substituted for mouse or rabbit. Polyclonal antibodies are then purified using techniques known in the art, adjusted for the desired specificity.

An immunological response is usually assayed with an immunoassay. Normally, such immunoassays involve some purification of a source of antigen, for example, that produced by the same cells and in the same fashion as the antigen. A variety of immunoassay methods are well known in the art, such as in Harlow E. and Lane D. (eds.), 1988, Antibodies: A Laboratory Manual, Cold Harbour Press, Cold Harbour, NY, or Goding J. W., 1996, Monoclonal Antibodies: Principles and Practice: Production and Application of Monoclonal Antibodies in Cell Biology, Biochemistry and Immunology, 3^{rd} edition, Academic Press, NY.

Monoclonal antibodies with affinities of 10⁸ M⁻¹ or preferably 10⁹ to 10¹⁰ M⁻¹ or stronger will typically be made by standard procedures as described in Harlow E. and Lane D. (eds.), 1988, Antibodies: A Laboratory Manual, Cold Harbour Press, Cold Harbour, NY or Goding J. W., 1996, Monoclonal Antibodies: Principles and Practice: Production and Application of Monoclonal Antibodies in Cell Biology, Biochemistry and Immunology, 3^{rd} edition, Academic Press, NY. Briefly, appropriate animals will be selected and the desired immunization protocol followed. After the appropriate period of time, the spleens of such animals are excised and individual spleen cells fused, typically, to immortalized myeloma cells under appropriate selection conditions. Thereafter, the cells are clonally separated and the supernatants of each clone tested for their production of an appropriate antibody specific for the desired region of the antigen.

Other suitable techniques involve in vitro exposure of lymphocytes to the antigenic biomarkers, or alternatively, to selection of libraries of antibodies in phage or similar vectors (Huse et al., 1989, Science, 246: 1275-1281). The polypeptides and antibodies of the present invention may be used with or without modification. Frequently, polypeptides and antibodies will be labelled by joining, either covalently or non-covalently, a substance, which provides for a detectable signal. A wide variety of labels and conjugation techniques are known and are reported extensively in both the scientific and patent literature. Suitable labels include radionuclides, enzymes, substrates, cofactors, inhibitors, fluorescent agents, chemiluminescent agents, magnetic particles and the like. Patents teaching the use of such labels include U.S. Pat. Nos. 3,817,837; 3,850,752; 3,939,350; 3,996,345; 4,277,437; 4,275,149 and 4,366,241. Also, recombinant immunoglobulins may be produced (see U.S. Pat. No. 4,816,567).

### Generation of Monoclonal Antibodies Specific for the Biomarker

Monoclonal antibodies can be generated according to various methods known to those skilled in the art. For example, any technique that provides for the production of antibody molecules by continuous cell lines in culture may be used. These include but are not limited to the hybridoma technique originally developed by Kohler and Milstein [Nature, 256:495-497 (1975)], as well as the trioma technique, the human B-cell hybridoma technique [Kozbor et al., Immunology Today, 4:72 (1983)]; [Cote et al., Proc. Natl. Acad. Sci. U.S.A., 80:2026-2030 (1983)], and the EBV-hybridoma technique to produce human monoclonal antibodies [Cole et al., in Monoclonal Antibodies and Cancer Therapy, Alan R. Liss, Inc., pp. 77-96 (1985)]. In fact, according to the invention, techniques developed for the production of “chimeric antibodies” [Morrison et al., J. Bacteriol., 159:870 (1984). Neuberger et al., Nature, 312:604-608 (1984). Takeda et al., Nature, 314:452-454 (1985)] by splicing the genes from a mouse antibody molecule specific for a given biomarker of the invention together with genes from a human antibody molecule of appropriate biological activity can be used. Such human or humanized chimeric antibodies are preferred for use in therapy of human diseases or disorders (described infra), since the human or humanized antibodies are much less likely than xenogeneic antibodies to induce an immune response, in particular an allergic response, themselves.

The following example of monoclonal antibody production is meant for clarity and is not intended to limit the scope of the invention. One method to producing antibodies of the invention is by inoculating a host mammal with an immunogen comprising the intact subject biomarker or its peptides (wild or mutant). The host mammal may be any mammal and is preferably a host mammal such as a mouse, rat, rabbit, guinea pig or hamster and is most preferably a mouse. By inoculating the host mammal it is possible to elicit the generation of antibodies directed towards the immunogen introduced into the host mammal. Several inoculations may be required to elicit an immune response.

To determine if the host mammal has developed antibodies directed towards the immunogen, serum samples are taken from the host mammal and screened for the desired antibodies. This can be accomplished by techniques known in the art such as radioimmunoassay, ELISA (enzyme-linked immunosorbent assay), “sandwich” immunoassays, immunoradiometric assays, gel diffusion precipitin reactions, immunodiffusion assays, in situ immunoassays (using colloidal gold, enzyme or radioisotope labels, for example), western blots, precipitation reactions, agglutination assays (e.g., gel agglutination assays, hemagglutination assays), complement fixation assays, immunofluorescence assays, protein A assays, and immunoelectrophoresis assays, etc. In one embodiment, antibody binding is detected by detecting a label on the primary antibody. In another embodiment, the primary antibody is detected by detecting binding of a secondary antibody or reagent to the primary antibody. In a further embodiment, the secondary antibody is labelled.

Once antibody generation is established in the host mammal, it is selected for hybridoma production. The spleen is removed and a single cell suspension is prepared as described by Harlow E. and Lane D. (eds.), 1988, Antibodies: A Laboratory Manual, Cold Harbour Press, Cold Harbour, NY. Cell fusions are performed essentially as described by Kohler G. and Milstein C., 1975, Nature, 256: 495-497. Briefly, P3.65.3 myeloma cells (American Type Culture Collection, Rockville, Md.) are fused with immune spleen cells using polyethylene glycol as described by Harlow E. and Lane D. (eds.), 1988, Antibodies: A Laboratory Manual, Cold Harbour Press, Cold Harbour, NY. Cells are plated at a density of 2×10⁵ cells/well in 96 well tissue culture plates. Individual wells are examined for growth and the supernatants of wells with growth are tested for the presence of subject biomarker specific antibodies by ELISA or RIA using wild type or mutant target protein. Cells in positive wells are expanded and subcloned to establish and confirm monoclonality. Clones with the desired specificities are expanded and grown as ascites in mice or in a hollow fibre system to produce sufficient quantities of antibody for characterization and assay development.

### Sandwich Assay for the Biomarker

Sandwich assays for the detection of a biomolecule, which can be biomarker A, B, C, D, E, F, G, H, I, J, K, L, M, N, or a combination thereof, can be used as a diagnostic tool for diagnosis of a subject as being healthy, having a non-malignant disease of the prostate, having a precancerous prostatic lesion, having a localized cancer of the prostate, or a metastasised cancer of the prostate, or having an acute or a chronic inflammation of prostatic tissue. In the context of the invention, sandwich assays consist of attaching a monoclonal antibody to a solid surface such as a plate, tube, bead, or particle, wherein the antibody is preferably attached to the well surface of a 96-well microtitre plate. A pre-determined volume of sample (e.g., serum, urine, tissue cytosol) containing the subject biomarker is added to the solid phase antibody, and the sample is incubated for a period of time at a pre-determined temperature conducive for the specific binding of the subject markers within the given sample to the solid phase antibody. Following, the sample fluid is discarded and the solid phase is washed with buffer to remove any unbound material. One hundred μl of a second monoclonal antibody (to a different determinant on the subject biomarker) is added to the solid phase. This antibody is labelled with a detector molecule or atom (e.g., enzyme, fluorophore, chromophore, or ¹²⁵I) and the solid phase with the second antibody is incubated for two hrs at room temperature. The second antibody is decanted and the solid phase is washed with buffer to remove unbound material.

The amount of bound label, which is proportional to the amount of subject biomarker present in the sample, is quantitated.

### Kits of the Invention

A further aspect of the invention comprises a kit for diagnosis of a prostate disease within a subject comprising: a biologically active surface comprising an adsorbent, binding solutions, and instructions to use the kit, wherein the instructions outline the a method for diagnosis of a prostate cancer in a subject according to the invention or a method for the differential diagnosis of healthy, non-malignant disease of the prostate, precancerous prostatic lesion, localized cancer of the prostate, metastasised cancer of the prostate, and acute or chronic inflammation of prostatic tissue in a subject according to the invention.

Any of the biologically active surfaces described herein may be used to practice the invention. In an embodiment of the invention, the biologically active surface may comprise an adsorbent comprising of silicon dioxide molecules. In another embodiment of the invention, a biologically active surface may comprise an adsorbent comprising antibodies specific to a biomarker, preferably two or more biomarkers, which can be biomarker A, B, C, D, E, F, G, H, I, J, K, L, M, N, or a combination thereof.

A further aspect of the invention comprises a kit for diagnosis of prostate disease within a subject comprising a binding solution, a binding molecule, a detection substrate, and instructions, wherein the instructions outline a method according to the invention for in vitro diagnosis of a prostate cancer in a subject, a method according to the invention for in vitro differential diagnosis of prostate cancer and non-malignant disease of the prostate in a subject, or a method according to the invention for in vitro differential diagnosis of healthy, prostate cancer, non-malignant disease of the prostate, precancerous prostatic lesion, localized cancer of the prostate, metastasised cancer of the prostate, and acute or chronic inflammation of prostatic tissue in a subject.

Yet another aspect of the invention comprises kits using methods of the invention as described in another section for differential diagnosis of prostate cancer or a non-malignant disease of the prostate, wherein the kits are used to detect biomolecules, which can be biomarker A, B, C, D, E, F, G, H, I, J, K, L, M, N, or a combination thereof.

Methods used to detect biomolecules, which can be biomarker A, B, C, D, E, F, G, H, I, J, K, L, M, N, or a combination thereof, can also be used to determine whether a subject is at risk of developing prostate cancer or has developed prostate cancer. Such methods may also be employed in the form of a diagnostic kit comprising a binding molecule specific to a biomolecule, which can be biomarker A, B, C, D, E, F, G, H, I, J, K, L, M, N, or a combination thereof, solutions and materials necessary for the detection of a biomolecule of the invention, and instructions to use the kit based on the above-mentioned methods.

For example, a kit can be used to detect one or more, biomolecules, which can be biomarker A, B, C, D, E, F, G, H, I, J, K, L, M, N, or a combination thereof. Kits of the invention have many applications. For example, kits can be used to differentiate if a subject is healthy, having a non-malignant disease of the prostate, or a prostate cancer, thus aiding diagnosis of a prostate cancer and/or a non-malignant disease of the prostate. Moreover, kits can be used to differentiate if a subject healthy, having a non-malignant disease of the prostate, having a precancerous prostatic lesion, having a localized cancer of the prostate, having a metastasised cancer of the prostate, or having an acute or a chronic inflammation of the prostate.

In an embodiment of any of the kits described above, the kit may comprise instructions on how to use the kit, a biologically active surface comprising an adsorbent, wherein the adsorbent is suitable for binding one or more biomolecules of the invention, a denaturation solution for the pre-treatment of a sample, a binding solution, and one or more washing solution(s) or instructions for making a denaturation solution, binding solution, or washing solution(s), wherein the combination allows for the detection of a biomolecule using gas phase ion spectrometry. Such kits can be prepared from the materials described in other previously detailed sections (e.g., denaturation buffer, binding buffer, adsorbents, washing solution(s), etc.).

In another embodiment of the kits according to the invention, the kit may comprise a first substrate comprising an adsorbent thereon (e.g., a particle functionalised with an adsorbent) and a second substrate onto which the first substrate can be positioned to form a probe, which is removably insertable into a gas phase ion spectrometer. In other embodiments, the kit may comprise a single substrate, which is in the form of a removably insertable probe with adsorbents on the substrate.

In another embodiment of kits according to the invention, a kit may comprise a binding molecule or panel of binding molecules that specifically binds to a biomolecule, which can be biomarker A, B, C, D, E, F, G, H, I, J, K, L, M, N, or a combination thereof, a detection reagent, appropriate solutions and instructions on how to use the kit. Such kits can be prepared from the materials described above, and other materials known to those skilled in the art. A binding molecule used within such a kit may include, but is not limited to, nucleic acids, nucleotides, oligonucleotides, polynucleotides, amino acids, peptides, polypeptides, proteins, monoclonal and/or polyclonal antibodies, sugars, carbohydrates, fatty acids, lipids, steroids, hormones, or a combination thereof (e.g. glycoproteins, ribonucleoproteins, lipoproteins), compounds or synthetic molecules. Preferably, a binding molecule used in said kit is a nucleic acid, nucleotide, oligonucleotide, polynucleotide, amino acid, peptide, polypeptide, and protein, monoclonal and/or polyclonal antibody. In another embodiment, a kit comprises a binding molecule or panel of binding molecules that specifically bind to more than one of the biomolecules selected from the group of biomarker A, B, C, D, E, F, G, H, I, J, K, L, M, N, and a combination thereof, a detection reagent, appropriate solutions and instructions on how to use the kit. Each binding molecule would be distinguishable from every other binding molecule in a panel of binding molecules, yielding easily interpreted signal for each of the biomolecules detected by the kit. Such kits can be prepared from the materials described above, and other materials known to those skilled in the art. A binding molecule used within such a kit may include, but is not limited to, nucleic acids, nucleotides, oligonucleotides, polynucleotides, amino acids, peptides, polypeptides, proteins, monoclonal and/or polyclonal antibodies, sugars, carbohydrates, fatty acids, lipids, steroids, hormones, or a combination thereof (e.g. glycoproteins, ribonucleoproteins, lipoproteins), compounds or synthetic molecules. Preferably, a binding molecule used in said kit is a nucleic acid, nucleotide, oligonucleotide, polynucleotide, amino acid, peptide, polypeptide, and protein, monoclonal and/or polyclonal antibody.

In any of the embodiments described above, the kit may optionally further comprise a standard or control biomolecule so that the biomolecules detected within the biological sample can be compared with said standard to determine if the test amount of a marker detected in a sample is a diagnostic amount consistent with a diagnosis of a non-malignant disease of the prostate, a precancerous prostatic lesion, localized cancer of the prostate, metastasised cancer of the prostate, acute or a chronic inflammation of the prostate. Likewise a biological sample can be compared with said standard to determine if the test amount of a marker detected is said sample is a diagnostic amount consistent with a diagnosis as healthy.

### Composition, Formulation, and Administration of Pharmaceutical Compositions

Differential expression of biomolecules in samples from healthy subjects, subjects having a non-malignant disease of the prostate, and subjects having prostate cancer allows for differential diagnosis of prostate cancer or a non-malignant disease of the prostate within a given subject. Accordingly, biomolecules discovered and characterized herein can be isolated and further characterized using standard laboratory techniques, and used to determine novel treatments for prostate cancer and non-malignant disease of the prostate. Knowledge of the association of these biomolecules with prostatic cancer and benign prostate disease can be used, for example, to treat patients with the biomolecule, an antibody specific to the biomolecule, or an antagonist of the biomolecule. In order to treat prostate cancer, the biomolecules or molecular entities which modulate the activity of biomolecules, can be prepared in specific pharmaceutical compositions and/or formulations that allow for the most efficient and effective delivery of the therapy to a patient in need thereof.

A further aspect of the invention includes a composition for treating a prostate disease, comprising a molecular entity, which modulates a biomarker and a pharmaceutically acceptable carrier. The biomarker may be selected from the group consisting of biomarker A, B, C, D, E, F, G, H, I, J, K, L, M, N, and a combination thereof.

In an embodiment of the invention, the molecular entity may be identified by any one of the methods of invention for identifying a molecular entity, which inhibits or promotes the activity of any biomarker according to the invention and a pharmaceutically acceptable carrier. Such methods are described in greater detail above. The molecular entity may be selected from the group consisting of nucleotides, oligonucleotides, polynucleotides, amino acids, peptides, polypeptides, proteins, antibodies, immunoglobulins, small organic molecules, pharmaceutical agents, agonists, antagonists, derivatives and combinations thereof.

A further aspect of the invention comprises a use of any composition according to the invention for treating prostate disease. Prostate disease may be prostate cancer and non-malignant disease of the prostate. Prostate disease may be is selected from the group consisting of non-malignant disease of the prostate, precancerous prostatic lesion, localized cancer of the prostate, metastasised cancer of the prostate, and acute or chronic inflammation of prostatic tissue.

The pharmaceutical compositions of the present invention may be manufactured in a manner that is itself known, e.g., by means of conventional mixing, dissolving, granulating, dragee-making, levigating, emulsifying, encapsulating, entrapping or lyophilizing processes.

Pharmaceutical compositions for use in accordance with the present invention thus may be formulated in conventional manner using one or more physiologically acceptable carriers comprising excipients and auxiliaries, which facilitate processing of the active compounds into preparations, which can be used pharmaceutically. Proper formulation is dependent upon the route of administration chosen.

For injection, the agents of the invention may be formulated in aqueous solutions, preferably in physiologically compatible buffers such as Hanks' solution, Ringer's solution, or physiological saline buffer. For transmucosal administration, penetrants appropriate to the barrier to be permeated are used in the formulation. Such penetrants are generally known in the art.

For oral administration, the compounds can be formulated readily by combining the active compounds with pharmaceutically acceptable carriers well known in the art. Such carriers enable the compounds of the invention to be formulated as tablets, pills, dragees, capsules, liquids, gels, syrups, slurries, suspensions and the like, for oral ingestion by a patient to be treated. Pharmaceutical preparations for oral use can be obtained by solid excipient, optionally grinding a resulting mixture, and processing the mixture of granules, after adding suitable auxiliaries, if desired, to obtain tablets or dragee cores. Suitable excipients are, in particular, fillers such as sugars, including lactose, sucrose, mannitol, or sorbitol, or cellulose preparations such as, maize starch, wheat starch, rice starch, potato starch, gelatin, gum tragacanth, methyl cellulose, hydroxypropylmethyl-cellulose, sodium carboxymethylcellulose, and/or polyvinylpyrrolidone. If desired, disintegrating agents may be added, such as the cross-linked polyvinylpyrrolidone, agar, or alginic acid or a salt thereof such as sodium alginate.

Dragee cores are provided with suitable coatings. For this purpose, concentrated sugar solutions may be used, which may optionally contain gum arabic, talc, polyvinyl pyrrolidone, carbopol gel, polyethylene glycol, and/or titanium dioxide, lacquer solutions, and suitable organic solvents or solvent mixtures. Dyestuffs or pigments may be added to the tablets or dragee coatings for identification or to characterize different combinations of active compound doses.

Pharmaceutical preparations, which can be used orally include push-fit capsules made of gelatin, as well as soft, sealed capsules made of gelatin and a plasticizer, such as glycerol or sorbitol. The push-fit capsules can contain the active ingredients in admixture with filler such as lactose, binders such as starches, and/or lubricants such as talc or magnesium stearate and, optionally, stabilizers. In soft capsules, the active compounds may be dissolved or suspended in suitable liquids, such as fatty oils, liquid paraffin, or liquid polyethylene glycols. In addition, stabilizers may be added. All formulations for oral administration should be in dosages suitable for such administration.

For buccal administration, the compositions may take the form of tablets or lozenges formulated in conventional manner.

For administration by inhalation, the compounds for use according to the present invention are conveniently delivered in the form of an aerosol spray presentation from pressurized packs or a nebulizer, with the use of a suitable propellant, e.g., dichlorodifluoromethane, trichlorofluoromethane, dichlorotetrafluoroethane, carbon dioxide or other suitable gas. In the case of a pressurized aerosol the dosage unit may be determined by providing a valve to deliver a metered amount. Capsules and cartridges (e.g. gelatin) for use in an inhaler or insufflator may be formulated containing a powder mix of the compound and a suitable powder base such as lactose or starch.

The compounds may be formulated for parenteral administration by injection, e.g., by bolus injection or continuous infusion. Formulations for injection may be presented in unit dosage form, e.g., in ampoules or in multidose containers, with an added preservative. The compositions may take such forms as suspensions, solutions or emulsions in oily or aqueous vehicles, and may contain formulatory agents such as suspending, stabilizing and/or dispersing agents.

Pharmaceutical formulations for parenteral administration include aqueous solutions of the active compounds in water-soluble form. Additionally, suspensions of the active compounds may be prepared as appropriate oily injection suspensions. Suitable lipophilic solvents or vehicles include fatty oils such as sesame oil, or synthetic fatty acid esters, such as ethyl oleate or triglycerides, or liposomes. Aqueous injection suspensions may contain substances, which increase the viscosity of the suspension, such as sodium carboxymethyl cellulose, sorbitol, or dextran. Optionally, the suspension may also contain suitable stabilizers or agents, which increase the solubility of the compounds to allow for the preparation of highly concentrated solutions.

Alternatively, the active ingredient may be in powder form for constitution with a suitable vehicle, e.g., sterile pyrogen-free water, before use.

The compounds may also be formulated in rectal compositions such as suppositories or retention enemas, e.g., containing conventional suppository bases such as cocoa butter or other glycerides.

In addition to the formulations described previously, the compounds may also be formulated as a depot preparation. Such long acting formulations may be administered by implantation (for example subcutaneously or intramuscularly) or by intramuscular injection. Thus, for example, the compounds may be formulated with suitable polymeric or hydrophobic materials (for example as an emulsion in an acceptable oil) or ion exchange resins, or as sparingly soluble derivatives, for example, as a sparingly soluble salt.

A pharmaceutical carrier for the hydrophobic compounds of the invention is a co-solvent system comprising benzyl alcohol, a nonpolar surfactant, a water-miscible organic polymer, and an aqueous phase. Naturally, the proportions of a co-solvent system may be varied considerably without destroying its solubility and toxicity characteristics. Furthermore, the identity of the co-solvent components may be varied.

Alternatively, other delivery systems for hydrophobic pharmaceutical compounds may be employed. Liposomes and emulsions are well known examples of delivery vehicles or carriers for hydrophobic drugs. Certain organic solvents such as dimethylsulfoxide also may be employed, although usually at the cost of greater toxicity. Additionally, the compounds may be delivered using a sustained-release system, such as semi-permeable matrices of solid hydrophobic polymers containing therapeutic agent. Various sustained-release materials have been established and are well known by those skilled in the art. Sustained-release capsules may, depending on their chemical nature, release the compounds for a few weeks up to over 100 days. Depending on the chemical nature and the biological stability of therapeutic reagent, additional strategies for protein stabilization may be employed.

Pharmaceutical compositions also may comprise suitable solid or gel phase carriers or excipients. Examples of such carriers or excipients include, but are not limited to, calcium carbonate, calcium phosphate, various sugars, starches, cellulose derivatives, gelatin, and polymers such as polyethylene glycols.

Many of the compounds of the invention may be provided as salts with pharmaceutically compatible counterions. Pharmaceutically compatible salts may be formed with many acids, including but, not limited to, hydrochloric, sulfuric, acetic, lactic, tartaric, malic, succinic, etc. Salts tend to be more soluble in aqueous or other protonic solvents than are the corresponding free base forms.

Suitable routes of administration may, for example, include oral, rectal, transmucosal, transdermal, or intestinal administration; or parenteral delivery, including intramuscular, subcutaneous, intramedullary injections, as well as intrathecal, direct intraventricular, intravenous, intraperitoneal, intranasal, or intraocular injections.

Alternately, one may administer the compound in a local rather than systemic manner, for example, via injection of the compound directly into an affected area, often in a depot or sustained release formulation.

Furthermore, one may administer the drug in a targeted drug delivery system, for example, in a liposome coated with an antibody specific for affected cells. The liposomes will be targeted to and taken up selectively by the cells.

Pharmaceutical compositions generally are administered in an amount effective for treatment or prophylaxis of a specific indication or indications. It is appreciated that optimum dosage will be determined by standard methods for each treatment modality and indication, taking into account the indication, its severity, route of administration, complicating conditions and the like. In therapy or as a prophylactic, the active agent may be administered to an individual as an injectable composition, for example, as a sterile aqueous dispersion, preferably isotonic. A therapeutically effective dose further refers to that amount of the compound sufficient to result in amelioration of symptoms associated with such disorders. Techniques for formulation and administration of the compounds of the instant application may be found in “Remington's Pharmaceutical Sciences,” Mack Publishing Co., Easton, Pa., latest edition. For administration to mammals, and particularly humans, it is expected that the daily dosage level of the active agent will be from 0.001 mg/kg to 10 mg/kg, typically around 0.01 mg/kg. The physician in any event will determine the actual dosage, which will be most suitable for an individual and will vary with the age, weight and response of the particular individual. The above dosages are exemplary of the average case. There can, of course, be individual instances where higher or lower dosage ranges are merited, and such are within the scope of this invention.

Compounds of the invention may be particularly useful in animal disorders (veterinarian indications), and particularly mammals.

The invention further provides diagnostic and pharmaceutical packs and kits comprising one or more containers filled with one or more of the ingredients of the aforementioned compositions of the invention. Associated with such container(s) can be a notice in the form prescribed by a governmental agency regulating the manufacture, use or sale of pharmaceuticals or biological products, reflecting approval by the agency of the manufacture, use or sale of the product for human administration.

The present invention is further illustrated by the following examples, which should not be construed as limiting in any way. The contents of all cited references (including literature references, issued patents, published patent applications), as cited throughout this application, are hereby expressly incorporated by reference. The practice of the present invention will employ, unless otherwise indicated, conventional techniques of cell biology, cell culture, molecular biology, transgenic biology, microbiology, recombinant DNA, and immunology, which are known to those skilled in the art. Such techniques are explained fully in the literature.

### EXAMPLES

### Example 1

### Urine Sample Collection

To identify biomarkers capable of classifying a patient as healthy, having prostate cancer or a non-malignant disease of the prostate, a total of 184 patient samples were tested for the presence of differentially expressed biomarkers using SELDI-based technology by Ciphergen® Biosystems.

A total of 184 urine samples were collected from patients at the Edmonton Prostate and Urological Research Centre (EPURC, Edmonton Alberta Canada, 42 prostate cancer, 15 BPH, 34 control/healthy), Winnipeg Clinic (WC, Winnipeg Manitoba Canada, 24 prostate cancer, 27 BPH, 40 control/healthy) and Victoria General Hospital (VGH, Winnipeg Manitoba Canada, 2 control/healthy). Medical histories, including diagnosis, were likewise obtained. Samples were collected in midstream to limit contamination. Of the 184 urine samples collected, a total of 66 samples were derived from patients with prostate cancer (PCa samples), 42 were derived from patients with benign prostatic hyperplasia (BPH samples), and 76 were derived from patients diagnosed as having neither prostate cancer nor benign prostatic hyperplasia (Control samples). Those samples collected from patients diagnosed with prostate cancer are further subdivided into samples taken from prostate cancer patients that have undergone androgen therapy (27) and those that have not. (31 samples). Patients were approximately age-matched (PCa 71.6±7.9 years, non-PCa 62.8±14.9) and >95% of patients from each geographical location were Caucasian.

Additionally, 76 samples were collected from patients with a confirmed diagnosis via biopsy. The patients were initially recruited from 18 independent urological clinics in southern Ontario and Quebec (Canada). Of the 76 samples, 46 were obtained from patients that were diagnosed as having prostate cancer and 30 were diagnosed as having a non-cancerous disease of the prostate such as prostatic intraepithelial neoplasia, (PIN), benign prostatic hyperplasia (BPH), hyperplasia, inflammation of the prostate, or non-malignant tissue.

Samples were shipped on dry ice and securely stored at −80° C. prior to being thawed and dispensed into 10 equal volume aliquots after assignment of a random 8-digit hexadecimal sample number. These aliquots were then securely stored at −80° C. until use. Thus, each sample was analysed after having undergone exactly two freeze/thaw cycles. Sample handling was conducted in accordance to Health Canada and CDC guidelines for BSL-2 pathogens.

### Example 2

### Biomarker Profile Generation

To detect the presence or absence of biomarkers in patient plasma samples, ProteinChip® array analysis was performed using silicone dioxide-coated protein chip arrays (NP20 ProteinChips® from Ciphergen Biosystems). Immediately prior to application to the ProteinChips®, urine samples were removed from −80° C. and allowed to thaw on ice. Samples were then centrifuged for 10 min. at 4° C. to remove precipitate matter prior to use. Two μL of untreated urine or positive/negative control sample was applied to each spot on each array according to random assignment. Samples were allowed to air-dry on the array surface at room temperature. Whereas a pooled sample (250 μl) of 10 randomly selected urine samples (at 25 μl each) served as a positive control, PBS was used as a negative control on each array. Duplicate spots were used to assay each of the 184 urine samples tested, and were also randomly assigned across all arrays used. The distribution of the spots used on particular arrays for a given sample or control were recorded to ease sample application.

Each spot was then washed with 5 μL HPLC-grade water for up to one minute, with wash water being removed by capillary action into a lint-free tissue (KimWipes®). After washing two aliquots of 0.6 μL 20% (w/v) CHCA suspended in 50% (v/v) acetonitrile, 0.5% (v/v) trifluoroacetic acid were applied to each spot, allowing sufficient time for the spots to dry between applications.

Prior to reading of the arrays, the ProteinChips® reader was calibrated for detection of biomarkers within a lower mass range using Hirudin BKHV (7,034 Da), myoglobin (16,951 Da) and carbonic anhydrase (29,023 Da). ProteinChips® which had EAM (20% (w/v) CHCA in 50% (v/v) acetonitrile, 0.5% (v/v) trifluoroacetic acid) applied were assayed for potential biomarkers in the lower mass range using a PCS4000 SELDI-TOF mass spectrometer and a laser intensity of 2,000 nJ over a mass range of 0 to 30,000 m/z. A mass focus of 10,000 m/z was used, as was a matrix attenuation value of 500 m/z.

To analyse for biomarkers within the upper mass range, the ProteinChips® reader was re-calibrated using the calibrants carbonic anhydrase (29,023 Da) and enolase (46,671 Da). Once the ProteinChip® reader was re-calibrated, the ProteinChips® were assayed for potential biomarkers within the higher mass range. A laser intensity of 3,000 nJ over a mass range of 30,000-80,000 m/z was used for the detection of bound biomolecules with a mass focus of 40,000 m/z, the matrix attenuation value was set to 5,000 m/z.

All mass spectra generated within each above-mentioned mass range were normalized for total ion current with the CiphergenExpress™ software package. Positive and negative control spectra were excluded from subsequent data analysis. The mean normalization factor for all remaining spectra (PCa, BPH and control/healthy spectra) was calculated. A total of 13 spectra were excluded from data analysis because of excessive normalization factor in the mass range of 1500 to 30,000 m/z (Table 2) more than two standard deviations from this mean (normalization factor <0 or >7.89). No single sample had more than one spectrum excluded from analysis in this manner.

TABLE 2
SELDI-TOF MS spectra excluded from data analysis because of
excessive normalization factor in the 1500-30000 m/z range.

| | | Sample . . . | | Normalization |
|---|---|---|---|---|
| ProteinChip# | Spot ID | Name | Type | Factor |
| 1050137589 | C | 51F3E9DF | BPH | 28.34276163 |
| 1050137549 | D | 05AE7597 | PCa | 8.706034458 |
| 1050137555 | A | FD8B2CAB | BPH | 8.647381049 |
| 1050137556 | A | E5DDBF2B | BPH | 8.260942365 |
| 1050137572 | E | DA138D93 | PCa | 11.86376365 |
| 1050137573 | G | D3ECC838 | PCa | 25.6419626 |
| 1050137579 | B | 917A1DC2 | PCa | 25.36237774 |
| 1050137584 | A | CFBE5B81 | ctrl | 13.14880484 |
| 1050137586 | G | 89D84AF2 | PCa | 19.42114142 |
| 1050137588 | A | 14573DF8 | PCa | 17.30506934 |
| 1050137588 | C | D3ECC838 | PCa | 11.85607982 |
| 1050137589 | E | 7DD9F81B | ctrl | 11.11679453 |
| 1050137622 | A | CECB747A | PCa | 8.267747303 |

### Example 3

### Peak Detection

Once the arrays were assayed and spectrum were generated for each spot on the ProteinChips®, entity difference maps (EDMs) were derived using CiphergenExpress™ software. For the lower mass range, automatic peak detection between 1,500 and 30,000 m/z was conducted, using first pass S/N and valley depth cut-offs of 3.0, second pass S/N and valley depth cut-offs of 2.0, and assignment of peaks where necessary to ensure that every peak was represented exactly once in each spectrum. Peaks in different spectra were considered to belong to the same cluster if they fell within 0.3% of their observed m/z. Peaks were only retained for further statistical analysis if they were independently detected (that is, were not estimated) in at least 10% of all spectra. Analysis of the remaining spectra by Mann-Whitney and Kruskal-Wallis statistics indicated several potentially useful markers in this mass range, which can differentiate BPH from PCa or ctrl from PCa namely Ur3049, Ur3338, Ur3529, Ur4013, Ur4051, Ur4360, Ur5004, Ur5385, Ur8177, Ur9898, Ur10517, Ur10560, Ur10632 and Ur10751 (Tables 3 to 8).

TABLE 3
Peak cluster statistics of BPH vs. Control vs. PCa urine samples assayed
using NP20 ProteinChips ® in the 1500-30000 m/z range.

| | | M/Z | | | | Intensity | | | | Peaks | |
|---|---|---|---|---|---|---|---|---|---|---|---|
| Index | P | Avg | Median | SD | CV | Avg | Median | SD | CV | # Estimated | % Estimated |
| 67 | 4.8 × 10⁻³ | 3338.08 | 3338.53 | 2.07 | 0.062 | 45.48 | 42.93 | 18.54 | 40.8 | 152 | 80 |
| 88 | 0.017 | 4013.21 | 4014.95 | 6.78 | 0.169 | 30.65 | 28.35 | 14.67 | 47.9 | 110 | 58 |
| 89 | 0.039 | 4051.82 | 4052.27 | 0.95 | 0.023 | 29.87 | 29.02 | 12.74 | 42.6 | 121 | 64 |
| 100 | 4.7 × 10⁻³ | 4359.90 | 4359.48 | 4.65 | 0.107 | 45.62 | 45.43 | 17.08 | 37.4 | 59 | 31 |
| 117 | 8.8 × 10⁻³ | 5004.11 | 5005.38 | 3.22 | 0.064 | 28.72 | 28.27 | 13.56 | 47.2 | 28 | 15 |
| 125 | 0.019 | 5386.13 | 5386.89 | 1.97 | 0.037 | 10.42 | 3.42 | 21.43 | 205.7 | 161 | 85 |
| 211 | 8.6 × 10⁻⁴ | 10561.23 | 10561.34 | 2.45 | 0.023 | 4.08 | 1.44 | 8.59 | 210.4 | 170 | 89 |
| 212 | 2.2 × 10⁻⁶ | 10633.33 | 10632.54 | 2.51 | 0.024 | 7.78 | 1.62 | 20.63 | 265.3 | 167 | 88 |
| 215 | 1.7 × 10⁻⁹ | 10751.31 | 10751.00 | 2.47 | 0.023 | 18.15 | 3.29 | 47.91 | 264.0 | 71 | 37 |

TABLE 4
Peak cluster statistics of Control vs. PCa urine samples assayed using NP20 ProteinChips ® in the 1500-30000 m/z range.

| | | | M/Z | | | | Intensity | | | | Peaks | |
|---|---|---|---|---|---|---|---|---|---|---|---|---|
| Index | P | ROCAUC | Avg | Median | SD | CV | Avg | Median | SD | CV | # Estimated | % Estimated |
| 67 | 8.8 × 10⁻³ | 0.367 | 3338.11 | 3338.53 | 2.06 | 0.062 | 46.85 | 43.28 | 19.04 | 40.6 | 115 | 78 |
| 100 | 9.6 × 10⁻⁴ | 0.345 | 4359.81 | 4359.48 | 4.59 | 0.105 | 45.78 | 45.87 | 16.59 | 36.2 | 49 | 33 |
| 117 | 3.4 × 10⁻³ | 0.372 | 5004.20 | 5005.38 | 3.10 | 0.062 | 29.34 | 28.23 | 13.15 | 44.8 | 19 | 13 |
| 125 | 0.014 | 0.604 | 5386.26 | 5386.89 | 1.78 | 0.033 | 8.11 | 3.06 | 16.59 | 204.6 | 131 | 89 |
| 201 | 0.041 | 0.408 | 9898.83 | 9898.95 | 1.61 | 0.016 | 8.84 | 7.23 | 6.93 | 78.4 | 110 | 75 |
| 211 | 0.016 | 0.621 | 10561.18 | 10561.34 | 2.32 | 0.022 | 2.91 | 1.32 | 5.67 | 195.0 | 131 | 89 |
| 212 | 2.6 × 10⁻⁵ | 0.691 | 10633.13 | 10632.54 | 2.36 | 0.022 | 5.00 | 1.45 | 13.36 | 267.0 | 132 | 90 |
| 215 | 1.7 × 10⁻⁸ | 0.761 | 10751.26 | 10751.00 | 2.39 | 0.022 | 12.47 | 2.97 | 35.74 | 286.7 | 58 | 39 |

TABLE 5
Peak cluster statistics of BPH vs. PCa urine samples assayed using NP20 ProteinChips ® in the 1500-30000 m/z range.

| | | | M/Z | | | | Intensity | | | | Peaks | |
|---|---|---|---|---|---|---|---|---|---|---|---|---|
| Index | P | ROCAUC | Avg | Median | SD | CV | Avg | Median | SD | CV | # Estimated | % Estimated |
| 62 | 0.033 | 0.637 | 3049.48 | 3049.30 | 0.61 | 0.020 | 32.20 | 30.01 | 14.85 | 46.1 | 68 | 61 |
| 67 | 3.7 × 10⁻³ | 0.670 | 3337.99 | 3338.53 | 2.19 | 0.066 | 47.28 | 45.05 | 20.33 | 43.0 | 89 | 79 |
| 75 | 0.027 | 0.633 | 3529.32 | 3529.21 | 0.41 | 0.012 | 29.20 | 28.91 | 11.53 | 39.5 | 98 | 88 |
| 88 | 7.2 × 10⁻³ | 0.648 | 4012.43 | 4014.95 | 7.51 | 0.187 | 31.65 | 27.76 | 16.08 | 50.8 | 64 | 57 |
| 89 | 0.016 | 0.626 | 4051.88 | 4052.27 | 0.87 | 0.021 | 30.37 | 29.22 | 13.69 | 45.1 | 71 | 63 |
| 117 | 0.032 | 0.607 | 5004.31 | 5005.61 | 3.26 | 0.065 | 30.48 | 30.44 | 14.44 | 47.4 | 17 | 15 |
| 125 | 0.021 | 0.395 | 5386.20 | 5386.89 | 1.89 | 0.035 | 10.04 | 2.52 | 21.83 | 217.5 | 94 | 84 |
| 210 | 1.4 × 10⁻³ | 0.328 | 10518.65 | 10518.33 | 2.13 | 0.020 | 3.63 | 1.19 | 7.06 | 194.8 | 99 | 88 |
| 211 | 4.4 × 10⁻⁴ | 0.299 | 10561.44 | 10561.34 | 2.63 | 0.025 | 4.35 | 1.44 | 9.46 | 217.8 | 98 | 88 |
| 215 | 3.7 × 10⁻⁷ | 0.225 | 10751.19 | 10751.00 | 2.31 | 0.022 | 17.96 | 2.32 | 49.68 | 276.7 | 57 | 51 |

TABLE 6
Peak cluster statistics of BPH + Control vs. PCa urine samples assayed
using NP20 ProteinChips ® in the 1500-30000 m/z range.

| | | | M/Z | | | | Intensity | | | | Peaks | |
|---|---|---|---|---|---|---|---|---|---|---|---|---|
| Index | P | ROCAUC | Avg | Median | SD | CV | Avg | Median | SD | CV | # Estimated | % Estimated |
| 62 | 0.025 | 0.395 | 3049.44 | 3049.30 | 0.58 | 0.019 | 31.26 | 29.51 | 13.96 | 44.7 | 138 | 73 |
| 67 | 1.5 × 10⁻³ | 0.359 | 3338.08 | 3338.53 | 2.07 | 0.062 | 45.48 | 42.93 | 18.54 | 40.8 | 148 | 78 |
| 88 | 0.010 | 0.382 | 4013.21 | 4014.95 | 6.78 | 0.169 | 30.65 | 28.35 | 14.67 | 47.9 | 119 | 63 |
| 89 | 0.025 | 0.409 | 4051.82 | 4052.27 | 0.95 | 0.023 | 29.87 | 29.02 | 12.74 | 42.6 | 134 | 71 |
| 100 | 3.0 × 10⁻³ | 0.391 | 4359.90 | 4359.48 | 4.65 | 0.107 | 45.62 | 45.43 | 17.08 | 37.4 | 61 | 32 |
| 117 | 2.3 × 10⁻³ | 0.382 | 5004.11 | 5005.38 | 3.22 | 0.064 | 28.72 | 28.27 | 13.56 | 47.2 | 38 | 20 |
| 125 | 5.2 × 10⁻³ | 0.614 | 5386.13 | 5386.89 | 1.97 | 0.037 | 10.42 | 3.42 | 21.43 | 205.7 | 162 | 85 |
| 176 | 0.036 | 0.591 | 8177.25 | 8177.56 | 2.34 | 0.029 | 7.49 | 6.94 | 3.83 | 51.1 | 28 | 15 |
| 211 | 9.2 × 10⁻⁴ | 0.650 | 10561.23 | 10561.34 | 2.45 | 0.023 | 4.08 | 1.44 | 8.59 | 210.4 | 162 | 85 |
| 212 | 7.7 × 10⁻⁷ | 0.687 | 10633.33 | 10632.54 | 2.51 | 0.024 | 7.78 | 1.62 | 20.63 | 265.3 | 160 | 84 |
| 215 | 2.7 × 10⁻¹⁰ | 0.764 | 10751.31 | 10751.00 | 2.47 | 0.023 | 18.15 | 3.29 | 47.91 | 264.0 | 81 | 43 |

TABLE 7
Peak cluster statistics of BPH vs. Control urine samples assayed using
NP20 ProteinChips ® in the 1500-30000 m/z range.

| | | | M/Z | | | | Intensity | | | | Peaks | |
|---|---|---|---|---|---|---|---|---|---|---|---|---|
| Index | P | ROCAUC | Avg | Median | SD | CV | Avg | Median | SD | CV | # Estimated | % Estimated |
| 95 | 0.044 | 0.592 | 4222.15 | 4221.84 | 0.96 | 0.023 | 26.30 | 26.01 | 11.55 | 43.9 | 91 | 75 |
| 168 | 0.042 | 0.585 | 7740.84 | 7740.87 | 3.44 | 0.044 | 3.44 | 2.85 | 2.59 | 75.3 | 107 | 88 |
| 235 | 0.034 | 0.374 | 13354.68 | 13358.45 | 17.29 | 0.129 | 0.36 | 0.17 | 0.67 | 186.8 | 102 | 84 |

TABLE 8
Summary of peaks capable of discriminating urine
samples obtained from prostate cancer patients from
other patients in the 1500 to 30,000 m/z range.

| | | Differentiates PCa from . . . | | | Elevated in . . . | |
|---|---|---|---|---|---|---|
| Index | M/Z | Ctrl | BPH | Ctrl + BPH | PCa | Non-PCa |
| 62 | 3049.44 | No | Yes | Yes | No | Yes |
| 67 | 3338.08 | Yes | Yes | Yes | Yes | No |
| 75 | 3529.32 | No | Yes | No | Yes | No |
| 88 | 4013.21 | No | Yes | Yes | Yes | No |
| 89 | 4051.82 | No | Yes | Yes | Yes | No |
| 100 | 4359.90 | Yes | No | Yes | Yes | No |
| 117 | 5004.11 | Yes | Yes | Yes | Yes | No |
| 125 | 5386.13 | Yes | Yes | Yes | No | Yes |
| 176 | 8177.25 | No | No | Yes | No | Yes |
| 201 | 9898.83 | Yes | No | No | Yes | No |
| 210 | 10518.65 | No | Yes | No | No | Yes |
| 211 | 10561.23 | Yes | Yes | Yes | No | Yes |
| 212 | 10633.33 | Yes | No | Yes | No | Yes |
| 215 | 10751.31 | Yes | Yes | Yes | No | Yes |

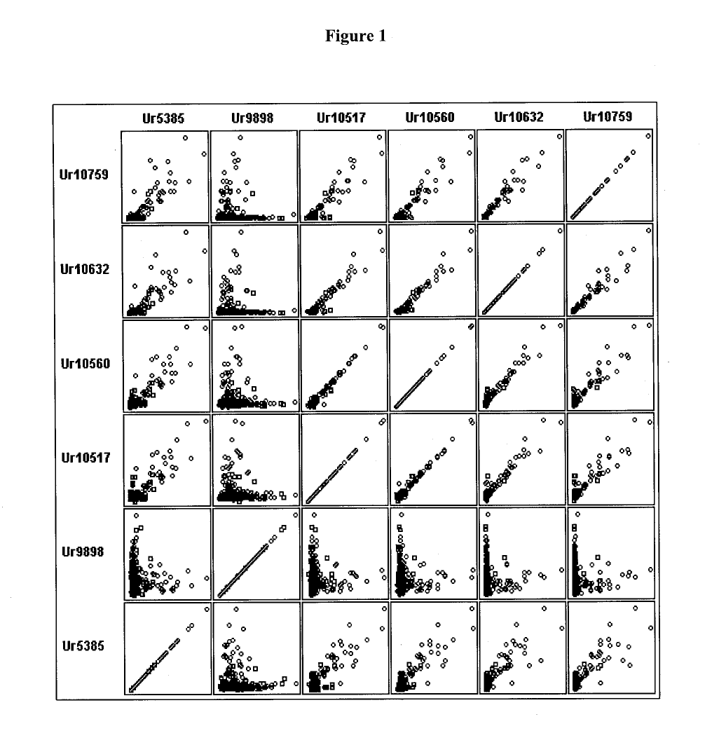

FIG. 1 demonstrates the correlation of urine SELDI-MS peaks that are discriminatory for prostate cancer. X and Y-axes represent peak intensities for the marker indicated for that row or column. All urine peak data for peaks in the 0 to 30,000 m/z range was examined visually using WEKA to identify peaks whose expression might be easily correlated, but only data for peaks Ur5385, Ur9898, Ur10517, Ur10560, Ur10632 and Ur10759 are presented due to space constraints. Perfect correlation is demonstrated where intensities for the same peak are used for both the X and Y axes, showing a straight line of points from the bottom left to top right of a panel. Note that peaks Ur5385, Ur10517, Ur10560, Ur10632 and Ur10759 appear to be correlated. Peak Ur9898 is included to demonstrate the depiction of an uncorrelated peak.

Analysis with WEKA indicates that these markers can give sensitivity/specificity of about the 65/65 with non-optimised classification algorithms (Tables 9 and 10). Peak Ur10759 appears to be the best of these markers at differentiating PCa from non-PCa patient (Tables 11 to 14). In addition, biomarkers Ur10632, Ur10560, Ur10517 and Ur5385, appear to have expression levels correlated to that of Ur10759 (FIG. 1).

TABLE 9
Calculation of specificity and sensitivity for classifiers derived
from various algorithms using SELDI-MS peak data for peaks observed
in urine samples in the 1500-30000 m/z range.

| | | | | | Specificity | Sensitivity |
|---|---|---|---|---|---|---|
| Algorithm | TP | FP | TN | FN | (%) | (%) |
| NBTree | 66 | 49 | 188 | 66 | 79.32 | 50.00 |
| J48 | 85 | 65 | 172 | 47 | 72.57 | 64.39 |
| Jrip | 64 | 55 | 182 | 68 | 76.79 | 48.48 |
| Ridor | 49 | 29 | 208 | 83 | 87.76 | 37.12 |
| Conj Rule | 36 | 40 | 197 | 96 | 83.12 | 27.27 |
| PART | 61 | 42 | 195 | 71 | 82.28 | 46.21 |
| OneR | 66 | 54 | 183 | 66 | 77.22 | 50.00 |

Classification was done as either prostate cancer or non- prostate cancer.

TABLE 10
Calculation of specificity and sensitivity for classifiers derived
from various algorithms using SELDI-MS peak data for peaks observed
in urine samples in the 1500-30000 m/z range.

| | | | | | Specificity | Sensitivity |
|---|---|---|---|---|---|---|
| Algorithm | TP | FP | TN | FN | (%) | (%) |
| NBTree | 85 | 77 | 160 | 47 | 67.51 | 64.39 |
| J48 | 70 | 75 | 162 | 62 | 68.35 | 53.03 |
| Jrip | 67 | 54 | 183 | 65 | 77.22 | 50.76 |
| Ridor | 86 | 69 | 168 | 46 | 70.89 | 65.15 |
| Conj Rule | 84 | 75 | 162 | 48 | 68.35 | 63.64 |
| PART | 74 | 66 | 171 | 58 | 72.15 | 56.06 |
| OneR | 79 | 78 | 159 | 53 | 67.09 | 59.85 |

Classification was done as either prostate cancer or non- prostate cancer.

TABLE 11
Summary of ranks for different ranking attribute evaluation
algorithms of SELDI-MS peak data for peaks observed
in urine samples in the 1500-30000 m/z range.

| | Binary Classification Scheme | | | | | | | |
|---|---|---|---|---|---|---|---|---|
| | RANK IN TEST TYPE | | | | | | | Avg |
| Peak ID | SVM | Chi | Symm | OneR | RelF | IGain | GainR | Rank |
| Ur3049 | 8 | 9 | 8 | 14 | 8 | 9 | 8 | 9.14 |
| Ur3338 | 3 | 3 | 5 | 6 | 7 | 3 | 5 | 4.57 |
| Ur3529 | 14 | 6 | 9 | 12 | 10 | 6 | 9 | 9.43 |
| Ur4013 | 1 | 7 | 6 | 9 | 13 | 7 | 6 | 7.00 |
| Ur4051 | 12 | 10 | 7 | 3 | 12 | 10 | 7 | 8.71 |
| Ur4360 | 7 | 13 | 13 | 11 | 14 | 13 | 13 | 12.00 |
| Ur5004 | 4 | 4 | 4 | 13 | 11 | 4 | 4 | 6.29 |
| Ur5385 | 10 | 5 | 3 | 5 | 2 | 5 | 2 | 4.57 |
| Ur8177 | 6 | 11 | 10 | 7 | 9 | 11 | 10 | 9.14 |
| Ur9898 | 5 | 12 | 11 | 8 | 6 | 12 | 11 | 9.29 |
| Ur10517 | 13 | 14 | 12 | 10 | 4 | 14 | 12 | 11.29 |
| Ur10560 | 11 | 8 | 14 | 4 | 1 | 8 | 14 | 8.57 |
| Ur10632 | 9 | 2 | 2 | 2 | 5 | 2 | 3 | 3.57 |
| Ur10759 | 2 | 1 | 1 | 1 | 3 | 1 | 1 | 1.43 |

Patient classification was done as either prostate cancer or non-prostate cancer.

TABLE 12
Summary of ranks for different ranking attribute evaluation
algorithms of SELDI-MS peak data for peaks observed
in urine samples in the 1500-30000 m/z range.

| | Trinary Classification Scheme | | | | | | | |
|---|---|---|---|---|---|---|---|---|
| | RANK IN TEST TYPE | | | | | | | Avg |
| Peak ID | SVM | Chi | Symm | OneR | RelF | IGain | GainR | Rank |
| Ur3049 | 12 | 7 | 7 | 12 | 10 | 7 | 7 | 8.86 |
| Ur3338 | 7 | 8 | 8 | 6 | 6 | 8 | 8 | 7.29 |
| Ur3529 | 13 | 6 | 6 | 9 | 14 | 6 | 6 | 8.57 |
| Ur4013 | 3 | 4 | 4 | 4 | 11 | 4 | 4 | 4.86 |
| Ur4051 | 14 | 5 | 5 | 3 | 13 | 5 | 5 | 7.14 |
| Ur4360 | 10 | 9 | 9 | 11 | 7 | 9 | 9 | 9.14 |
| Ur5004 | 9 | 13 | 13 | 8 | 9 | 13 | 13 | 11.14 |
| Ur5385 | 2 | 14 | 14 | 5 | 3 | 14 | 14 | 9.43 |
| Ur8177 | 11 | 12 | 12 | 13 | 12 | 12 | 12 | 12.00 |
| Ur9898 | 8 | 10 | 10 | 7 | 8 | 10 | 10 | 9.00 |
| Ur10517 | 5 | 3 | 3 | 14 | 2 | 3 | 1 | 4.43 |
| Ur10560 | 4 | 11 | 11 | 10 | 1 | 11 | 11 | 8.43 |
| Ur10632 | 1 | 2 | 2 | 2 | 4 | 2 | 3 | 2.29 |
| Ur10759 | 6 | 1 | 1 | 1 | 5 | 1 | 2 | 2.43 |

Patient classification was done as, either prostate cancer, control or BPH.

TABLE 13
Frequency of peak occurrence using classification and non- ranking
attribute evaluation algorithms for SELDI-MS peak data for peaks
observed in urine samples in the 1500-30000 m/z range.

| | Total |
|---|---|
| Peak ID | Frequency |
| Ur3049 | 1 |
| Ur3338 | 8 |
| Ur3529 | 1 |
| Ur4013 | 1 |
| Ur4051 | 1 |
| Ur4360 | 5 |
| Ur5004 | 7 |
| Ur5385 | 3 |
| Ur8177 | 0 |
| Ur9898 | 0 |
| Ur10517 | 0 |
| Ur10560 | 2 |
| Ur10632 | 6 |
| Ur10759 | 15 |

Patient classification was done as either prostate cancer or non-prostate cancer.

TABLE 14
Frequency of peak occurrence using classification and non- ranking
attribute evaluation algorithms for SELDI-MS peak data for peaks
observed in urine samples in the 1500-30000 m/z range.

| | Total |
|---|---|
| Peak ID | Frequency |
| Ur3049 | 3 |
| Ur3338 | 3 |
| Ur3529 | 2 |
| Ur4013 | 1 |
| Ur4051 | 0 |
| Ur4360 | 3 |
| Ur5004 | 4 |
| Ur5385 | 1 |
| Ur8177 | 3 |
| Ur9898 | 2 |
| Ur10517 | 8 |
| Ur10560 | 3 |
| Ur10632 | 3 |
| Ur10759 | 15 |

Patient classification was done as either prostate cancer or non-prostate cancer.

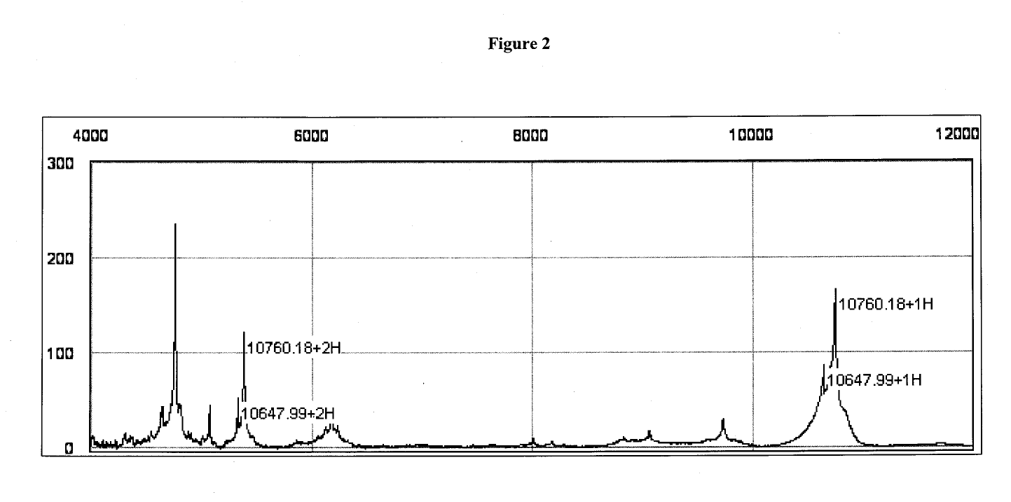

The correlated expression levels observed for biomarkers Ur0632, Ur10517, Ur5385 and Ur10759 may be indicative of either a coordinated biological expression of these factors, or cleavage/degradation products of Ur10759. Indeed, Ur5385 appears to be a doubly charged version of Ur10759 (FIG. 2). FIG. 2 shows the presence of doubly charged peptides discriminatory for prostate cancer was first intuited by visual examination of mass spectra. Comparison of peak masses further support the conclusion that at least some of the peaks discovered may be multiply charged versions of larger peaks that are also discriminatory for prostate cancer. The “detect multiple charge peaks” function in the CiphergenExpress software was used to confirm the presence of such peaks. The spectrum above gives the output of the CiphergenExpress software, showing two pairs of peaks, one that is singly charged (m/z ˜10760 and 10648) and one that is doubly charged (m/z ˜5380 and 5325). The sample used to generate this spectrum was 4511E1D2.

In contrast, the peaks found in the mass range of 30,000 to 80,000 m/z appear less useful than those found in the lower mass ranges. Four spectra were excluded due to excessive normalization factor (Table 15), but little overlap was seen in the comparisons done between BPH vs. PCa, ctrl vs. PCa and BPH+ctrl vs. PCa (Tables 16 to 21). Indeed, only peak Ur33923 was observed using all three comparisons, with a P value ranging from 0.006 to 0.039. Visual inspection of spectra indicated that none of the peaks with P<0.05 and found in ≧10% of the spectra were likely to be “real” peaks—all appeared to be more likely the result of background noise or were shoulders of other, major peaks.

TABLE 15
SELDI-TOF MS spectra excluded from data analysis
because of excessive normalization factor
in the 30,000-80,000 m/z range.

| | | Sample . . . | | Normalization |
|---|---|---|---|---|
| ProteinChip# | Spot ID | Name | Type | Factor |
| 1050137618 | H | F8F361C9 | ctrl | 6.417 |
| 1050137621 | E | E5DDBF2B | BPH | 4.936 |
| 1050137622 | F | 14573DF8 | PCa | 5.487 |
| 1050137622 | C | 8865A7F4 | ctrl | 4.962 |

TABLE 16
Peak cluster statistics of BPH vs. Control vs. PCa urine samples assayed
using NP20 ProteinChips ® in the 30,000-80,000 m/z range.

| | | M/Z | | | | Intensity | | | | Peaks | |
|---|---|---|---|---|---|---|---|---|---|---|---|
| Index | P | Avg | Median | SD | CV | Avg | Median | SD | CV | # Estimated | % Estimated |
| 14 | 0.049 | 31618.49 | 31617.43 | 9.09 | 0.029 | 0.15 | 0.13 | 0.08 | 57.9 | 141 | 73.8 |
| 31 | 0.050 | 33718.54 | 33722.14 | 26.16 | 0.078 | 0.28 | 0.25 | 0.13 | 47.8 | 134 | 70.2 |
| 32 | 0.024 | 33923.59 | 33924.59 | 16.79 | 0.049 | 0.23 | 0.21 | 0.12 | 53.3 | 130 | 68.1 |
| 35 | 0.025 | 34370.35 | 34370.52 | 10.80 | 0.031 | 0.16 | 0.15 | 0.10 | 59.4 | 152 | 79.6 |
| 36 | 0.038 | 34493.48 | 34493.78 | 6.58 | 0.019 | 0.14 | 0.12 | 0.09 | 64.5 | 167 | 87.4 |
| 109 | 0.046 | 62839.72 | 62839.16 | 35.19 | 0.056 | 0.09 | 0.08 | 0.06 | 63.5 | 154 | 80.6 |
| 141 | 0.012 | 79580.75 | 79589.17 | 37.87 | 0.048 | 0.02 | 0.01 | 0.01 | 80.0 | 162 | 84.8 |

TABLE 17
Peak cluster statistics of Control vs. PCa urine samples assayed using
NP20 ProteinChips ® in the 30,000-80,000 m/z range.

| | | | M/Z | | | | Intensity | | | | Peaks | |
|---|---|---|---|---|---|---|---|---|---|---|---|---|
| Index | P | ROCAUC | Avg | Median | SD | CV | Avg | Median | SD | CV | # Estimated | % Estimated |
| 14 | 0.015 | 0.369 | 31618.14 | 31617.43 | 9.32 | 0.029 | 0.15 | 0.13 | 0.09 | 60.2 | 111 | 75 |
| 22 | 0.038 | 0.420 | 32631.67 | 32634.04 | 7.22 | 0.022 | 0.22 | 0.19 | 0.13 | 59.5 | 132 | 89 |
| 25 | 0.033 | 0.393 | 32914.58 | 32915.29 | 5.59 | 0.017 | 0.27 | 0.24 | 0.15 | 55.2 | 132 | 89 |
| 31 | 0.020 | 0.385 | 33718.92 | 33722.14 | 26.01 | 0.077 | 0.28 | 0.25 | 0.13 | 47.4 | 103 | 70 |
| 32 | 0.011 | 0.369 | 33924.23 | 33924.59 | 16.72 | 0.049 | 0.23 | 0.22 | 0.12 | 53.2 | 101 | 68 |
| 35 | 0.010 | 0.364 | 34370.19 | 34370.52 | 10.61 | 0.031 | 0.16 | 0.15 | 0.10 | 61.7 | 117 | 79 |
| 36 | 0.017 | 0.396 | 34494.09 | 34493.78 | 6.58 | 0.019 | 0.14 | 0.12 | 0.09 | 65.5 | 129 | 87 |
| 38 | 0.021 | 0.391 | 34780.96 | 34781.17 | 10.59 | 0.030 | 0.12 | 0.11 | 0.08 | 64.0 | 122 | 82 |
| 51 | 0.017 | 0.604 | 37249.39 | 37249.44 | 9.04 | 0.024 | 0.08 | 0.07 | 0.06 | 71.9 | 128 | 86 |

TABLE 18
Peak cluster statistics of BPH vs. PCa urine samples assayed using NP20 ProteinChips ® in the 30,000-80,000 m/z range.

| | | | M/Z | | | | Intensity | | | | Peaks | |
|---|---|---|---|---|---|---|---|---|---|---|---|---|
| Index | P | ROCAUC | Avg | Median | SD | CV | Avg | Median | SD | CV | # Estimated | % Estimated |
| 22 | 0.042 | 0.596 | 32630.84 | 32634.04 | 8.12 | 0.025 | 0.22 | 0.19 | 0.13 | 58.5 | 95 | 85 |
| 24 | 0.051 | 0.603 | 32783.21 | 32781.04 | 13.93 | 0.042 | 0.25 | 0.23 | 0.13 | 53.0 | 89 | 79 |
| 30 | 0.035 | 0.599 | 33531.50 | 33529.26 | 13.48 | 0.040 | 0.32 | 0.32 | 0.15 | 47.5 | 91 | 81 |
| 32 | 0.039 | 0.618 | 33923.73 | 33924.59 | 16.67 | 0.049 | 0.24 | 0.22 | 0.11 | 48.2 | 81 | 72 |
| 36 | 0.065 | 0.603 | 34493.20 | 34493.78 | 6.90 | 0.020 | 0.14 | 0.13 | 0.08 | 56.3 | 98 | 88 |
| 101 | 0.043 | 0.403 | 58391.49 | 58391.38 | 54.25 | 0.093 | 0.05 | 0.05 | 0.03 | 60.9 | 79 | 71 |
| 109 | 0.018 | 0.407 | 62839.39 | 62839.16 | 34.22 | 0.054 | 0.09 | 0.08 | 0.06 | 63.5 | 88 | 79 |
| 141 | 7.1 × 10⁻³ | 0.655 | 79577.85 | 79589.17 | 39.75 | 0.050 | 0.02 | 0.01 | 0.01 | 86.5 | 94 | 84 |

TABLE 19
Peak cluster statistics of BPH + Control vs. PCa urine samples assayed
using NP20 ProteinChips ® in the 30,000-80,000 m/z range.

| | | | M/Z | | | | Intensity | | | | Peaks | |
|---|---|---|---|---|---|---|---|---|---|---|---|---|
| Index | P | ROCAUC | Avg | Median | SD | CV | Avg | Median | SD | CV | # Estimated | % Estimated |
| 14 | 0.029 | 0.398 | 31618.49 | 31617.43 | 9.09 | 0.029 | 0.15 | 0.13 | 0.08 | 57.9 | 147 | 77 |
| 24 | 0.044 | 0.421 | 32782.65 | 32781.04 | 14.50 | 0.044 | 0.25 | 0.23 | 0.13 | 52.8 | 147 | 77 |
| 30 | 0.020 | 0.402 | 33530.88 | 33529.26 | 13.05 | 0.039 | 0.31 | 0.29 | 0.16 | 50.1 | 146 | 76 |
| 31 | 0.015 | 0.389 | 33718.54 | 33722.14 | 26.16 | 0.078 | 0.28 | 0.25 | 0.13 | 47.8 | 138 | 72 |
| 32 | 6.3 × 10⁻³ | 0.387 | 33923.59 | 33924.59 | 16.79 | 0.049 | 0.23 | 0.21 | 0.12 | 53.3 | 148 | 77 |
| 35 | 0.016 | 0.400 | 34370.35 | 34370.52 | 10.80 | 0.031 | 0.16 | 0.15 | 0.10 | 59.4 | 158 | 83 |
| 38 | 0.032 | 0.405 | 34781.16 | 34781.17 | 10.11 | 0.029 | 0.12 | 0.11 | 0.07 | 60.8 | 158 | 83 |
| 51 | 0.030 | 0.590 | 37249.21 | 37249.44 | 9.64 | 0.026 | 0.08 | 0.07 | 0.06 | 73.4 | 164 | 86 |
| 101 | 0.049 | 0.581 | 58394.99 | 58391.38 | 51.42 | 0.088 | 0.05 | 0.05 | 0.03 | 61.0 | 135 | 71 |

TABLE 20
Peak cluster statistics of BPH vs. Control urine samples assayed using
NP20 ProteinChips ® in the 30,000-80,000 m/z range.

| | | | M/Z | | | | Intensity | | | | Peaks | |
|---|---|---|---|---|---|---|---|---|---|---|---|---|
| Index | P | ROCAUC | Avg | Median | SD | CV | Avg | Median | SD | CV | # Estimated | % Estimated |
| 45 | 0.027 | 0.640 | 36079.64 | 36080.15 | 8.91 | 0.025 | 0.08 | 0.08 | 0.05 | 65.0 | 101 | 83 |
| 109 | 0.038 | 0.396 | 62840.99 | 62839.16 | 34.98 | 0.056 | 0.09 | 0.08 | 0.06 | 62.4 | 99 | 81 |
| 134 | 0.041 | 0.619 | 75372.72 | 75381.01 | 156.48 | 0.208 | 0.04 | 0.04 | 0.03 | 63.9 | 45 | 37 |
| 141 | 0.011 | 0.636 | 79582.53 | 79589.17 | 35.05 | 0.044 | 0.02 | 0.01 | 0.01 | 80.6 | 108 | 89 |

TABLE 21
Summary of peaks capable of discriminating urine
samples obtained from prostate cancer patients from
other patients in the 30,000-80,000 m/z range.

| | | Differentiates PCa from . . . | | | Elevated in . . . | |
|---|---|---|---|---|---|---|
| Index | M/Z | Ctrl | BPH | Ctrl + BPH | PCa | Non-PCa |
| 14 | 31618.49 | Yes | No | Yes | Yes | No |
| 22 | 32631.67 | Yes | Yes | No | Yes | No |
| 24 | 32782.65 | No | Yes | Yes | Yes | No |
| 25 | 32914.58 | Yes | No | No | Yes | No |
| 30 | 33530.88 | No | Yes | Yes | Yes | No |
| 31 | 33718.54 | Yes | No | Yes | Yes | No |
| 32 | 33923.59 | Yes | Yes | Yes | Yes | No |
| 35 | 34370.35 | Yes | No | Yes | Yes | No |
| 36 | 34494.09 | Yes | Yes | No | Yes | No |
| 38 | 34781.16 | Yes | No | Yes | Yes | No |
| 51 | 37249.21 | Yes | No | Yes | No | Yes |
| 101 | 58394.99 | No | Yes | Yes | No | Yes |
| 109 | 62839.39 | No | Yes | No | No | Yes |
| 141 | 79577.85 | No | Yes | No | Yes | No |

### Example 4

### Biomarker Validation

### Phase I: Preliminary Biomarker Validation

Fifty-five naïve samples (not used during biomarker discovery) were assayed to detect and evaluate biomarkers shown to be statistically significant during Biomarker Discovery. Of the 55 samples, 39 samples had been originally collected from patients recruited by Winnipeg Clinic and Victoria General Hospital, both in Winnipeg, Manitoba. 16 samples had been previously collected by the Edmonton Prostate and Urological Research Center in Edmonton, Alberta.

Sample groups include prostate cancer (28 patients), benign prostate hyperplasia (BPH) (16 patients), and controls (11 patients) (Table 22).

TABLE 22
Patient recruitment by location and diagnosis.

| | Prostate | | | |
|---|---|---|---|---|
| | Cancer | BPH | Control | Total |
| Alberta | 12 | 3 | 1 | 16 |
| Manitoba | 16 | 13 | 10 | 39 |
| Total | 28 | 16 | 11 | 55 |

### Phase I: Sample Analysis

Samples were applied to NP20 ProteinChips® and assayed using the PCS4000 SELDI-TOF MS. Control samples and assay conditions were the same as those used for Biomarker Discovery as described in Examples 2 and 3.

Accordingly, spectral data generated from samples assayed using the PCS4000 SELDI-TOF MS were handled and analyzed in a manner identical to that in Biomarker Discovery as described in Examples 2 and 3. Whereas spectra generated in biomarker discovery that demonstrated excessive normalization factors were discarded, spectra generated in this preliminary validation set were not discarded.

Quantitative statistical comparisons (non-parametric methods, Mann-Whitney rank sum testing for comparisons of two groups) were made between prostate cancer and non-cancer (BPH and control) patients. For this evaluation, to be considered significant, a potential biomarker had to have a P<0.05 and also be independently detected in at least 10% of all spectra assayed.

Eight peaks corresponding to the approximate masses of peaks that were shown to be potential biomarkers during biomarker discovery were detected by the peak detection software used. Of 8 peaks tested, MI0750 was found to be expressed at significantly different levels in cancer samples compared to non-cancer samples (Table 23). Of the other potential biomarkers, MI0900 and MI0635 both have a greatly reduced P value compared to the other biomarkers tested. This may be indicative of a greater potential for statistical significance for these markers than the others tested, and suggest that these markers are truly discriminatory for prostate cancer.

TABLE 23
Summary of statistical significance of previously discovered
biomarkers in a preliminary validation set of urine
samples when using NP20 ProteinChips ®.

| Biomarker | P |
|---|---|
| MI0005 | 0.97 |
| MI0015 | 0.68 |
| MI0050 | 0.91 |
| MI0180 | 0.75 |
| MI0360 | 0.56 |
| MI0635 | 0.061 |
| MI0750 | 6.74 × 10⁻³ |
| MI0900 | 0.16 |

### Phase II: Biomarker Validation

A total of 216 urine samples were collected for validation of biomarkers initially identified in Biomarker Discovery. 127 samples were collected from patients recruited by Winnipeg Clinic and Victoria General Hospital, both in Winnipeg, Manitoba. An additional 58 samples were collected by the Edmonton Prostate and Urological Research Center in Edmonton, Alberta (Table 24).

Sample groups include prostate cancer (92 patients), benign prostate hyperplasia (BPH) (42 patients), and controls (51 patients) (Table 24).

TABLE 24
Patient recruitment by location and diagnosis.

| | Prostate | | | |
|---|---|---|---|---|
| | Cancer | BPH | Control | Total |
| Alberta | 24 | 8 | 26 | 58 |
| Manitoba | 68 | 34 | 25 | 127 |
| Total | 92 | 42 | 51 | 185 |

### Sample Analysis

Samples were applied to NP20 ProteinChips® and assayed using the PCS4000 SELDI-TOF MS. Control samples and assay conditions were the same as those used for Biomarker Discovery and the preliminary validation study, as described in Examples 2 and 3. Eight peaks corresponding to those assessed in Phase I of biomarker validation were retained after application of the Entity Difference Map functionality of CiphergenExpress™ (Ciphergen Biosystems, Fremont, Calif.) version 3.0.

For each of the retained peaks, quantitative statistical comparisons (non-parametric methods, Mann-Whitney rank sum testing for comparisons of two groups) were made between prostate cancer and control patients (no prostate disease); prostate cancer and BPH patients; and prostate cancer and non-cancer (BPH and control) patients. In this evaluation, to be considered significant, a potential biomarker had to have a P<0.05 and also be independently detected in at least 10% of all spectra assayed. Diagnostic utility was further confirmed through the use of receiver-operator characteristic curve analysis. Qualitative statistical analysis was conducted using WEKA on statistically significant biomarkers in order to prioritize these markers for identification.

Last, biomarkers found to be statistically significant were used to develop a classification model using methods developed in-house to ensure high test sensitivity. This model was created using the biomarker discovery data as a training set, and was then independently evaluated using the biomarker validation data.

Of the eight biomarkers assessed, three were statistically significant (P<0.05) for at least one of the comparisons made (MI0005, MI0635 and MI0750, see Table 25). The distribution of peak intensities for these peaks was then reviewed manually in order to ensure that expression patterns were consistent with those observed during biomarker discovery.

TABLE 25
Summary of urinary biomarkers tested to validate their capability to discriminate between
urine samples obtained from prostate cancer patients or from other patient types.

| | | Differentiates PCa from . . . | | | Elevated in . . . | | |
|---|---|---|---|---|---|---|---|
| Designation | M/Z | Ctrl | BPH | Ctrl + BPH | PCa | Non-PCa | Validated? |
| MI0005 | 5009.35 | 0.016 | — | 9.34 × 10⁻³ | ✓ | — | ✓ |
| MI0015 | 4027.65 | — | — | — | — | — | — |
| MI0050 | 3048.87 | — | — | — | — | — | — |
| MI0180 | 8170.59 | — | — | — | — | — | — |
| MI0360 | 4360.70 | — | — | — | — | — | — |
| MI0635 | 10639.08 | 5.31 × 10⁻⁵ | 0.014 | 5.49 × 10⁻⁵ | — | ✓ | ✓ |
| MI0750 | 10752.31 | 1.02 × 10⁻⁵ | 1.00 × 10⁻⁴ | 1.12 × 10⁻⁶ | — | ✓ | ✓ |
| MI0900 | 9900.62 | — | — | — | — | — | — |

### Classification Model Development

A classification model using MI0005 in conjunction with MI0750 was created using the biomarker discovery samples as a training set for classification model development and the biomarker validation samples as a test dataset for classification model evaluation. Despite its strong expression correlation with MI0750, marker MI0635 was not used for classification model development, as its discriminatory capability was weaker compared to MI0750.

A target sensitivity of >90% for these models was chosen based on the premise that it is preferable to have a relatively poor specificity so long as the vast majority of patients with cancer are correctly classified. Patients who had undergone a radical prostatectomy prior to sample collection, or were undergoing androgen therapy at the time of sample collection, were excluded from model development.

A classification model meeting these criteria was developed by initially choosing MI0750 intensity cut-off values that gave either a specificity or sensitivity of 90%. Patients demonstrating MI0750 intensities less than the cut-off to give a specificity of 90% (1.0 μAmp) were classified as having PCa, while those with MI0750 intensities greater than the cut-off to give a sensitivity of 90% (7.8 μAmp) were classified as non-PCa.

The MI0005 intensity cut-off (8.5 μAmp) giving a sensitivity of 90% for the remaining samples was then set as a cut-off value above which patients would be classified as having PCa. This procedure yielded the following algorithm:

IF MI0750<1.0 μAmp THEN DIAGNOSIS=PCa

ELSE IF MI0750>7.8 μAmp THEN DIAGNOSIS=Non-PCa OR

ELSE IF MI00005>8.5 μAmp THEN DIAGNOSIS=PCa OR

ELSE DIAGNOSIS=Non-PCa

This model was then applied unaltered to the data generated during biomarker validation. Performance of this model in both data sets is given in Table 26.

TABLE 26
Rate of successful prostate cancer diagnosis in patients who have not had
a radical prostatectomy and who are not undergoing androgen therapy.

| | | Patient Diagnosis | | | | | | |
|---|---|---|---|---|---|---|---|---|
| Sample | Biomarker(s) | Category . . . | | | | Sensitivity | Specificity | Correct Rate |
| Group | Used | TP | FP | TN | FN | (%) | (%) | (%) |
| Discovery | MI0750 only | 28 | 96 | 26 | 3 | 90.32 ± 10.41 | 21.31 ± 7.27 | 35.29 ± 7.57 |
| | MI0750 and | 52 | 78 | 53 | 74 | 87.10 ± 11.80 | 30.33 ± 8.16 | 41.83 ± 7.82 |
| | MI0005 | | | | | | | |
| Validation | MI0750 only | 42 | 74 | 38 | 16 | 72.41 ± 11.50 | 33.93 ± 8.77 | 47.06 ± 7.50 |
| | MI0750 and | 41 | 41 | 47 | 17 | 70.69 ± 11.71 | 53.41 ± 10.42 | 60.27 ± 7.94 |
| | MI0005 | | | | | | | |

TP (True positive), FP (False positive), TN (True negative), FN (False negative).
Error gives the range of the 95% confidence interval around the mean.

### Example 5

### Peak Purification and Identification of MI0750

Purification and identification of biomarker MI0750 was conducted using urine samples known (as observed in previous studies) to have increased levels of MI0750 expression as a source of the marker. Samples were determined to have increased expression of MI0750 based on observed peak intensities during initial biomarker discovery, assay reproducibility and biomarker validation.

### Sample Handling and Sample Preparation Effect

Sample handling, and sample preparation are inevitable steps during protein purification, and may play a key role for the successful purification of a target protein. As such, the effects of sample handling/preparation on urinary protein stability were evaluated on SELDI-TOF MS, using MI0750 as a model protein. The mass spectra of samples before and after treatment were compared in terms of peak intensities and mass profiles (major peaks present in the mass spectrum). It is expected that peak intensities, and mass profiles vary when protein loss, or protein degradation occur.

### 1) Freeze-Thaw Effect

Sample freeze-thaw is frequently used during sample handling for dispensing, shipping, etc. To determine the effect additional freeze-thaw cycles have on protein stability in a urine samples, the mass profiles of a urine sample before and after additional freeze-thaw cycles were compared. A urine sample that has been frozen twice was used as a control.

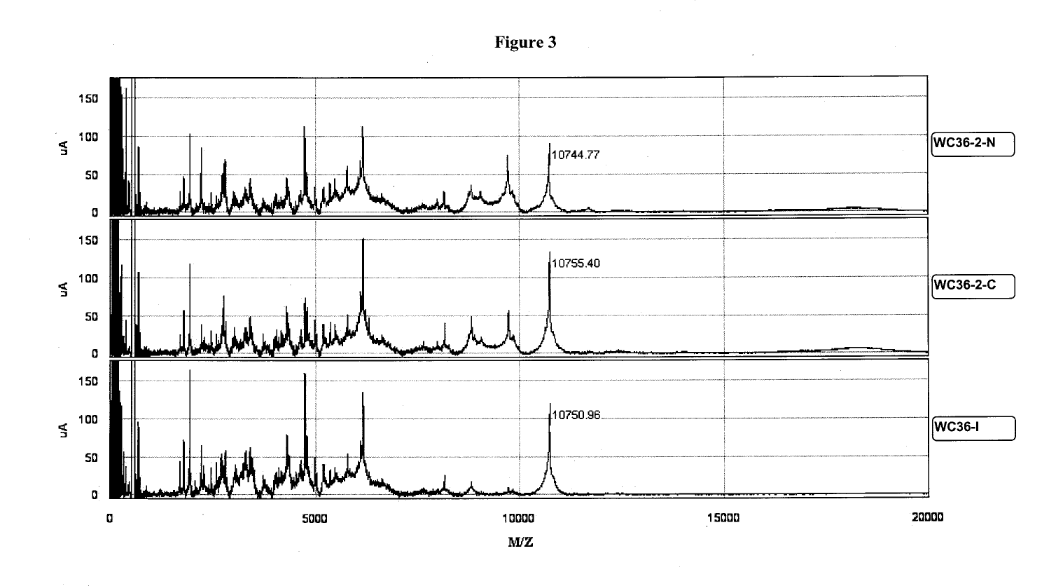

FIG. 3 demonstrates that mass profiles of a urine sample before and after additional freeze-thaw cycles remains unaltered. The peak intensities of MI0750, and most other urinary proteins within the test sample, are insensitive towards additional freeze-thaws indicating stability of most urinary proteins under such conditions. Although most urinary proteins seem unaffected by the addition freeze-thaw cycles, a few proteins with m/z ratios ranging from 7,500˜10,000 did display a decrease in peak intensities following additional freeze-thaw, implying that some urinary proteins may degrade upon additional freeze-thaw cycles.

### 2) Storage Stability (at 4° C., −80° C.)

Fractions collected during the process of protein purification are frequently stored at 4° C. overnight due to hold time or −80° C. for long term storage. It is important to know how the storage conditions affect protein stability. Urine samples were fractionated on Q ceramic HyperD Anionic Exchange filtration plate (Ciphergen Biosystems) according to manufacture's instruction. AEX fraction eluted with buffer at pH 6.0 contains MI0750, and thus used as a model intermediate product. AEX fraction pH 6.0 was divided into 4 equal parts, and subjected to different storage conditions prior to analysis on SELDI TOF MS. Storage conditions used are:

Storage condition A: 4° C. for 1 day

Storage condition B: 4° C. for 15 days

Storage condition C: −80° C. for 1 day

Storage condition D: dried out on Speedvac and stored at 4° C.

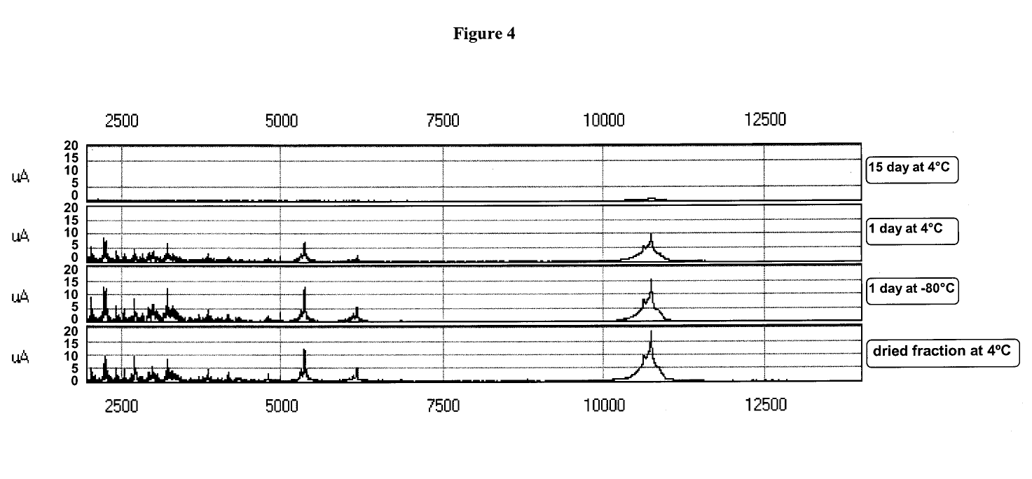

The AEX fraction (pH 6.0) that was stored at different conditions were analyzed on SELDI TOF MS, with results shown in FIG. 4.

It can be seen that the urinary protein in the AEX fraction is stable when stored at −80° C., or dried out and stored at 4° C., as both peak intensities and peak mass profiles are very similar. An AEX fraction can also be stored at 4° C. for 1 day without significant change in both peak intensities, and mass profiles. However, storage at 4° C. for longer period is not recommended, as peak intensities drops significantly, indicating protein degradation has occurred.

### 3) Dialysis

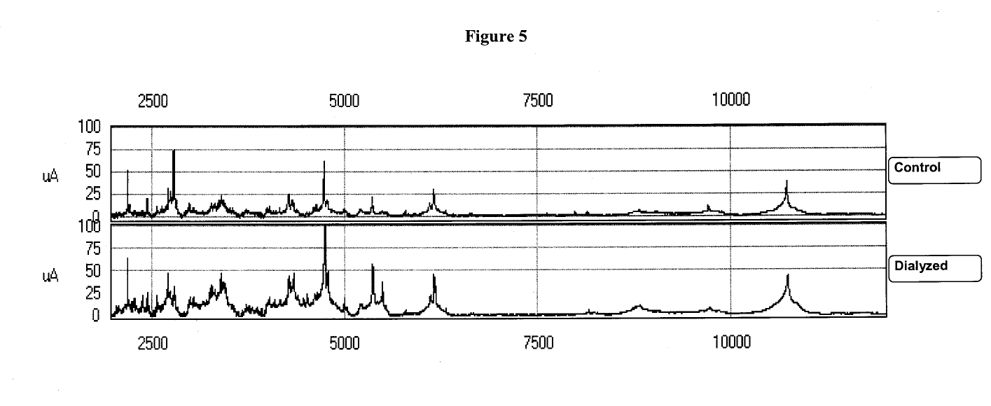

Dialysis is often used to remove salts from urine samples or fractions collected during protein purification. Therefore, the mass profile of a urine sample dialyzed (MWCO: 3500 Da) at 4° C. for 24 hours was compared to that of control (refers to urine sample that is subjected to frozen twice) (FIG. 5).

FIG. 5 demonstrates that protein peak intensities increase upon dialysis of a urine sample against HPLC-grade water and can be explained by the removal of ion suppression from salt. Interestingly, the mass profiles of peaks with an m/z ratio >3,500 are not altered upon dialysis, indicating that those urinary proteins are stable against dialysis. In addition, there is an observed decrease in some peak (m/z <3,500) intensities within the dialyzed sample. This is likely due to a molecular sieving effect.

### 4) Sample Prep for Mass Analysis

A MALDI-TOF mass spectrometer is a very sensitive instrument for protein mass analysis that was used throughout the purification process to monitor the purification progress. Although it has a higher tolerance toward salt than ESI-MS, a salt present in a sample can also lead to a decrease in peak intensity as a result of ion suppression. Therefore, dialysis and concentration was adopted as a standard operating procedure for sample preparation for mass analysis to assure unambiguous detection of target proteins.

### Characterization of MI0750

Anionic exchange chromatography and reverse phase chromatography were used in preliminary studies to assess MI0750 properties—pI and hydrophobicity, respectively. pI value of MI0750 was assessed by using anion exchange chromatography (in the form of a Q Ceramic HyperD® F-Filtration Plate) coupled with a step-wise decreasing elution based on pH. Urinary proteins were eluted from the anionic exchange chromatographic resin when the pH of the elution buffer was close to or below the pI of MI0750.

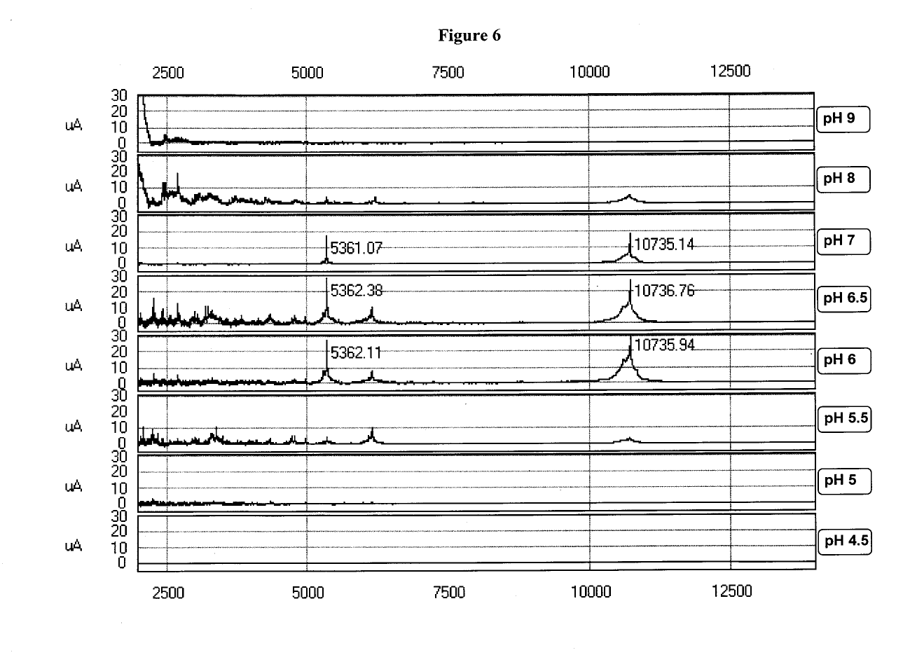

Experimental results indicate that MI0750 begins to elute at pH 8, implying a pI value around 8 (FIG. 6). This indicates that a binding buffer at pH≧9 should be used in the future to ensure complete binding of MI0750 onto anionic exchange resin.

The hydrophobicity of MI0750 was assessed using reverse phase chromatography (Alltech C18 SPE column). The elution behavior of the target was studied by loading pooled AEX fraction (pH 7.0 and pH 6.0) enriched with MI0750 onto C18 column. Proteins were eluted by a step-wise increase in the methanol concentration in 0.01% TFA. Fractions were collected and concentrated on a Speedvac to remove solvent prior to analysis on SELDI-TOF MS. Mass spectra of each fraction are shown in FIG. 6.

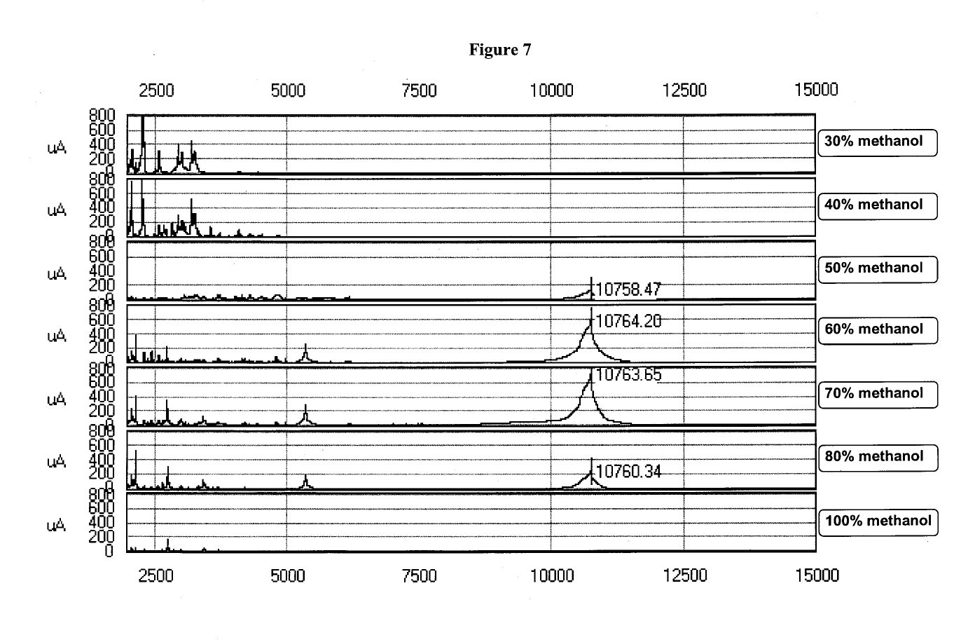

Assessment of mass analysis preformed on SELDI-TOF MS of each fraction demonstrates that 50% methanol is required to elute MI0750 (FIG. 7). This result also implies that MI0750 is a moderately hydrophobic protein, using a less hydrophobic reverse-phase resin will reduce the interaction between protein and resin, and thus improve recovery.

A comparison of mass spectra of MI0750 enriched AEX fraction in FIG. 6 and MI0750 enriched RP fraction in FIG. 7 indicate that reverse-phased based solid-phase extraction could not improve MI0750 purity significantly. Proteins removed during reverse phase fractionation are mostly protein contaminants with a m/z ratio of less than 5000. The protein contaminants can be easily separated from MI0750 using SDS-PAGE separation, which is a commonly used approach to prepare proteins for protein identification via LC/MS/MS or Peptide Mass Fingerprinting (PMF).

### Purification of MI0750

A closer examination of mass spectra of AEX fraction pH 7.0, pH 6.5 and pH 6.0 in FIG. 6, revealed that MI0750 is dominant in those fractions, even with a mass bias of higher molecular weigh proteins when using SELDI-TOF MS. Most protein contaminants present in those fractions have an m/z ratio of less than 6000, and can be easily separated from MI0750 on SDS-PAGE when applied to a 16.5% Tris-Tricine gel.

Based on a preliminary evaluation of MI0750, a purification platform was established for its purification, e.g. AEX fractionation coupled with SDS-PAGE separation on 16.5% Tris-Tricine gel.

A scale-up AEX fractionation was conducted on Q Ceramic HyperD® F-Filtration Plate (Ciphergen Inc.), by keeping the sample loading/resin weight the same as in preliminary study.

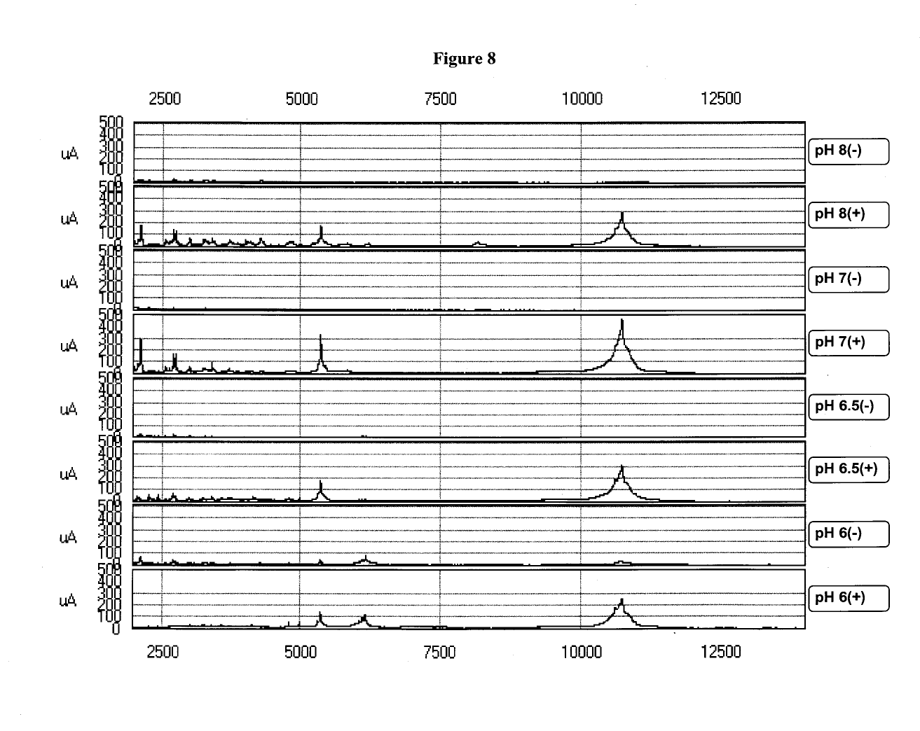

MI0750 was partially purified by using strong anionic exchange (AEX) resin in a 96-well filter plate format (HyperD Q Ceramic filter plate, Ciphergen). AEX fractionation was conducted by applying a pooled urine sample with increased or decreased expression of MI0750, in parallel. Proteins were eluted by a step gradient of decreasing pH from 9 to pH 2. AEX fractions were collected, dialyzed against HPLC grade water for 24 hrs at 4° C., and then concentrated on Speedvac at RT prior to the analysis on SELDI-TOF MS. MI0750 was detected in fractions that were eluted with buffers between pH 7.0 and pH 8.0 using SELDI-TOF MS (PCS-4000, Ciphergen). The results are shown in FIG. 8.

MI00750 enriched fractions were pooled and concentrated by Speedvac at room temperature after dialysis against HPLC-grade water overnight at 4° C. using a MWCO membrane of 3,500 Da. The concentrated AEX fractions containing Ur10759 were retained for identification work.

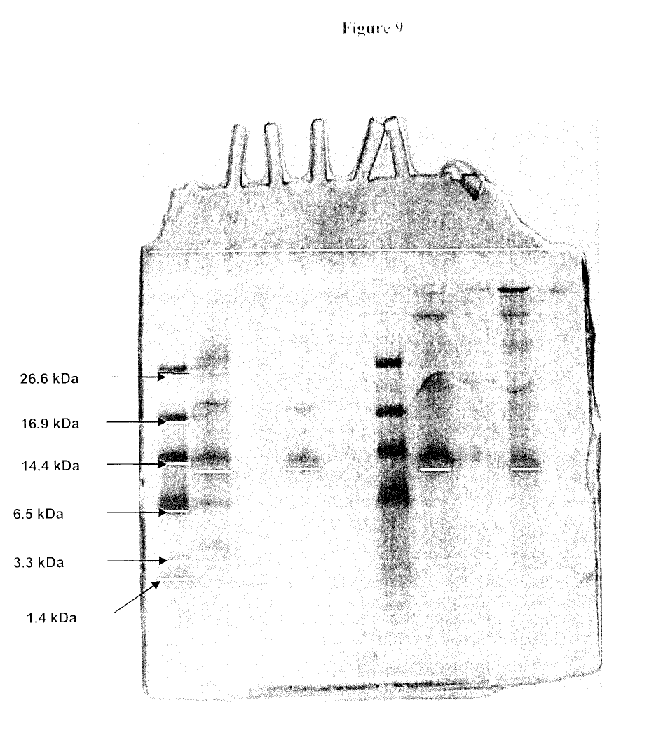

Sample enriched for Ur10759 (˜45 μL) was combined with an equal volume of loading buffer (Tris-Tricine sample loading buffer (Bio-Rad) supplemented with 10 μL 3M DTT per 230 μL of stock sample buffer) and loaded in three lanes on a 16.5% Tris-Tricine polyacrylamide gel (Bio-Rad). Molecular weight standard peptides were loaded in an additional two lanes to allow mass estimation for any proteins visualized. The sample was electrophoresed at ˜50 mAmps in electrophoretic buffer (10-fold dilution of Tris-Tricine running buffer concentrate (Bio-Rad) in water) until the loading dye front reached the bottom of the resolving gel. The gel was carefully removed from the chamber and placed in the bottom of a Pyrex bowl and incubated in ˜150 mL fixative (25% (v/v) isopropanol+10% (v/v) acetic acid in HPLC-grade water) for 1 hour at room temperature with gentle shaking. The fixative was then removed and replaced with ˜150 mL staining solution (0.01% (w/v) Coomassie Blue G250 dye+10% (v/v) acetic acid in HPLC-grade water) and allowed to incubate overnight (˜16 hours) at room temperature with gentle shaking. The staining solution was then removed and replaced with ˜150 mL of destaining solution (10% (v/v) acetic acid in HPLC-grade water) and allowed to incubate at room temperature with gentle shaking. The destaining solution was replaced every two hours for a total of 5 changes over the course of the day. The gel was photographed (FIG. 9) prior to excision of bands corresponding to the approximate mass of Ur10759 with a clean razor. These bands were stored at 4° C. in ˜50 μL sterile HPLC-grade water until shipment to external facilities for sequencing by peptide mass fingerprinting and LC-MSMS.

The external facilities used were the W. M. Keck Foundation Biotechnology Resource Facility (Yale), the UTMB Biomolecular Resource Facility (University of Texas Medical Branch) and the UNC-Duke Michael Hooker Proteomics Facility (UNC-Chapel Hill). Sequence information in the form of report summaries were provided by all facilities.

For protein sequence information, the sequence ID of each fragment was used to search the NCBI public database (http:/www.ncbi.nlm.nih.gov) of deposited protein sequences for a match. The following sequence corresponded to MI0750 (Table 27):

TABLE 27

| | | | | | | | Peptide |
|---|---|---|---|---|---|---|---|
| Sample (Band/ | | | Database | MW | Peptide | MS & MS/MS | sequences |
| Spot on Gel | Protein Name | Species | Accession ID. | (Da) | Count¹ | Score² | (Ion Score)³ |
| 1 | Beta-microseminoprotein | Homo | gi\|1086994 | 2331 | 1 | 122 | 110 |
| | | Sapiens | | | | | |

¹Number of peptides that match the theoretical digest for the primary protein identified.
²Score of the quality of the peptide-mass fingerprint march and the quality of the MS/MS peptide fragment ion matches (if MA/Ma data was generated).
³Score of the quality of MS/MS peptide fragment ion matched only (if MS/MS data was generated). Scores of 20 or greater are significant.

These findings were confirmed by a second and third independent facility, wherein the first facility identified the band as having a peptide sequence similar to that of gorilla beta-microseminoprotein (gi|1094774642). The second facility identified the band as having sequence similarities to five peptide sequences, two of which correspond to beta-microseminoprotein (gi|225159 and gi|1086994). Also, of the peptide sequences identified by the second facility, one corresponded to immunoglobulin binding factor (gi|237563). A search of synonyms for beta-microseminoprotein was performed using ExPASy (Expert Protein Analysis System). Interestingly, beta-microseminoprotein is also known as prostate secretory protein of 94 amino acids (PSP94) and immunoglobulin binding factor. Based on this information, it was determined that the biomarker corresponding to Ur10759 was PSP94, or a derivative or fragment thereof. The amino acid sequence encoding PSP94 is shown in SEQ ID No. 1.

### Example 6

### Peak Purification and Identification

Biomarker purification and identification was conducted using samples known (observed in previous studies) to have increased levels of MI0005 expression as a source of the marker. Samples were determined to have increased expression of MI0005 based on observed peak intensities during initial biomarker discovery, assay reproducibility and biomarker validation.

Anionic exchange chromatography and reverse phase chromatography were used in preliminary studies to assess MI0005 properties such as pI and hydrophobicity. pI value of MI0005 was assessed by using anion exchange chromatography (in the form of a Q Ceramic HyperD® F-Filtration Plate) coupled with step-wise decreasing elution pH. Urinary proteins were eluted from anionic exchange chromatographic resin when elution buffer pH reaches or close to its pI.

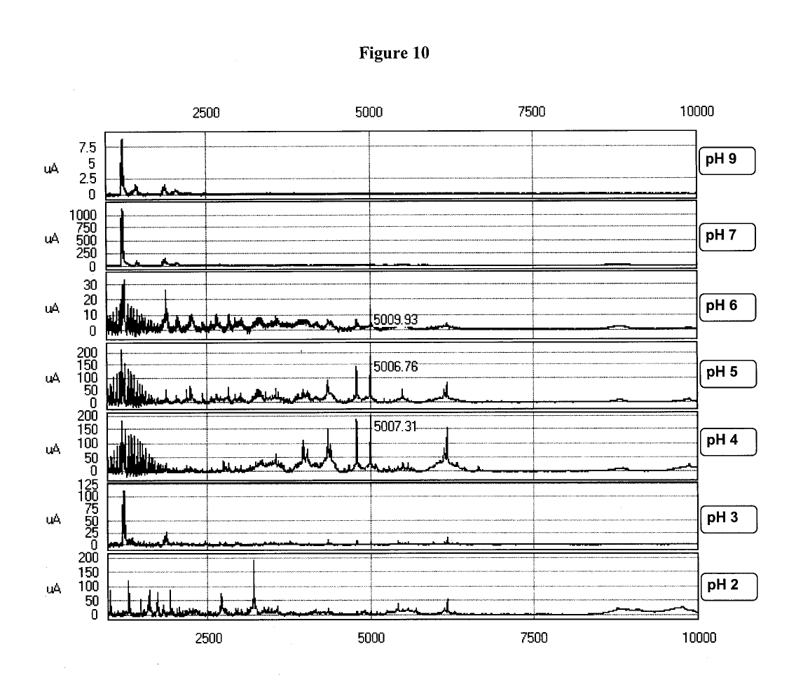

Experimental results indicate that MI0005 begins to elute at pH 6, implying a pI value at around 6 (FIG. 10). This result also suggests a binding buffer at pH 8 should be used to ensure complete binding of MI0005 onto an anionic exchange resin.

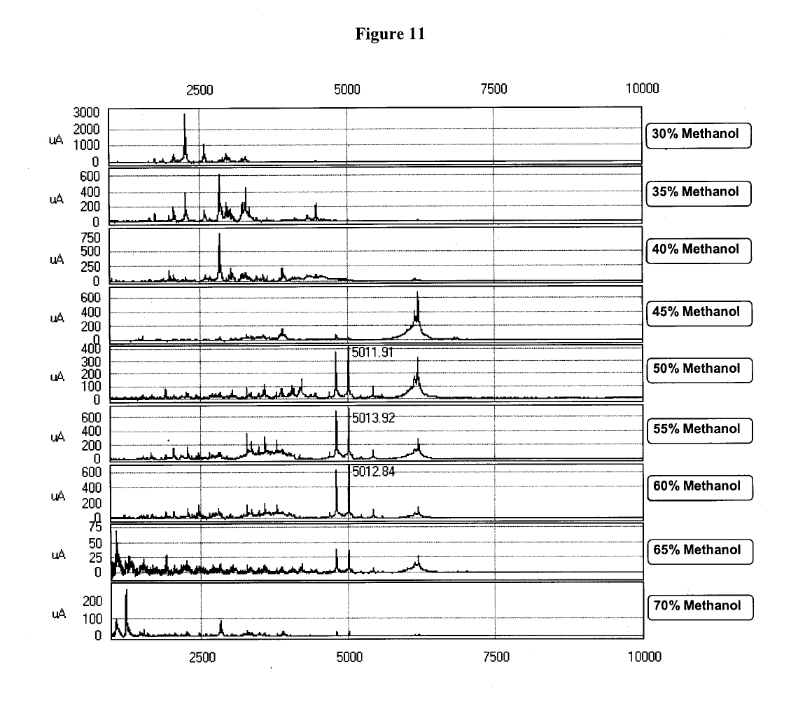

Hydrophobicity of MI0005 was evaluated by using reverse phase chromatography (in the form of a Waters Sep-Pak C18 plus cartridge), where proteins were eluted by a step-wise increasing organic modifier (methanol) concentration in 0.1% TFA. Mass analysis of each fraction on SELDI-TOF MS demonstrates that 50% methanol is required to elute MI0005 (FIG. 11). This result also implies that MI0005 is a moderately hydrophobic protein, using a less hydrophobic reverse-phase resin (C4 or C8) will reduce the interaction between protein and resin, and thus improve the recovery. A comparison of mass spectra of MI0005 enriched AEX fraction in FIG. 1 and MI0005 enriched RP fraction in FIG. 2 indicate that reverse-phased based solid-phase extraction could not improve MI0005 purity significantly. Some of the impurities cannot be separated efficiently from MI0005 on SDS-PAGE either. Therefore, C8-RP-HPLC is used as second-dimension chromatographic separation.

### Purification of MI0005

Based on the preliminary pI and hydrophobicity studies described earlier, a two-dimension chromatographic purification platform was used to purify MI0005, e.g. AEX fractionation (1^{st} dimension) and C8—RP-HPLC purification (2^{nd} dimension).

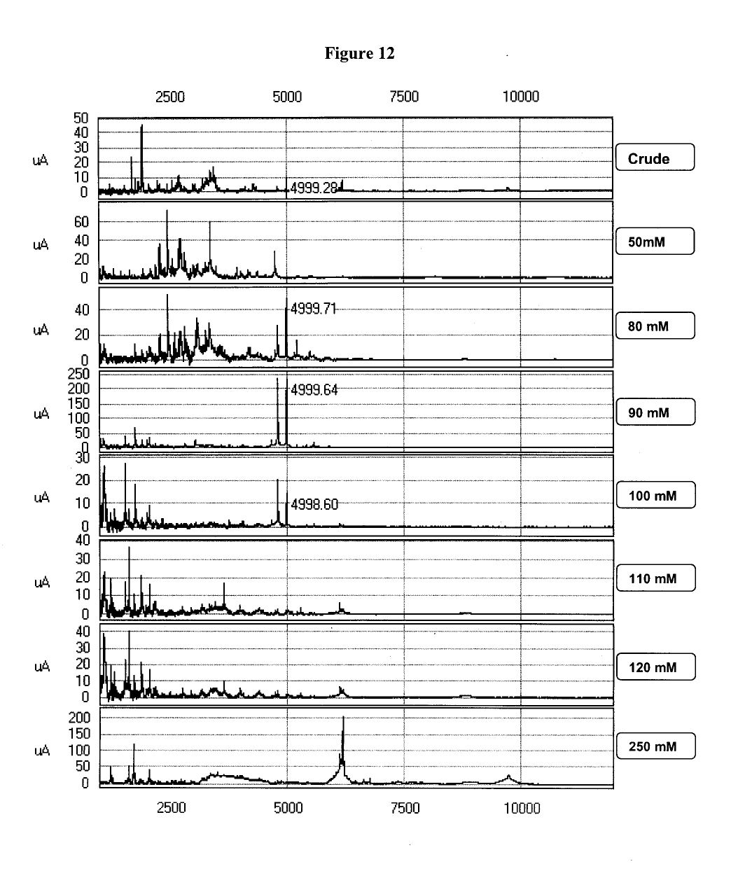

MI005 was partially purified by using strong anionic exchange (AEX) resin in a cartridge format (GE HealthCare Q FF resin, bed volume 5 mL). Proteins were eluted by a step gradient of increasing salt in elution buffer. Ur5004 was detected using SELDI-TOF MS (PCS-4000, Ciphergen) in AEX fractions eluted with 20 mM Tris buffer pH 8.0 containing between 80 and 120 mM NaCl. Each fraction was collected and analyzed on SELDI-MS; results shown in FIG. 12.

FIG. 12 demonstrates that 80 mM NaCl is required to elute MI0005 from the resin. Selective enrichment of MI0005 from a crude urine sample was achieved, particularly in AEX fractions eluted with 90 mM NaCl.

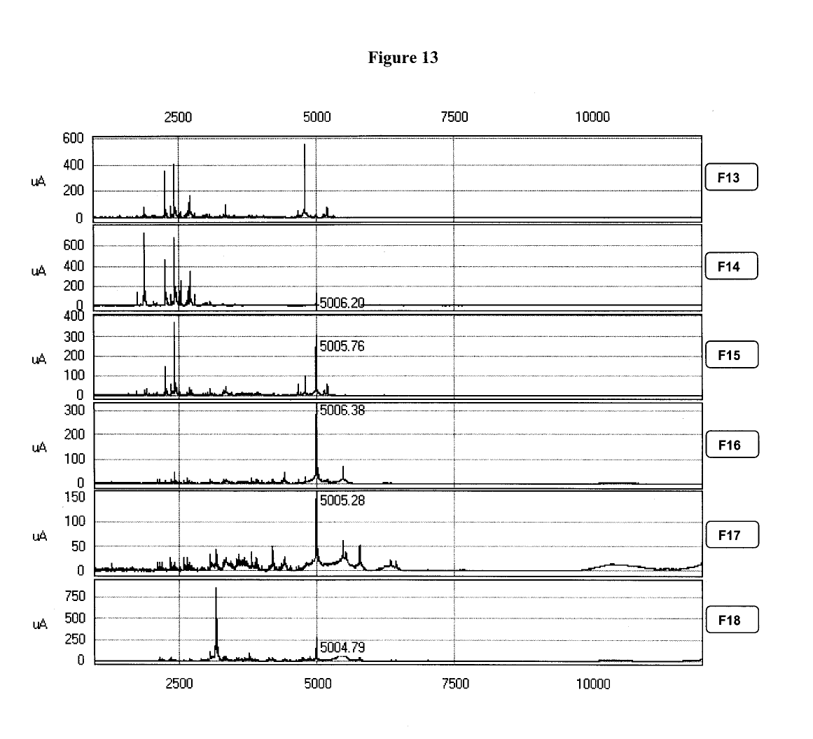

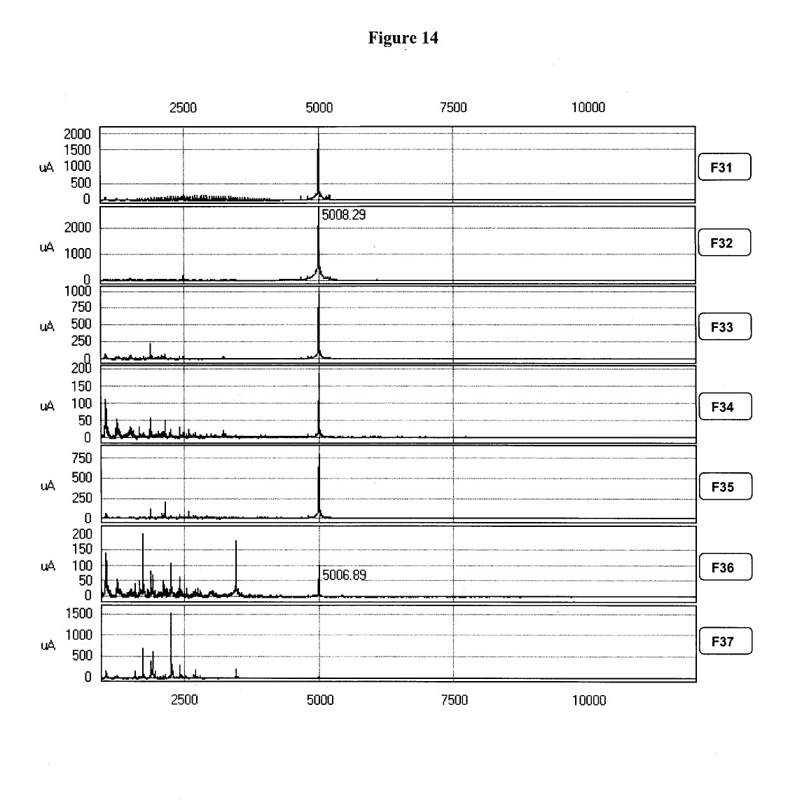

MI005 enriched fractions were pooled, dialyzed against HPLC-grade water overnight at 4° C. using a MWCO membrane of 3,500, and concentrated by Speedvac at room temperature. The AEX fraction enriched with Ur4996 that had been desalted and concentrated was further purified by reverse phase HPLC. Waters 2695 HPLC separation module was used for the delivery of two mobile phases at the same time to allow gradient elution. The HPLC module was in conjunction with an Agilent ZORBAX C8 column (3×150 mm, 3.5 μm particle size). Proteins were eluted by gradually increasing the organic modifier (acetonitrile) in the mobile phase, which was achieved by gradually increasing the proportion of mobile phase B (80% acetonitrile in 0.08% TFA), against mobile phase A (0.1% trifluoroacetic acid). The HPLC run was conducted with a flow rate of 0.4 mL/min and a column temperature of 27° C. The gradient applied was 25% B over 5 minutes, followed by 25% B to 35% B over an additional 30 minutes, followed by and increase to 100% B in another 5 min. The fractions were concentrated by Speedvac at room temperature and the presence of MI005 was assayed by SELDI-TOF MS (PCS-4000, Ciphergen) (FIG. 13). Fractions enriched with MI005 were pooled for final polishing on Waters 2695 HPLC by reverse phase HPLC using the same column and mobile phases. The column temperature and flow rates were increased to 45° C. and 0.6 mL/min, respectively. The gradient applied was 10% B over 5 minutes, 10% B to 20% B over another 5 minutes, and 20% B to 30% B over an additional 50 min., followed by 100% B over 1 min. The fractions were concentrated by Speedvac at room temperature and the presence of Ur5004 was assayed using SELDI-TOF MS (PCS-4000, Ciphergen Biosystems) (FIG. 14). Fractions with fairly pure Ur5004 were retained for identification work.

A sample enriched for Ur5004 (˜10 μL) was sent to the Biomolecular Resource Facility at the University of Texas Medical Branch (UTMB) in Galveston, Tex. for N-terminal amino acid sequence analysis. Using the Applied Biosystems Procise model 494 HT sequencer, the Biomolecular Resource Facility generated the sequence DQESXKGRXTEGFNVDKK (SEQ ID NO: 3) from the sample. SEQ ID No: 3 was then used to search the NCBI protein database (pBLAST) for homologous amino acid sequences. Sequencing cycles that failed to identify an amino acid were assigned a value of X (any amino acid) for this search. The resulting sequences for each peptide tested are given in Table 28. From the BLAST results it is clear that all of the sequences correspond to the N-terminus of the somatomedin B domain of the protein vitronectin. Whereas protein sequences 1 (CAA28659), 2 (CAA26933), 3 (AAH05046) and 4 (NP_{—}000629) share at least 99% amino acid sequence identity, peptide sequence 5 (XP_{—}001146664) shares 93% sequence identity with sequence 1 (CAA28659).

TABLE 28
NCBI public database protein sequence match.

| | | | Database | Size (Amino | Sequence Identity with |
|---|---|---|---|---|---|
| Sequence | Protein Name | Species | Accession ID. | Acids) | Query Sequence (%)¹ |
| 1 | Unnamed Protein | Homo | CAA28659 | 478 | 100 |
| | Product | Sapiens | | | |
| 2 | Unnamed Protein | Homo | CAA26933 | 478 | 100 |
| | Product | Sapiens | | | |
| 3 | Vitronectin | Homo | AAH05046 | 478 | 100 |
| | | Sapiens | | | |
| 4 | Vitronectin Precursor | Homo | NP_000629 | 478 | 100 |
| | | Sapiens | | | |
| 5 | Vitronectin isoform 2 | Pan | XP_001146664 | 503 | 93.75 |
| | | troglodytes | | | |

¹Proportion of query sequence that were identical in the sequence listed, excluding amino acids corresponding to a failed Edman degradation cycle (2 of 18 amino acids).

Since 18 amino acids was not enough to correctly identify this marker, the same UTMB facility continued with the sequencing until they were able to obtain the complete amino acid sequence for Ur5004. The sequence is shown below (“X”s are amino acids that UTMB were not able to identify):

(SEQ ID NO: 4)

DQESXKGRXTEGFNVDKKXQXDELXSYYQSXXTDYTAEXKPQVTRGDVFT
M

SEQ ID NO:4 includes all of the somatomedin B domain of vitronectin, which is amino acids 20-63 of vitronectin.

| | | | |
|---|---|---|---|
| SEQ ID NO: 4 | 1 | DQESXKGRXTEGFNVDKKXQXDELXSYYQSXXTDYTAEXKPQVTRGDVFTM | 51 |
| | | DQES KGR TEGKNVDKK Q DEL SYYQS TDYTAE KPQVTRGDVFTM | |
| SEQ IN NO: 5 | 20 | DQESCKGRCTEGFNVDKKCQCDELCSYYQSCCTDYTAECKPQVTRGDVFTM | 70 |

SEQ ID NO:5 is Ur5004 deduced from SEQ ID NO:4, sequenced by UTMB, and the corresponding sequence from vitronectin (SEQ ID NO:2).

### Confirmation of MI0005 Identification

To confirm peptide sequence identity of MI005, polyclonal antibodies for vitronectin were used to capture partially purified MI0005 using two different biological adsorbent surfaces: PS20 ProteinChip Arrays and Dynabeads.

To confirm the identity of MI005, PS20 ProteinChip arrays and polyclonal antibodies specific for vitronectin were used to capture the target in 1) a partially purified sample and 2) a urine sample known to have elevated expression levels of MI0005. Samples were applied in duplicate to PS20 ProteinChip arrays previously coupled with the polyclonal antibodies. To account for non-specific binding of MI005 to the PS20 ProteinChip arrays, samples were likewise assayed on arrays lacking the capture antibodies. Following in-house standard operating procedures, samples were processed directly on the array surfaces and co-crystallized with α-cyano-4-hydroxycinnamic acid (CHCA). The samples were subsequently assayed using a PCS4000 SELDI-TOF MS over a mass range of 0 to 80,000 m/z.

The spectra generated for each applied sample were normalized for total ion current using the Normalize Spectra functionality of CiphergenExpress™ version 3.0 over a mass range of 1,500 to 80,000 m/z.

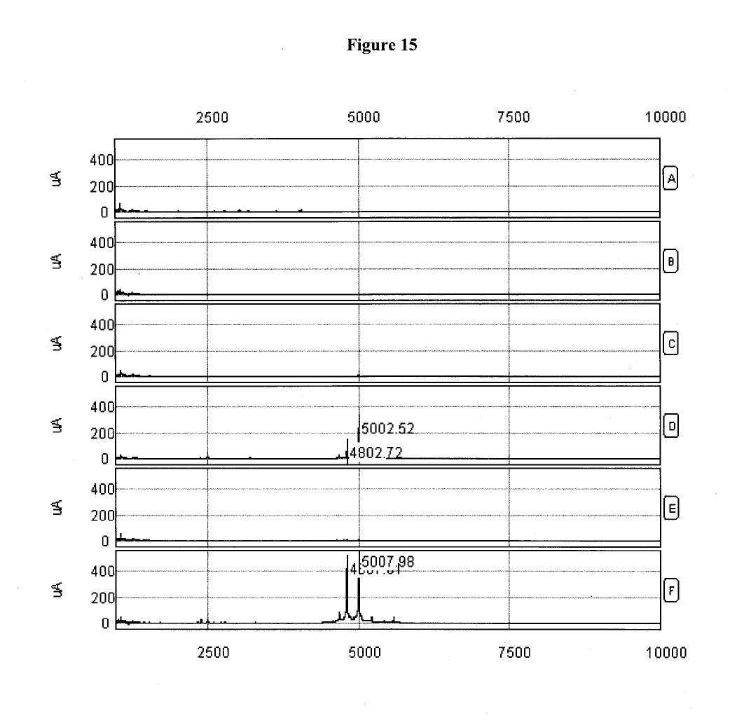

FIG. 15 demonstrates that array surfaces coupled with polyclonal antibodies specific for vitronectin were able to selectively capture a biomolecule at an m/z ratio of 5003 (Spectra D and F; FIG. 15). This m/z ratio corresponds to that of previously detected MI005 and suggests that MI005 is a fragment of vitronectin. In addition, a second predominant target with having an m/z ratio of 4800 was also detected. This is not unexpected as sample analysis during protein purification has demonstrated that MI005 co-elutes with a target characterized by an m/z ratio of 4800. From the data, it appears that this second target (4800 m/z) is also recognized by the polyclonal antibodies specific for vitronectin, suggesting that it may also represent a fragment of the same parent molecule.

In addition, magnetic Dynabeads with activated tosyl groups were utilised as an additional tool for the confirmation of MI005 identity. Polyclonal antibodies specific for vitronectin were coupled to the magnetic beads via surface-bound tosyl groups to generate a ‘capture’ surface. An aliquot of a sample containing the partially purified MI005 was applied to the magnetic beads and allowed to bind overnight. The remaining sample (supernatant) was removed and stored for analysis. Unbound proteins were removed by washing the magnetic beads with PBS for a total of three washed; each wash was retained for analysis. 0.1M Glycine-HCl was used to elute bound protein.

Samples representing the supernatant, each wash step and the eluate were applied to NP20 ProteinChip arrays for analysis. PBS and an aliquot of partially purified MI005 and PBS were applied directly to the NP20 ProteinChips® as negative and positive controls, respectively. Following in-house standard operating procedures, samples were processed directly on the array surfaces and co-crystallized with α-Cyano-4-hydroxycinnamic acid (CHCA). The samples were subsequently assayed using a PCS4000 SELDI-TOF MS over a mass range of 0 to 80,000 m/z.

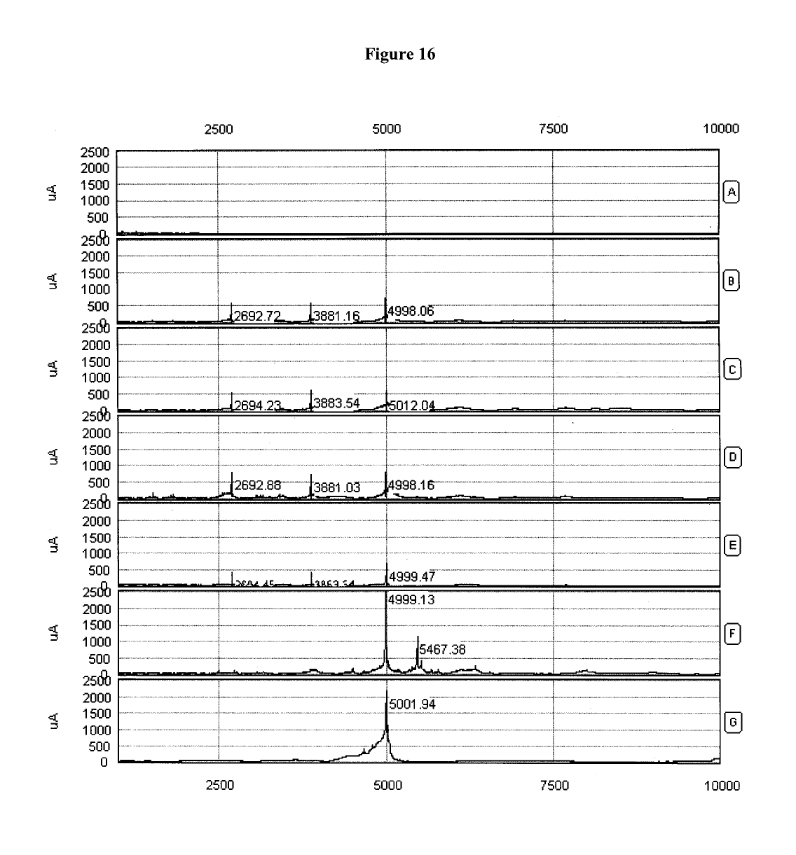

Dynabeads coupled with polyclonal antibodies specific for vitronectin were able to selectively capture a biomolecule at an m/z ratio of 5003 (Spectrum F, FIG. 16). Comparison of spectra generated from samples containing the supernatant following target molecule binding and the positive control reveal that a majority of the target molecule is bound to the antibody coupled to magnetic beads after a 24-hour incubation at RT (spectra B and G, FIG. 16). Washing with PBS removes residual unbound proteins (i.e. peaks 2694 and 3883 m/z in spectra C, D and E; FIG. 16). Elution of bound proteins with 0.1M Glycine-HCl results in the collection of a predominant target with an m/z ratio of 4999. This m/z appears to correspond to that of partially purified MI005 (Spectra F and G, FIG. 16), suggesting that the eluate contains MI005 and that this marker is a fragment of vitronectin. In addition, a second predominant target with having an m/z ratio of 4800 was co-eluted with the target of interest. This is not unexpected as sample analysis during protein purification has shown the MI005 co-elutes with a target characterized by an m/z ratio of 4800. From the data, it appears that this second target (4800 m/z) is also recognized by the polyclonal antibodies specific for vitronectin, suggesting that this target may also be a fragment of the same parent molecule.

### Example 7

### Derivation of Diagnostic Tests Using Ur5004 and Ur10759 Separately and Together

Mass spectral data obtained from patients who were not undergoing androgen therapy (Ad trt-) for prostate cancer were used to derive diagnostic tests to differentiate patients with prostate cancer from those without prostate cancer. An initial training set of data was used to establish tests for Ur5004 and Ur10759 in isolation from one another, using peak intensity cut-offs for each that give sensitivities of close to 90% in a training population of samples that consisted of 31 prostate cancer (Ad trt-) and 122 non-prostate cancer samples. These intensity cut-offs were applied to an independent test population of samples that consisted of 58 prostate cancer and 88 non-prostate cancer samples in order to evaluate the robustness of these tests. The 58 prostate cancer samples include samples from patients undergoing androgen therapy at time of sample collection, as well as those patients that were not given androgen therapy to treat the disease.

To derive a test using both Ur5004 and Ur10759 together, reanalysis of the initial training set of samples was conducted. The distribution of incorrect diagnoses in this sample population using Ur10759 with a peak intensity cut-off to establish a 90% test sensitivity was visualized by assigning a value of 1 to each patient misdiagnosed by the Ur10759-based test and a value of 0 to each patient correctly diagnosed by this test. A moving average of misdiagnosis spanning a window equal to 5% of the patient population was then calculated for each patient after ordering the patients from lowest to highest Ur10759 peak intensity. A central region spanning peak intensities from 1 μAmp to 7.8 μAmp was found to consistently have an error rate in excess of 50%, with patients having Ur10759 intensity less than 1 μAmp predominantly having prostate cancer and those with Ur10759 intensity greater than 7.8 μAmp predominantly not having prostate cancer. The patient samples in the error-prone region of Ur10759 diagnosis were reordered by Ur5004 peak intensity, with an Ur5004 peak intensity cut-off established to ensure 90% test sensitivity in this subpopulation. The cut-off established for Ur5004 in this subpopulation was 8.5 μAmps, above which the patient would be diagnosed as having prostate cancer and below which the patient would be diagnosed as not having prostate cancer. This method of analysis was found to improve sample classification rates over Ur10759 alone or Ur5004 alone by about 20% in the training sample population and between 10 and 15 percent in the test sample population. Significant improvements in test specificity were also observed in all cases. Test sensitivity was not significantly affected by the use of Ur10759 and Ur5004 together over Ur10759 alone in both sample populations, or over Ur5004 alone in the training population.

The following summarises the patient populations used for diagnostic test development using Ur5004 and Ur10759. The training population was used to develop diagnostic tests, which were then evaluated using the test population (Table 29). The training population consists of samples collected from patients not undergoing androgen therapy (31) and those collected from patients that do not have prostate cancer (122). The test population consists of samples collected from patients diagnosed with prostate cancer (58) and those collected form patients that do not have prostate cancer (122). It should be noted that the 58 prostate cancer samples include samples obtained from patients that were not undergoing androgen therapy, as well as patients that were undergoing androgen therapy at time of collection.

TABLE 29

| Sample | Prostate | Non-Prostate |
|---|---|---|
| Population | Cancer | Cancer |
| Training | 31 | 122 |
| Test | 58 | 88 |

The following summarises the diagnostic rules developed based on the above population distributions to differentiate prostate cancer samples from non-prostate cancer samples using SELDI-TOF MS peak data for Ur5004 and Ur10759 (Table 30).

TABLE 30

| | Diagnostic Rule |
|---|---|
| Ur5004 | Ur5004 > 10.13 μAmps THEN Prostate Cancer |
| Alone | ELSE Not Prostate Cancer |
| Ur10759 | Ur10759 < 7.79 μAmps THEN Prostate Cancer |
| Alone | ELSE Not Prostate Cancer |
| Ur10759 + | Ur10759 < 1 μAmp THEN Prostate Cancer |
| Ur5004 | ELSE Ur10759 > 7.8 μAmps THEN Not Prostate Cancer |
| | ELSE Ur5004 > 8.5 μAmps THEN Prostate Cancer |
| | ELSE Not Prostate Cancer |

Below, the correct diagnosis rate in the training and test populations of samples using diagnostic tests based on SELDI-TOF MS peak intensity of Ur5004 and Ur10759, either alone or together is summarised (Table 31). Values are given as the percentage of the total sample population that is correctly diagnosed.

TABLE 31

| | Markers Used By Test . . . | | |
|---|---|---|---|
| Sample | | | Ur5004 + |
| Population | Ur5004 | Ur10759 | Ur10759 |
| Training | 34.6 | 35.3 | 41.8 |
| Test | 52.1 | 54.8 | 60.3 |

The test sensitivity in both the training and test populations of samples using the diagnostic tests based on SELDI-TOF MS peak intensity for Ur5004 and Ur10759, either alone or together are summarised below. Values are given as the percentage of the prostate cancer samples in each population that were correctly diagnosed (Table 32).

TABLE 32

| | Markers Used By Test . . . | | |
|---|---|---|---|
| Sample | | | Ur5004 + |
| Population | Ur5004 | Ur10759 | Ur10759 |
| Training | 87.1 | 90.3 | 87.1 |
| Test | 87.9 | 72.4 | 70.7 |

The test specificity in both the training and test populations of samples using diagnostic tests based on SELDI-TOF MS peak intensity of Ur5004 and Ur10759, either alone or together are summarised below (Table 33). Values are given as the percentage of the non-prostate cancer samples in each population that were correctly diagnosed.

TABLE 33

| | Markers Used By Test . . . | | |
|---|---|---|---|
| Sample | | | Ur5004 + |
| Population | Ur5004 | Ur10759 | Ur10759 |
| Training | 21.3 | 21.3 | 30.3 |
| Test | 28.4 | 43.2 | 53.4 |

### Example 8

### Derivation of Alternate Diagnostic Tests Using Ur5004 and Ur10759 Separately and Together

Mass spectral data obtained from patients who were diagnosed with prostate cancer were used to derive diagnostic tests to differentiate patients with prostate cancer from those without prostate cancer. An initial training set of data was used to establish tests for Ur5004 and Ur10759 in isolation from one another, using peak intensity cut-offs for each that give sensitivities of close to 90% in a training population of retrospectively collected samples that consisted of 68 prostate cancer (including samples obtained from patients undergoing androgen therapy, as well as those that were not being) given androgen therapy of any kind) and 122 non-prostate cancer samples. These intensity cut-offs were applied to an independent test population of retrospectively collected samples that consisted of 99 prostate cancer and 110 non-prostate cancer samples in order to evaluate the robustness of these tests. In addition, identical intensity cut-offs were also applied to a prospectively collected sample population that consisted of samples derived from patients prior to undergoing biopsy of the prostate because of the suspected presence of prostate cancer.

To derive a test using both Ur5004 and Ur10759 together, reanalysis of the initial training set of samples was conducted. The distribution of incorrect diagnoses in this sample population using Ur10759 with a peak intensity cut-off to establish a 90% test sensitivity was visualized by assigning a value of 1 to each patient misdiagnosed by the Ur10759-based test and a value of 0 to each patient correctly diagnosed by this test. A moving average of misdiagnosis spanning a window equal to 5% of the patient population was then calculated for each patient after ordering the patients from lowest to highest Ur10759 peak intensity. Patients having Ur10759 intensity less than 54 μAmp predominantly having prostate cancer and those with Ur10751 intensity greater than 54 μAmp predominantly not having prostate cancer. The patient samples in the error-prone region of Ur10759 diagnosis were reordered by Ur5004 peak intensity, with an Ur5004 peak intensity cut-off established to ensure 90% test sensitivity in this subpopulation. The cut-off established for Ur5004 in this subpopulation was 12.75 μAmps, above which the patient would be diagnosed as having prostate cancer and below which the patient would be diagnosed as not having prostate cancer. This method of analysis was found to improve sample classification rates over Ur10759 alone or Ur5004 alone by about 15-20% in the test sample population and 3% in the pre-biopsy population. Significant improvements in test specificity were also observed in both cases. Test sensitivity was not significantly affected by the use of Ur10759 and Ur5004 together over Ur10759 alone in both sample populations, or over Ur5004 alone in the training population.

The following summarises the patient populations used for alternate diagnostic test development using Ur5004 and Ur10759. The training population was used to develop diagnostic tests, which were then evaluated using the test population (Table 34).

TABLE 34

| Sample | Prostate | |
|---|---|---|
| Population | Cancer | Other |
| Training | 68 | 122 |
| Test | 99 | 110 |
| Pre-Biopsy | 46 | 30 |

The following summarises the diagnostic rules developed to differentiate prostate cancer samples from non-prostate cancer samples using SELDI-TOF MS peak data for Ur5004 and Ur10759 (Table 35).

TABLE 35

| | Diagnostic Rule |
|---|---|
| Ur5004 | Ur5004 > 4.52 μAmps THEN Prostate Cancer |
| Alone | ELSE Not Prostate Cancer |
| Ur10759 | Ur10759 < 54 μAmps THEN Prostate Cancer |
| Alone | ELSE Not Prostate Cancer |
| Ur10759 + | Ur10759 < 5 μAmp THEN Prostate Cancer |
| Ur5004 | ELSE Ur5004 > 12.75 μAmps THEN Prostate Cancer |
| | ELSE Not Prostate Cancer |

Below, the correct diagnosis rate in the training and test populations of samples using diagnostic tests based on SELDI-TOF MS peak intensity of Ur5004 and Ur10759, either alone or together is summarised (Table 36). Values are given as the percentage of the total sample population that is correctly diagnosed.

TABLE 36

| | Markers Used By Test . . . | | |
|---|---|---|---|
| Sample | | | Ur5004 + |
| Population | Ur5004 | Ur10759 | Ur10759 |
| Training | 43.68 | 42.11 | 43.16 |
| Test | 49.76 | 52.63 | 61.72 |
| Pre-Biopsy | 60.53 | 60.53 | 61.84 |

The test sensitivity in both the training and test populations of samples using the diagnostic tests based on SELDI-TOF MS peak intensity for Ur5004 and Ur10759, either alone or together are summarised below. Values are given as the percentage of the prostate cancer samples in each population that were correctly diagnosed (Table 37).

TABLE 37

Markers Used By Test . . .

| Sample | | | Ur5004 + |
|---|---|---|---|
| Population | Ur5004 | Ur10759 | Ur10759 |
| Training | 98.53 | 98.53 | 98.53 |
| Test | 75.76 | 97.98 | 87.88 |
| Pre-Biopsy | 97.82 | 100 | 78.26 |

The test specificity in both the training and test populations of samples using diagnostic tests based on SELDI-TOF MS peak intensity of Ur5004 and Ur10759, either alone or together are summarised below (Table 38). Values are given as the percentage of the non-prostate cancer samples in each population that were correctly diagnosed.

TABLE 38

| | Markers Used By Test . . . | | |
|---|---|---|---|
| Sample | | | Ur5004 + |
| Population | Ur5004 | Ur10759 | Ur10759 |
| Training | 13.11 | 10.66 | 12.3 |
| Test | 26.36 | 11.82 | 38.18 |
| Pre-Biopsy | 3.33 | 0 | 36.67 |

### Example 9

### Evaluation of Diagnostic Tests Using MI0750 or MI0005 Sample Collection

Patients were recruited through a series of urological clinics and hospitals. Spot urine samples were collected without a preceding digital rectal exam no more than ten days prior to the patient undergoing a previously scheduled biopsy of the prostate for suspicion of prostate cancer. Patient diagnosis was based upon the pathology report for this previously scheduled prostate biopsy. Patients qualified for this study if they were male, at least 50 years of age, had been previously scheduled for a biopsy of the prostate for suspicion of prostate cancer, could provide urine samples for analysis and serum samples for total PSA testing, had complete medical history information available, had tumor stage and grade information available if diagnosed with prostate cancer as a result of this biopsy, did not report a previous incidence of prostate cancer, did not report a previous incidence of non-prostate cancer except basal skin cell carcinoma in the previous two years, and were not taking any prescribed pre-operative medications or investigational agents at the time of sample collection. A total of 212 patients were recruited and provided satisfactory samples. These patients were subsequently divided into three groups for data analysis: Training (99 patients—50 PCa/PIN, 39 non-PCa/PIN), First Testing (45 patients—19 PCa/PIN, 21 non-PCa/PIN and 5 with unknown diagnosis) and Second Testing (68 patients—36 PCa/PIN, 32 non-PCa/PIN). Patients in the Training group were those who were recruited prior to 1 Feb. 2007 and who had biopsy information available as of 1 Feb. 2007. Those in the First Testing group were those who were recruited prior to 11 Feb. 2007 but did not have biopsy information available as of 1 Feb. 2007. Those in the Second Testing group were those who were recruited for the study after 11 Feb. 2007. Five patients with unknown diagnosis were excluded from classification model development (Table 39).

TABLE 39
Patient distribution across sample sets.

| | PCa/PIN¹ | Non-PCa/PIN² | No Diagnosis³ | Total |
|---|---|---|---|---|
| Training | 50 | 39 | 0 | 89 |
| First | 21 | 19 | 5 | 45 |
| Testing | | | | |
| Second | 36 | 32 | 0 | 68 |
| Testing | | | | |
| Total | 107 | 90 | 5 | 202 |

¹PCa/PIN is a diagnosis of either prostate cancer or prostatic intraepithelial neoplasia.
²Non-PCa/PIN is a diagnosis of neither prostate cancer nor prostatic intraepithelial neoplasia.
³No Diagnosis is where a diagnosis is unavailable.

### Sample Preparation

Prior to application of urine samples to a ProteinChip® array (Bio-Rad Laboratories, Hercules, Calif.), samples were removed from −80° C. and thawed on ice. Samples were then centrifuged for 10 min at 4° C. to remove precipitate matter prior to use. Two μL of untreated urine or positive/negative control sample were applied to each spot on each array according to random assignment. Samples were allowed to air-dry on the array surface at room temperature. Whereas a pooled sample (250 μl) of 10 randomly selected urine samples (at 25 μl each) served as a positive control, PBS was used as a negative control on each array. Likewise patient urine samples were randomly assigned across all arrays used and assayed in duplicate. The distribution of the spots used on particular arrays for a given sample or control were recorded to ease sample application.

Each spot was then washed with 5 μL HPLC-grade water for up to one minute, with wash water being removed by capillary action into a lint-free tissue (KimWipes®). After washing, two aliquots of 0.6 μL 20% (w/v) CHCA suspended in 50% (v/v) acetonitrile, 0.5% (v/v) trifluoroacetic acid were applied to each spot, allowing sufficient time for the spots to dry between applications.

### ProteinChip Array Analysis

Prior to reading of the arrays, the ProteinChip® (Bio-Rad Laboratories) reader was calibrated for detection of biomarkers within a lower mass range using Hirudin BKHV (7,034 Da), myoglobin (16,951 Da) and carbonic anhydrase (29,023 Da). ProteinChips® that had EAM (20% (w/v) CHCA in 50% (v/v) acetonitrile, 0.5% (v/v) trifluoroacetic acid) applied were assayed for potential biomarkers in the lower mass range using a PCS4000 SELDI-TOF mass spectrometer withand a laser intensity of 2,000 nJ over a mass range of 0 to 30,000 m/z. A mass focus of 10,000 m/z was used, as was a matrix attenuation value of 500 m/z.

To analyze for biomarkers within the upper mass range, the ProteinChip® reader was re-calibrated using the calibrants carbonic anhydrase (29,023 Da) and enolase (46,671 Da). Once the ProteinChip® reader was re-calibrated, the ProteinChips® were assayed for potential biomarkers within the higher mass range. A laser intensity of 3,000 nJ over a mass range of 30,000-80,000 m/z was used for the detection of bound biomolecules with a mass focus of 40,000 m/z, the matrix attenuation value was set to 5,000 m/z.

### Peak Detection and Data Analysis

All mass spectra generated were normalized for total ion current with the CiphergenExpress™ software package. Positive and negative control spectra were excluded from subsequent data analysis. The mean normalization factor for all remaining spectra (PCa, BPH and control/healthy spectra) was calculated. Spectra that displayed an excessive normalization factor in the mass range of 1500 to 30,000 m/z more than two standard deviations from the mean were excluded from data analysis. No single sample had more than one spectrum excluded from analysis in this manner.

Once the arrays were assayed and spectrum were generated for each spot on the ProteinChips®, entity difference maps (EDMs) were derived using CiphergenExpress™ software. For the lower mass range, automatic peak detection between 1,500 and 30,000 m/z was conducted, using first pass S/N and valley depth cut-offs of 3.0, second pass S/N and valley depth cut-offs of 2.0, and assignment of peaks where necessary to ensure that every peak was represented exactly once in each spectrum. Peaks in different spectra were considered to belong to the same cluster if they fell within 0.3% of their observed m/z. Peaks were only retained for further statistical analysis if they were independently detected (that is, were not estimated) in at least 10% of all spectra.

### Classification Model Development

The assayed training set samples were used to generate a series of classification models based on the use of MI0750, MI0005 and total PSA. These models were developed by first identifying an MI0750 cutoff yielding a test specificity of as close to 90% as possible without being less than 90%. Those samples with a lower MI0750 intensity than this cutoff were predominantly derived from patients with PCa/PIN, and were therefore classified by this parameter as such. Of the remaining patients in the Training set, those reporting a total PSA score of greater than 10 ng/mL were observed to be predominantly PCa/PIN, and were therefore classified by this second parameter as such. Of the remaining patients in the Training set, an MI0005 cutoff yielding a test sensitivity of as close to 90% as possible without being less than 90% was selected. Those samples with a lower MI0005 intensity than this cutoff were predominantly derived from patients with PCa/PIN, and were therefore classified by this parameter as such. When combined, these parameters yield the classification model:

IF MI0750<0.4 μAmps OR

IF PSA>10 ng/mL OR

IF MI0005<4.8 μAmps

THEN DIAGNOSIS=PCa/PIN

ELSE DIAGNOSIS=Non-PCa/PIN

Alternatively, this model can be expressed as:

IF MI0750≧0.4 μAmps AND

IF PSA≦10 ng/mL AND

IF MI0005≧4.8 μAmps

THEN DIAGNOSIS=Non-PCa/PIN

ELSE DIAGNOSIS=PCa/PIN

These models were tested on the First Testing sample set and the Second Testing sample set independently. In addition, the overall performance of each model was evaluated on the entire population of 202 samples. Sensitivity and specificity values were calculated using the formulae: [sensitivity=100*(# True Positives)/(# True Positives+# False Negatives)] and [sensitivity=100*(# True Negatives)/(# True Negatives+# False Positives)]. The standard error of the proportion (Sp) for the sensitivity was calculated as 100*[(Sensitivity/100)*(1−Sensitivity/100)/(# True Positives+# False Negatives)]^{0.5}. Similarly, the standard error of the proportion (Sp) for the specificity was calculated as 100*[(Specificity/100)*(1−Specificity/100)/(# True Negatives+# False Positives)]^{0.5}. The sensitivities and specificities of this model as applied to these sample sets are outlined in Table 40.

TABLE 40
Diagnostic performance of a classification model to distinguish patients with
prostate cancer/prostatic intraepithelial neoplasia from all other patients.

| | | Diagnostic Performance | | | | | |
|---|---|---|---|---|---|---|---|
| Classification Model | Sample Set | TP¹ | FN² | TN³ | FP⁴ | Sensitivity⁵ | Specificity⁶ |
| MI0750 < 0.4 μAmps | Training | 48 | 3 | 6 | 25 | 94.1 ± 3.3 | 19.4 ± 7.1 |
| OR MI0005 < 4.8 μAmps | First Testing | 19 | 0 | 3 | 18 | 100 ± 15.8 | 14.3 ± 7.6 |
| OR PSA > 10 ng/mL | Second Testing | 35 | 1 | 6 | 26 | 97.2 ± 8.3 | 18.8 ± 6.9 |
| Then PCa Else Other | All Samples | 102 | 4 | 15 | 69 | 96.2 ± 2.83 | 17.9 ± 4.2 |

¹True Positive;
²False Positive;
³True Negative;
⁴False Negative;
⁵sensitivity ± standard error;
⁶specificity ± standard error.

### Example 10

### Evaluation of Prognostic Performance

### Sample Collection

Patients were recruited through a series of urological clinics and hospitals. Twenty-four hour urine samples were collected no more than ten days prior to the patient undergoing a previously scheduled biopsy of the prostate for suspicion of prostate cancer. Samples were stored at room temperature during collection. Patient diagnosis was based upon the pathology report for this previously scheduled prostate biopsy. Patients qualified for this study if they were male, at least 50 years of age, had been previously scheduled for a biopsy of the prostate for suspicion of prostate cancer, could provide urine samples for analysis and serum samples for total PSA testing, had complete medical history information available, had tumor stage and grade information available if diagnosed with prostate cancer as a result of this biopsy, did not report a previous incidence of prostate cancer, did not report a previous incidence of non-prostate cancer except basal skin cell carcinoma in the previous two years, and were not taking any prescribed pre-operative medications or investigational agents at the time of sample collection. It is noted that the disease stage of each patient for a given sample was known prior to sample collection.

A total of 144 patients were recruited and provided complete 24-hour urine samples (that is, no missed evacuations were reported). These patients were subsequently divided into three groups for data analysis: Training (57 patients—14 aggressive PCa (Gleason score of ≧7), 15 non-aggressive PCa (Gleason score of ≦6), and 28 non-PCa), First Testing (36 patients—9 aggressive PCa (Gleason score of ≧7), 6 non-aggressive PCa (Gleason score of ≦6), and 21 non-PCa), and Second Testing (51 patients—15 aggressive PCa (Gleason score of ≧7), 11 non-aggressive PCa (Gleason score of ≦6), and 25 non-PCa). Patients in the Training group were those who were recruited prior to 1 Feb. 2007 and who had biopsy information available as of 1 Feb. 2007. Those in the First Testing group were those who were recruited prior to 11 Feb. 2007 but did not have biopsy information available as of 1 Feb. 2007. Those in the Second Testing group were those who were recruited for the study after 11 Feb. 2007 (Table 41).

TABLE 41
Patient distribution across sample sets.

| | Aggressive | Non-Aggressive | | |
|---|---|---|---|---|
| | PCa¹ | PCa² | Non-PCa³ | Total |
| Training | 14 | 15 | 28 | 57 |
| First | 9 | 6 | 21 | 36 |
| Testing | | | | |
| Second | 15 | 11 | 25 | 51 |
| Testing | | | | |
| Total | 38 | 32 | 74 | 144 |

¹Aggressive PCa is a diagnosis of prostate cancer with Gleason score of 7 or greater.
²Non-aggressive PCa is a diagnosis of prostate cancer with Gleason score of 6 or less.
³Non-PCa is confirmed as not prostate cancer.

### Sample Preparation

Prior to application to the ProteinChips®, urine samples were removed from −80° C. and allowed to thaw on ice. Samples were then centrifuged for 10 min. at 4° C. to remove precipitate matter prior to use. Two μL of untreated urine or positive/negative control sample was applied to each spot on each array according to random assignment. Samples were allowed to air-dry on the array surface at room temperature. Whereas a pooled sample (250 μl) of 10 randomly selected urine samples (at 25 μl each) served as a positive control, PBS was used as a negative control on each array. Likewise, patient urine samples were likewise randomly assigned across all arrays used and assayed in duplicate. The distribution of the spots used on particular arrays for a given sample or control were recorded to ease sample application.

Each spot was then washed with 5 μL HPLC-grade water for up to one minute, with wash water being removed by capillary action into a lint-free tissue (KimWipes®). After washing two aliquots of 0.6 μL 20% (w/v) CHCA suspended in 50% (v/v) acetonitrile, 0.5% (v/v) trifluoroacetic acid were applied to each spot, allowing sufficient time for the spots to dry between applications.

### ProteinChip Array Analysis

Prior to reading of the arrays, the ProteinChip® reader was calibrated for detection of biomarkers within a lower mass range using Hirudin BKHV (7,034 Da), myoglobin (16,951 Da) and carbonic anhydrase (29,023 Da). ProteinChips® which had EAM (20% (w/v) CHCA in 50% (v/v) acetonitrile, 0.5% (v/v) trifluoroacetic acid) applied were assayed for potential biomarkers in the lower mass range using a PCS4000 SELDI-TOF mass spectrometer and a laser intensity of 2,000 nJ over a mass range of 0 to 30,000 m/z. A mass focus of 10,000 m/z was used, as was a matrix attenuation value of 500 m/z.

To analyse for biomarkers within the upper mass range, the ProteinChips® reader was re-calibrated using the calibrants carbonic anhydrase (29,023 Da) and enolase (46,671 Da). Once the ProteinChip® reader was re-calibrated, the ProteinChips® were assayed for potential biomarkers within the higher mass range. A laser intensity of 3,000 nJ over a mass range of 30,000-80,000 m/z was used for the detection of bound biomolecules with a mass focus of 40,000 m/z, the matrix attenuation value was set to 5,000 m/z.

### Peak Detection and Data Analysis

All mass spectra generated within each above-mentioned mass range were normalized for total ion current with the CiphergenExpress™ software package. Positive and negative control spectra were excluded from subsequent data analysis. The mean normalization factor for all remaining spectra (PCa, BPH and control/healthy spectra) was calculated. Spectra that displayed an excessive normalization factor in the mass range of 1500 to 30,000 m/z more than two standard deviations from the mean were excluded from data analysis. No single sample had more than one spectrum excluded from analysis in this manner. No single sample had more than one spectrum excluded from analysis in this manner.

Once the arrays were assayed and spectra were generated for each spot on the ProteinChips®, entity difference maps (EDMs) were derived using CiphergenExpress™ software. For the lower mass range, automatic peak detection between 1,500 and 30,000 m/z was conducted, using first pass S/N and valley depth cut-offs of 3.0, second pass S/N and valley depth cut-offs of 2.0, and assignment of peaks where necessary to ensure that every peak was represented exactly once in each spectrum. Peaks in different spectra were considered to belong to the same cluster if they fell within 0.3% of their observed m/z. Peaks were only retained for further statistical analysis if they were independently detected (that is, were not estimated) in at least 10% of all spectra. Analysis of the remaining spectra by Mann-Whitney and Kruskal-Wallis statistics indicated several potentially useful markers in this mass range, which can differentiate BPH from PCa or ctrl from PCa.

Peak intensity values for MI0750 and MI0005 were then multiplied by the number of mL of urine collected in the 24 hour collection sample. These “24 hour intensity” values (measured in μAmp·mL) were then used for classification model development.

### Classification Model Development

The assayed training set samples were used to generate a series of classification models based on the use of MI0750, MI0005 and total PSA. Manual review of these 57 samples indicated that a predominance of patients with aggressive PCa had low MI0750 24 hour intensity values (typically less than or equal to 1700 μAmp·mL MI0750 24 hour intensity) and high MI0005 24 hour intensity values (typically greater than 1500 μAmp·mL MI0005 24 hour intensity). In addition to these, a series of arbitrarily selected but progressively less selective MI0750 24 hour intensity values and MI0005 24 hour intensity values were also chosen to create several classification models for evaluation. Patients with MI0750 24 hour intensity less than or equal to the given cutoff, or with MI0005 24 intensity greater than or equal to the corresponding cutoff, were classified as having aggressive PCa. Total PSA was then applied to patients not classified as aggressive PCa by either MI0750 24 hour intensity or MI0005 24 hour intensity, using a cutoff value of 4.0 ng/mL, above or equal to which patients were classified as having aggressive PCa. The classification models generated in this manner had the format of:

IF MI0750 24 hour intensity≦a μAmp·mL OR

IF MI0005 24 hour intensity≧b μAmp·mL OR

IF PSA≧4 ng/mL

THEN DIAGNOSIS=Aggressive Cancer

ELSE DIAGNOSIS=Non-PCa/Non-Aggressive Cancer

wherein the variable a is one of the set of values: 1700 μAmp·mL, 2000 μAmp·mL, 2500 μAmp·mL, 3000 μAmp·mL or 3500 μAmp·mL; and the variable b is one of the set of values: 1500 μAmp·mL, 2000 μAmp·mL, 2500 μAmp·mL, 3000 μAmp·mL or 2500 μAmp·mL.
Alternatively, this model can be expressed as:

IF MI0750 24 hour intensity>a μAmp·mL AND

IF MI0005 24 hour intensity<b μAmp·mL AND

IF PSA<4 ng/mL

THEN DIAGNOSIS=Non-PCa/Non-Aggressive Cancer Aggressive Cancer

ELSE DIAGNOSIS=Aggressive Cancer

TABLE 42
Summary of the classification models evaluated.

| | | MI0005> . . . | | | | |
|---|---|---|---|---|---|---|
| | | 3500 | 1500 | 2000 | 2500 | 3000 |
| MI0750< . . . | 1700 | 1 | 2 | 3 | 4 | 5 |
| | 2000 | 6 | 7 | 8 | 9 | 10 |
| | 2500 | 11 | 12 | 13 | 14 | 15 |
| | 3000 | 16 | 17 | 18 | 19 | 20 |
| | 3500 | 21 | 22 | 23 | 24 | 25 |

In Table 42, the classification models for staging are in the format IF PSA>4.0 AND MI0005>x AND MI0750<y THEN DIAGNOSIS=“Aggressive PCa”; ELSE “Non-PCa/Non-Aggressive PCa”. Algorithms were numbered to make recording data more clear, the number for each algorithm being in the field corresponding to the appropriate MI0005 and MI0750 cutoffs (measured in μAmp·mL).

These models were tested on the First Testing sample set and the Second Testing sample set independently, performance being assessed in comparison of aggressive PCa patients vs. non-aggressive PCa pooled together with non-PCa patients. In addition, the overall performance of each model was evaluated on the entire population of 144 samples. Sensitivity and specificity values were calculated using the formulae: [sensitivity=100*(# True Positives)/(# True Positives+# False Negatives)] and [sensitivity=100*(# True Negatives)/(# True Negatives+# False Positives)]. The standard error of the proportion (Sp) for the sensitivity was calculated as 100*[(Sensitivity/100)*(1−Sensitivity/100)/(# True Positives+# False Negatives)]^{0.5}. Similarly, the standard error of the proportion (Sp) for the specificity was calculated as 100*[(Specificity/100)*(1−Specificity/100)/(# True Negatives+# False Positives)]^{0.5}. The sensitivities and specificities of this model as applied to these sample sets are outlined in Table 44. The five best performing classification models, as measured by the average of the sum of their sensitivity and specificity for each dataset tested, were then reassessed by comparing aggressive PCa patients vs. non-aggressive PCa patients only (Table 45).

TABLE 43
Summary of algorithm performance on the dataset
used for training the classification algorithms.

| Model | Dataset used for evaluation . . . | | | |
|---|---|---|---|---|
| Used | Training¹ | First Testing | Second Testing | All Datasets |
| 1 | 71.4/88.4 | 33.3/66.7 | 33.3/77.8 | 47.4/79.2 |
| 2 | 85.7/65.1 | 66.7/59.3 | 60/63.9 | 71.1/63.2 |
| 3 | 78.6/69.8 | 66.7/59.3 | 60/66.7 | 68.4/66 |
| 4 | 78.6/74.4 | 66.7/63 | 33.3/66.7 | 57.9/68.9 |
| 5 | 71.4/81.4 | 55.6/66.7 | 33.3/75 | 52.6/75.5 |
| 6 | 71.4/81.4 | 33.3/44.4 | 46.7/72.2 | 52.6/68.9 |
| 7 | 85.7/58.1 | 66.7/55.6 | 73.3/55.6 | 76.3/56.6 |
| 8 | 78.6/62.8 | 66.7/59.3 | 73.3/58.3 | 73.7/60.4 |
| 9 | 78.6/67.4 | 66.7/63 | 46.7/58.3 | 63.2/63.2 |
| 10 | 71.4/74.4 | 55.6/66.7 | 60/66.7 | 63.2/69.8 |
| 11 | 71.4/81.4 | 44.4/59.3 | 60/72.2 | 60.5/72.6 |
| 12 | 92.9/55.8 | 77.8/44.4 | 86.7/52.8 | 86.8/51.9 |
| 13 | 78.6/60.5 | 77.8/48.1 | 86.7/55.6 | 81.6/55.7 |
| 14 | 78.6/65.1 | 77.8/55.6 | 60/58.3 | 71.1/60.4 |
| 15 | 71.4/72.1 | 66.7/59.3 | 60/69.4 | 65.8/67.9 |
| 16 | 71.4/74.4 | 66.7/59.3 | 60/72.2 | 65.8/69.8 |
| 17 | 92.9/46.5 | 100/40.7 | 86.7/52.8 | 92.1/47.2 |
| 18 | 78.6/53.5 | 100/48.1 | 86.7/55.6 | 86.8/52.8 |
| 19 | 78.6/58.1 | 100/55.6 | 60/58.3 | 76.3/57.5 |
| 20 | 71.4/65.1 | 88.9/59.3 | 60/66.7 | 71.1/64.2 |
| 21 | 71.4/74.4 | 66.7/55.6 | 60/69.4 | 65.8/67.9 |
| 22 | 92.9/44.2 | 100/33.3 | 86.7/50 | 92.1/43.4 |
| 23 | 78.6/51.2 | 100/40.7 | 86.7/52.8 | 86.8/49.1 |
| 24 | 78.6/55.8 | 100/48.1 | 60/55.6 | 76.3/53.8 |
| 25 | 71.4/65.1 | 88.9/55.6 | 60/66.7 | 71.1/63.2 |

All values are percent sensitivity/percent specificity. The composition of the different algorithms are disclosed in Table 41.

TABLE 44
Sensitivities and specificities of the five algorithms with
the highest average combined sensitivity and specificity
across the training, test and evaluation data sets.

| Model | Dataset used for evaluation . . . | | | |
|---|---|---|---|---|
| Used | Training | First Testing | Second Testing | All Datasets |
| 12 | 100/33.33 | 43.75/66.67 | 86.67/54.55 | 75.56/46.88 |
| 17 | 100/20 | 100/50 | 86.67/54.55 | 94.74/37.50 |
| 18 | 85.71/26.67 | 100/66.67 | 86.67/54.55 | 89.47/43.75 |
| 19 | 85.71/40 | 100/66.67 | 60/63.64 | 78.95/53.13 |
| 20 | 78.57/46.67 | 88.89/66.67 | 60/81.82 | 73.68/62.50 |
| PSA Alone | 92.86/13.33 | 100/33.33 | 86.67/9.09 | 92.11/15.63 |

All values are percent sensitivity/percent specificity. The composition of the different algorithms are disclosed in Table 41.

### Example 11

### ELISA Test Development

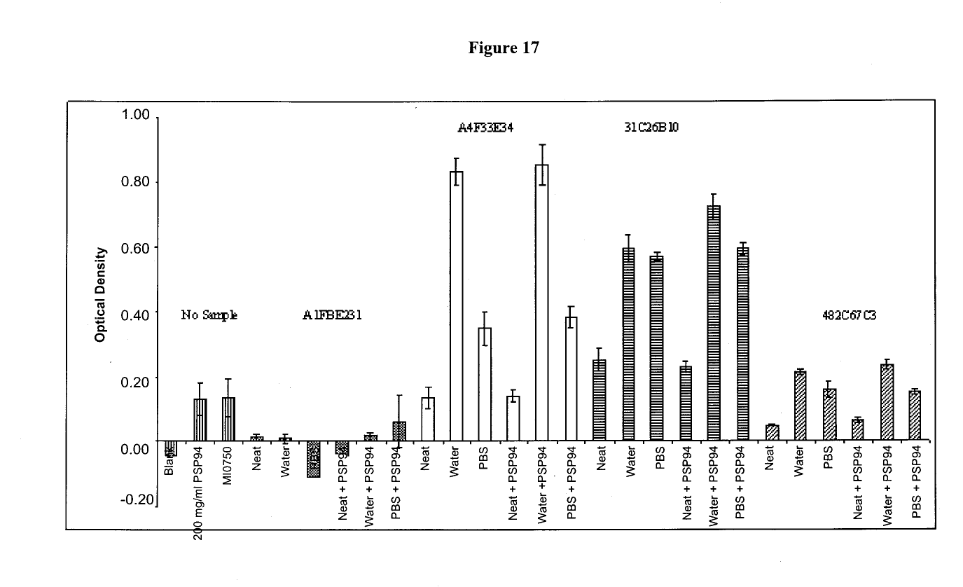

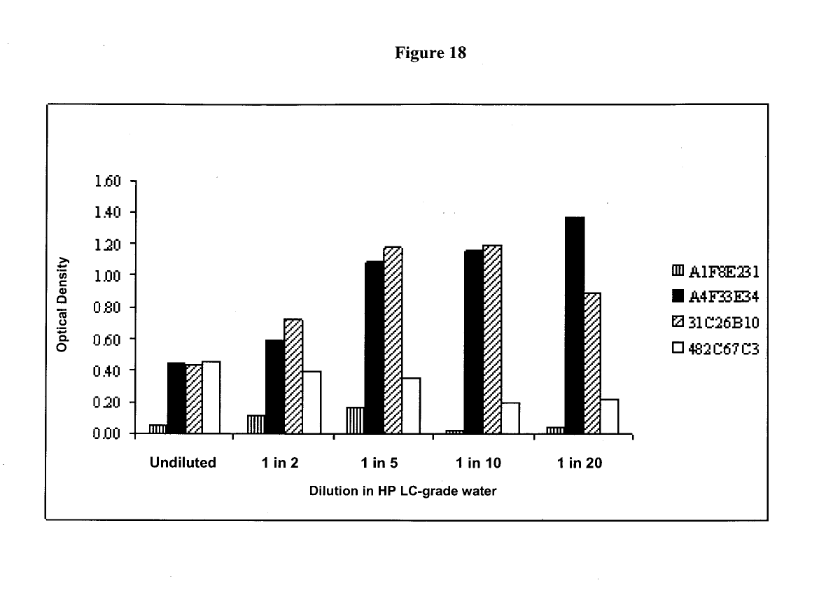

An indirect ELISA for urinary PSP94 was developed using commercially available antibodies. Initial experiments to test the effects of dialysis on the urine samples indicated that removal of salts in this manner enhanced assay signal, particularly when HPLC-grade water was used as the dialysis buffer rather than PBS (FIG. 17). Addition of exogenous PSP94 were detected in samples with low inherent MI0750 intensity. It was further demonstrated that simple dilution of sample with water could achieve a similar effect as dialysis (FIG. 18), and a 1 in 10 dilution of urine samples with water was chosen for further work.

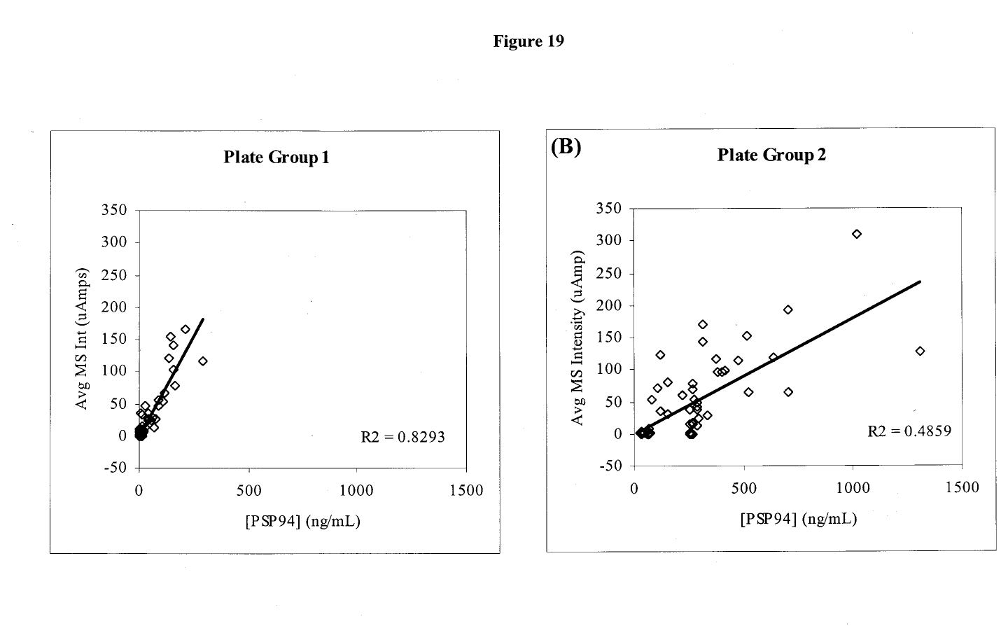

A total of 394 urine samples were then assayed using the indirect ELISA that had been developed. It was found that these samples could be placed into two distinct groups, based on the nature of the PSP94 standard curve of the ELISA plate the sample was assayed on. Plate Group 1 had standard curves comparable to those observed previously during assay development experiments, with a linear range of detection of between 0 and 500 ng/mL PSP94. In contrast, Plate Group 2 had strikingly different standard curves, and a linear range of detection of between 500 and 2000 ng/mL. In Plate Group 1, 22% of all samples fell below the linear range of detection (i.e. they were calculated to have a PSP94 concentration of less than 0 ng/mL), while 80% of all samples in Plate Group 2 fell below the linear range of detection for those plates (i.e. they were calculated to have a PSP94 concentration of less than 0 ng/mL). In both cases, samples with PSP94 concentrations below the linear range of detection were excluded from further analysis. Correlations between MI0750 peak intensity and PSP94 concentration were observed for both groups of samples (FIG. 19), though the strength of this was greater for Plate Group 1 than Plate Group 2. Diagnostic performance of the ELISA assay was comparable in these samples to MI0750 diagnostic performance (Table 45).

TABLE 45
Summary of ELISA diagnosis of PCa in comparison
to SELDI-MS diagnosis of PCa.

| | Plate Group 1 | | Plate Group 2 | |
|---|---|---|---|---|
| | ELISA | MS | ELISA | MS |
| P | 2.4 × 10⁻⁵ | 1.5 × 10⁻⁴ | 3.4 × 10⁻³ | 1.3 × 10⁻⁴ |
| ROC-AUC | 0.78 | 0.75 | 0.73 | 0.79 |
| SENS/SPEC | 90/49 | 90/29 | 91/51 | 91/51 |
| | 77/73 | 71/67 | 64/66 | 73/73 |
| | 90/39* | — | 90/16* | — |

| | | |
|---|---|---|
| Samples Avail at Start | 106 | 287 |
| Samples Discarded (%) | 23 (22%) | 230 (80%) |
| Samples Retained (%) | 83 (78%) | 57 (20%) |

SENS/SPEC values are given when fixing SENS at 90% (top line) and also when fixing SENS to be approcimately equal to SPEC.
P values were calculated by Mann-Whitney rank sum testing.
ROC-AUC: area under the receiver operator characteristic curve. SENS/SPEC: sensitivity/specificity (values given in %).
Plate Group 1: Samples assayed on ELISA plates that had standard curves similar to those observed during method development.
Plate Group 2: Samples assayed on ELISA plates that had aberrant standard curves.
*Sensitivity and specificity calculated when samples not falling on the linear part of the PSP94 standard curve were arbitrarily diagnosed as being from prostate cancer patients.

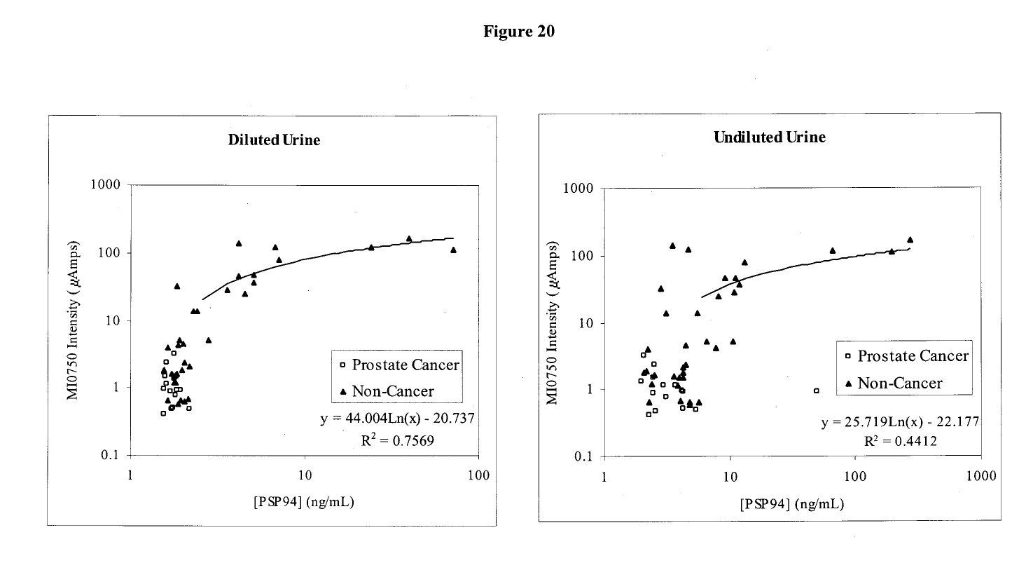

Further development of this assay was outsourced to Covance Immunology Services. Pilot analysis of 50 urine samples gave an assay that was consistent with that achieved by Miraculins when assaying either diluted or undiluted urine (FIG. 20), but further analysis of additional samples could not reproduce this performance.

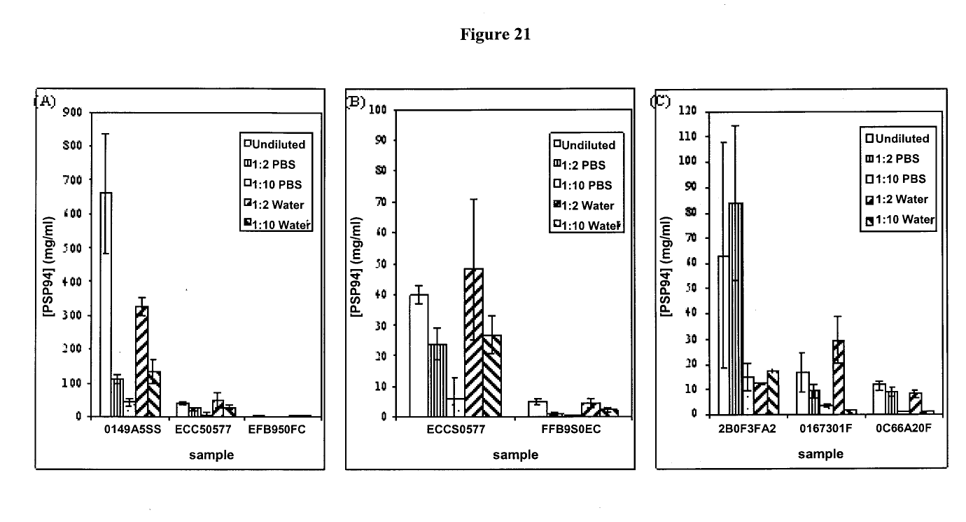

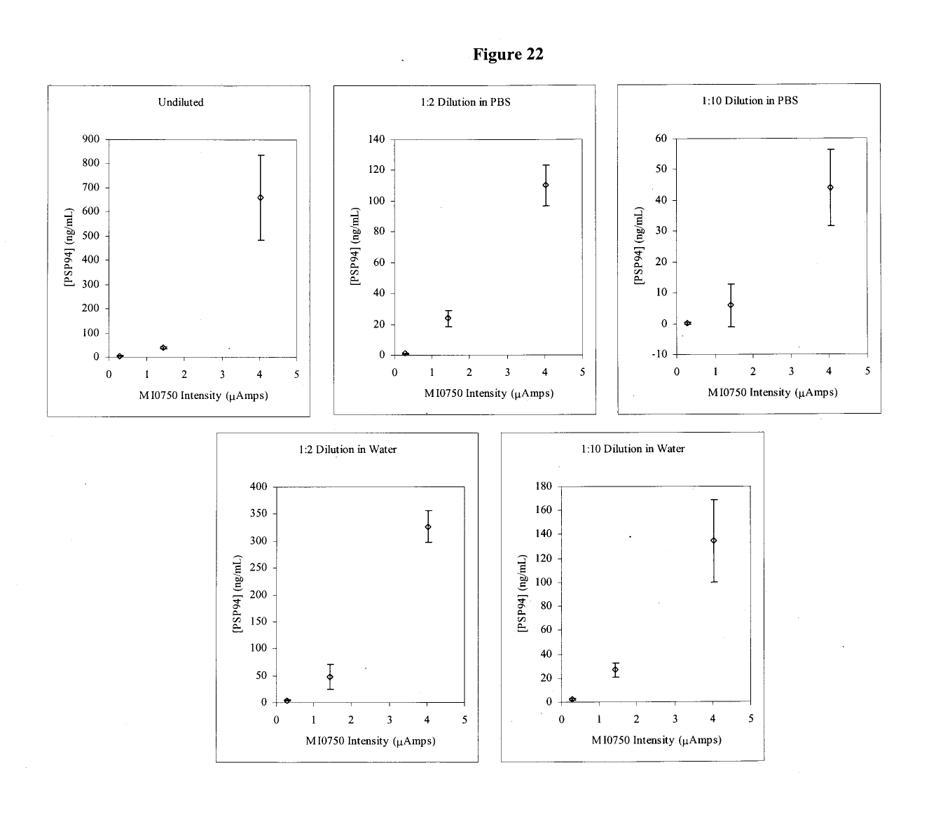

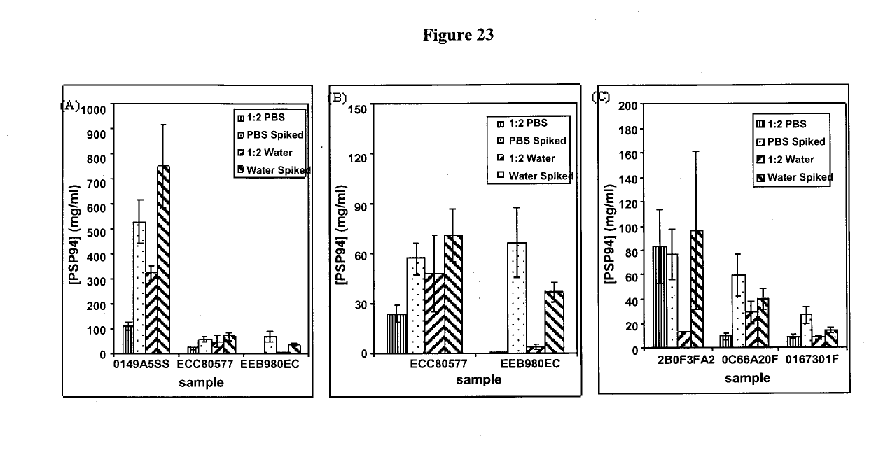

Development of a sandwich ELISA using commercially available antibodies was initiated through Covance Immunology Services with the goal of improving the sensitivity of detection of the assay. This work has shown that 10-fold sample dilution in either PBS or HPLC-grade water will significantly reduce the observed amount of PSP94 in a sample (FIG. 21), that the amount of PSP94 detected is correlated with the MI0750 intensity measured for the sample (FIG. 22), and that subsequent addition of exogenous PSP94 can be detected (FIG. 23). The amount of increase in measured PSP94 due to the addition of exogenous PSP94 is not consistent across samples.

1.-86. (canceled)

87. A method for diagnosing prostate cancer comprising:
a) detecting a quantity, presence or absence of a combination of biomarkers L and N in a biological sample from a subject; and
b) classifying said subject as having or not having prostate cancer, based on said quantity, presence or absence of said biomarkers.

88. The method according to claim 87, wherein the step of classifying said subject comprises comparing the quantity, presence or absence of the biomarkers with a reference biomarker panel indicative of a prostate cancer.

89. The method of claim 87 wherein the method also differentially diagnoses prostate cancer from non-malignant disease of the prostate, comprising:
further classifying said subject as having prostate cancer, non-malignant disease of the prostate, or as healthy, based on the quantity, presence or absence of said one or more biomarkers in said biological sample.

90. The method according to claim 89, wherein the step of classifying said subject comprises comparing the quantity, presence or absence of the biomarkers with a reference biomarker panel indicative of prostate cancer and a reference biomarker panel indicative of a non-malignant disease of the prostate.

91. The method of claim 89 further comprising:
classifying said subject as having non-malignant disease of the prostate, precancerous prostate lesion, localized cancer of the prostate, metastasised cancer of the prostate, and/or acute or chronic inflammation of prostatic tissue, or as healthy, based on the quantity, presence or absence of said one or more biomarkers in said biological sample.

92. The method according to claim 91, wherein the step of classifying said subject comprises comparing the quantity, presence or absence of the biomarkers with a reference biomarker panel indicative of healthy, non-malignant disease of the prostate, precancerous prostate lesion, localized cancer of the prostate, metastasised cancer of the prostate, acute inflammation of prostatic tissue or chronic inflammation of prostatic tissue.

93. The method of claim 87, wherein said one or more biomarkers are used to classify said subject by further comprising:
c) contacting the biological sample with a biologically active surface,
d) allowing one or more biomarker within the biological sample to bind to the biologically active surface;
e) detecting the bound biomarkers using a detection method, wherein the detection method generates mass profiles of said biological sample;
f) transforming the information obtained in c) into a computer readable form; and
g) comparing the information in d) with a database containing mass profiles from subjects whose classification is known;
wherein said comparison allows for the differential diagnosis and classification of a subject.

94. The method of claim 87, wherein the quantity, presence, or absence of the biomarker is detected or quantified in the biological sample obtained from the subject utilizing an antibody to said biomarker.

95. The method of claim 87, wherein the quantity, presence, or absence of the biomarkers is detected or quantified in the biological sample obtained from the subject through the use of an ELISA assay.

96. The method of claim 87, wherein the biological sample is selected from the group consisting of: blood, blood serum, plasma, urine, semen, seminal fluid, seminal plasma, prostatic fluid, pre-ejaculatory fluid (Cowper's fluid), excreta, tears, saliva, sweat, biopsy, ascites, cerebrospinal fluid, lymph, and tissue extract sample, preferably selected from the group consisting of: urine, semen, seminal fluid, seminal plasma, prostatic fluid, and pre-ejaculatory fluid (Cowper's fluid).

97. A method for determining aggressiveness or non-aggressiveness of prostate cancer in a subject, said method comprising measuring a quantity of biomarkers L and N in a biological sample, comparing the quantity of said biomarkers in the biological sample and the quantity of said biomarkers in a control/benign sample; wherein a difference in the quantity of said one or more biomarkers, or said combination thereof in the subject's biological sample and the quantity in the control/benign sample is an indication that prostate cancer is aggressive or non-aggressive.

98. A method of determining a stage of prostate cancer in a subject, said method comprising measuring a quantity of biomarkers L and N in a biological sample from the subject, comparing the quantity of said biomarkers in the biological sample with a pre-determined reference level, wherein the quantity of said biomarkers, above or below the pre-determined reference level is indicative of the stage of prostate cancer.

99. A method of determining a grade of a prostate tumor comprising measuring a quantity of biomarkers L and N in a biological sample, comparing the quantity of said biomarkers in the biological sample with a pre-determined reference level, wherein a quantity of said biomarkers, above or below the pre-determined reference level is indicative of the grade of a prostate tumor.


SEQUENCE LISTING (5 sequences)

SEQ ID NO: 1 - protein, 114 aa, Homo sapiens
MNVLLGSVVIFATFVTLCNASCYFIPNEGVPGDSTRKCMDLKGNKHPINSEWQTDNCETCTCYETEISCCTLVSTPVGYDKDNCQRIFKKEDCKYIVVEKKDPKKTCSVSEWII

SEQ ID NO: 2 - protein, 478 aa, Homo sapiens
MAPLRPLLILALLAWVALADQESCKGRCTEGFNVDKKCQCDELCSYYQSCCTDYTAECKPQVTRGDVFTMPEDEYTVYDDGEEKNNATVHEQVGGPSLTSDLQAQSKGNPEQTPVLKPEEEAPAPEVGASKPEGIDSRPETLHPGRPQPPAEEELCSGKPFDAFTDLKNGSLFAFRGQYCYELDEKAVRPGYPKLIRDVWGIEGPIDAAFTRINCQGKTYLFKGSQYWRFEDGVLDPDYPRNISDGFDGIPDNVDAALALPAHSYSGRERVYFFKGKQYWEYQFQHQPSQEECEGSSLSAVFEHFAMMQRDSWEDIFELLFWGRTSAGTRQPQFISRDWHGVPGQVDAAMAGRIYISGMAPRPSLAKKQRFRHRNRKGYRSQRGHSRGRNQNSRRPSRAMWLSLFSSEESNLGANNYDDYRMDWLVPATCEPIQSVFFFSGDKYYRVNLRTRRVDTVDPPYPRSIAQYWLGCPAPGHL

SEQ ID NO: 3 - protein, 18 aa, Homo sapiens
  misc_feature (5)..(5): Xaa can be any naturally occurring amino acid
DQESXKGRXTEGFNVDKK

SEQ ID NO: 4 - protein, 51 aa, Homo sapiens
  misc_feature (5)..(5): Xaa unidentified amino acid
DQESXKGRXTEGFNVDKKXQXDELXSYYQSXXTDYTAEXKPQVTRGDVFTM

SEQ ID NO: 5 - protein, 51 aa, Homo sapiens
DQESCKGRCTEGFNVDKKCQCDELCSYYQSCCTDYTAECKPQVTRGDVFTM